(19) United States
(12) Patent Application Publication
(10) Pub. No.: US 2024/0243794 A1
(43) Pub. Date: Jul. 18, 2024

(54) SUPPORT OF TOEPLITZ-BASED CSI FEEDBACK/REPORTING METHODS

(71) Applicant: Samsung Electronics Co., Ltd., Suwon-si (KR)

(72) Inventors: Caleb K. Lo, San Jose, CA (US); Gilwon Lee, McKinney, TX (US); Eko Onggosanusi, Coppell, TX (US); Md. Saifur Rahman, Plano, TX (US)

(21) Appl. No.: 18/534,419

(22) Filed: Dec. 8, 2023

Related U.S. Application Data
(60) Provisional application No. 63/434,759, filed on Dec. 22, 2022.
(60) Provisional application No. 63/438,726, filed on Jan. 12, 2023.

(51) Int. Cl. H04B 7/06; H04L 5/00; H04W 8/22

(52) U.S. Cl. CPC H04B 7/0626; H04L 5/0051; H04W 8/22

(57) ABSTRACT

Apparatuses and methods for support of Toeplitz-based channel state information (CSI) feedback/reporting methods. A method performed by a user equipment (UE) includes transmitting capability information indicating a capability of the UE to support a Toeplitz-based method of determining channel state information (CSI) reports; receiving configuration information that indicates parameters for the Toeplitz-based method of determining the CSI reports; and receiving CSI reference signals (RSs). The method further includes measuring the CSI-RSs; determining, based on the configuration information and the measured CSI-RSs, a CSI report; and transmitting the CSI report.

### CROSS-REFERENCE TO RELATED AND CLAIM OF PRIORITY

The present application claims priority under 35 U.S.C. § 119(e) to: U.S. Provisional Patent Application No. 63/434,759 filed on Dec. 22, 2022, and U.S. Provisional Patent Application No. 63/438,726 filed on Jan. 12, 2023, which are hereby incorporated by reference in their entirety.

### TECHNICAL FIELD

The present disclosure relates generally to wireless communication systems and, more specifically, the present disclosure is related to apparatuses and methods for support of Toeplitz-based channel state information (CSI) feedback/reporting methods.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to support of Toeplitz-based CSI feedback/reporting methods.

In an embodiment, a user equipment (UE) is provided. The UE includes a transceiver configured to transmit capability information indicating a capability of the UE to support a Toeplitz-based method of determining channel state information (CSI) reports, receive configuration information that indicates parameters for the Toeplitz-based method of determining the CSI reports, and receive CSI reference signals (RSs). The UE further includes a processor operably coupled to the transceiver. The processor is configured to measure the CSI-RSs and determine, based on the configuration information and the measured CSI-RSs, a CSI report. The transceiver is configured to transmit the CSI report.

In another embodiment, a base station (BS) is provided. The BS includes a processor and a transceiver operably coupled to the processor. The transceiver is configured to receive capability information indicating a capability of a UE to support a Toeplitz-based method of determining CSI reports, transmit configuration information that indicates parameters for the Toeplitz-based method of determining the CSI reports, transmit CSI-RSs, and receive the CSI report that is based on the configuration information and the CSI-RSs.

In yet another embodiment, a method performed by a UE is provided. The method includes transmitting capability information indicating a capability of the UE to support a Toeplitz-based method of determining CSI reports; receiving configuration information that indicates parameters for the Toeplitz-based method of determining the CSI reports; and receiving CSI-RSs. The method further includes measuring the CSI-RSs; determining, based on the configuration information and the measured CSI-RSs, a CSI report; and transmitting the CSI report.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a flowchart of an example BS procedure to support UE-initiated switch to doubly-block Toeplitz CSI feedback/report method according to embodiments of the present disclosure;

FIG. 7 illustrates a flowchart of an example UE procedure to support UE-initiated switch to doubly-block Toeplitz CSI feedback/report method according to embodiments of the present disclosure;

FIG. 8 illustrates a flowchart of an example BS procedure to support BS-initiated switch to doubly-block Toeplitz CSI feedback/report method according to embodiments of the present disclosure;

FIG. 9 illustrates a flowchart of an example UE procedure to support BS-initiated switch to doubly-block Toeplitz CSI feedback/report method according to embodiments of the present disclosure;

FIG. 10 illustrates a flowchart of an example BS procedure to support UE-initiated fallback to Toeplitz CSI feedback/report method according to embodiments of the present disclosure;

FIG. 11 illustrates a flowchart of an example UE procedure to support UE-initiated fallback to Toeplitz CSI feedback/report method according to embodiments of the present disclosure;

FIG. 12 illustrates a flowchart of an example BS procedure to support BS-initiated fallback to Toeplitz CSI feedback/report method according to embodiments of the present disclosure;

FIG. 13 illustrates a flowchart of an example UE procedure to support BS-initiated fallback to Toeplitz CSI feedback/report method according to embodiments of the present disclosure;

FIG. 14 illustrates a diagram of a new medium access control (MAC) control element (CE) for UE assistance information report according to embodiments of the present disclosure;

FIG. 15 illustrates a diagram of a new MAC CE for Toeplitz CSI fallback request according to embodiments of the present disclosure;

FIG. 16 illustrates a flow diagram of an example artificial intelligence (AI)/machine learning (ML) architecture to support training/inference of a Toeplitz codebook according to embodiments of the present disclosure;

FIG. 17 illustrates a flowchart of an example BS procedure to support UE-initiated switch to concatenated doubly-block Toeplitz CSI feedback/report method according to embodiments of the present disclosure;

FIG. 18 illustrates a flowchart of an example UE procedure to support UE-initiated switch to concatenated doubly-block CSI feedback/report method according to embodiments of the present disclosure;

FIG. 19 illustrates a flowchart of an example BS procedure to support BS-initiated switch to concatenated doubly-block Toeplitz CSI feedback/report method according to embodiments of the present disclosure; and

FIG. 20 illustrates a flowchart of an example UE procedure to support BS-initiated switch to concatenated doubly-block Toeplitz CSI feedback/report method according to embodiments of the present disclosure.

### DETAILED DESCRIPTION

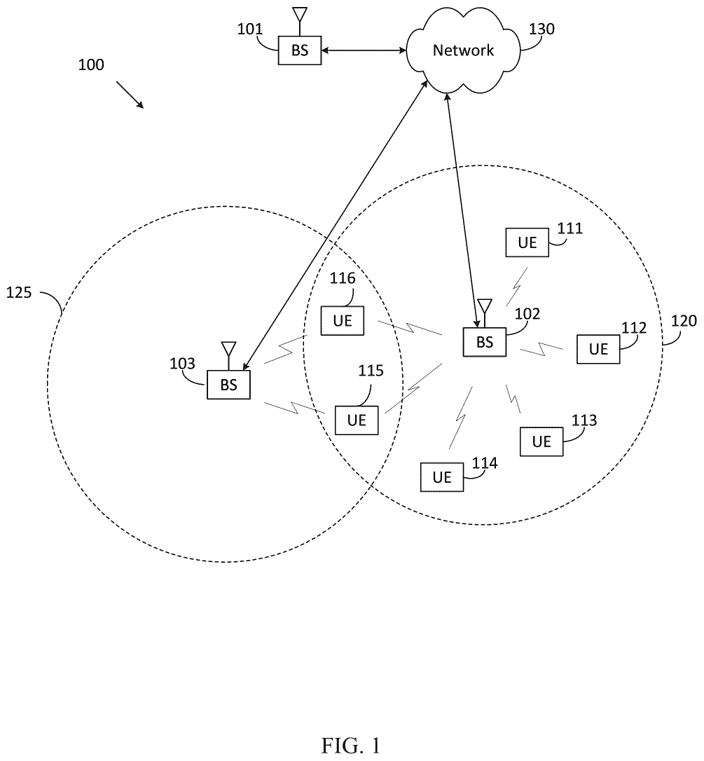

FIGS. 1-20, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP, TS 38.211, 5G; NR; Physical channels and modulation; [2] 3GPP, TS 38.331, 5G; NR; Radio Resource Control (RRC); Protocol specification; [3] 3GPP, TS 38.321, 5G; NR; Medium Access Control (MAC); Protocol specification; [4] 3GPP, TS 38.214, 5G; NR; Physical layer procedures for data; [5] https://mathworld.wolfram.com/ToeplitzMatrix.html; [6] M. Wax and T. Kailath, “Efficient inversion of a doubly block Toeplitz matrix”, in Proc. IEEE ICASSP, pp. 170-173, Apr. 14-16, 1983; [7] https://mathworld.wolfram.com/CirculantMatrix.html; [8] A. Araujo, “Building Compact and Robust Deep Neural Networks with Toeplitz Matrices”, https://arxiv.org/pdf/2109.00959.pdf; and [9] D. Geller, I. Kra, S. Popescu, and S. Simanca, “On Circulant Matrices”, http://www.math.stonybrook.edu/˜sorin/eprints/circulant.pdf.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing Toeplitz-based CSI feedback/reporting methods. In certain embodiments, one or more of the BSs 101-103 include circuitry, programing, or a combination thereof to support Toeplitz-based CSI feedback/reporting methods.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

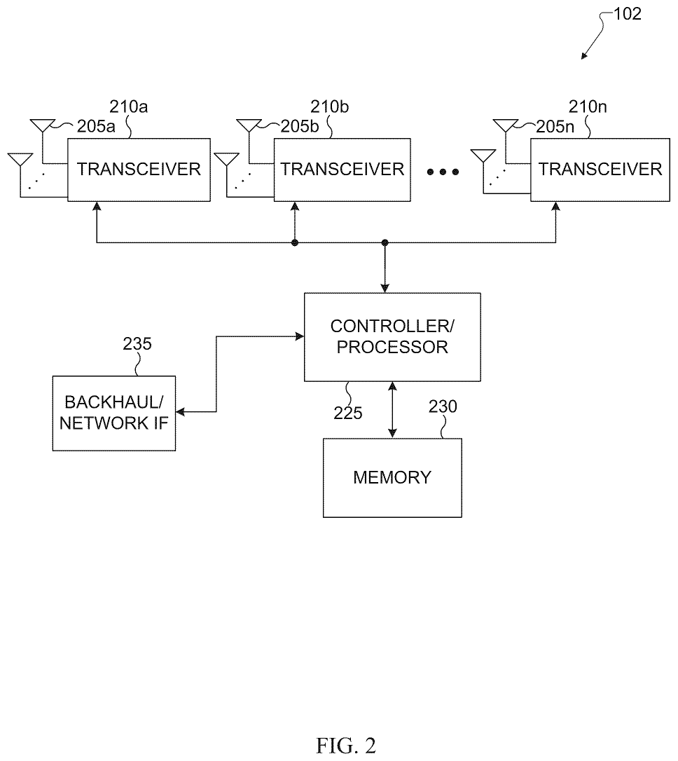

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods to support Toeplitz-based CSI feedback/reporting methods as described in greater detail below. Any of a wide variety of other functions could be supported in the gNB 102 by the controller/processor 225. The controller/processor 225 can move data into or out of the memory 230 as required by an executing process.

The controller/processor 225 is also capable of executing programs and other processes resident in the memory 230, such as supporting Toeplitz-based CSI feedback/reporting methods. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

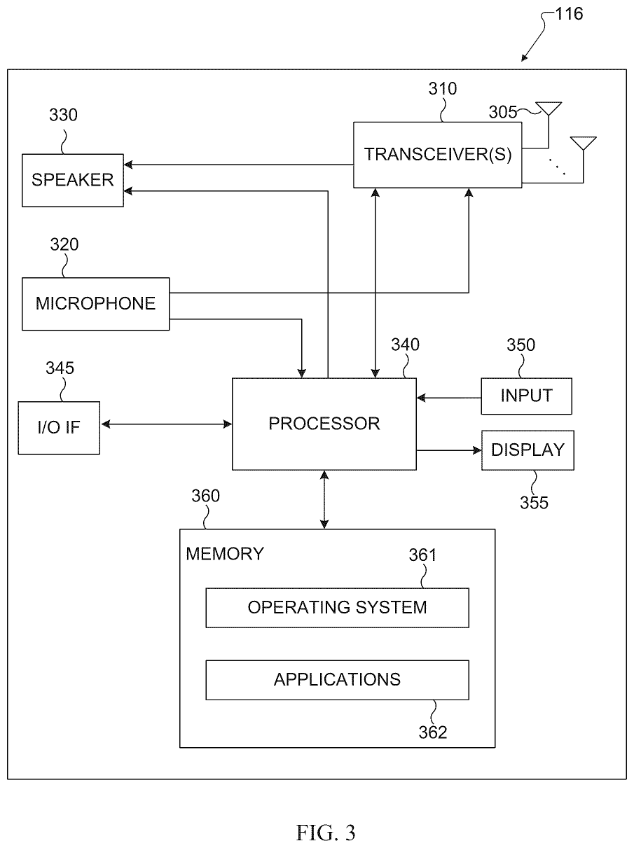

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for performing Toeplitz-based CSI feedback/reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

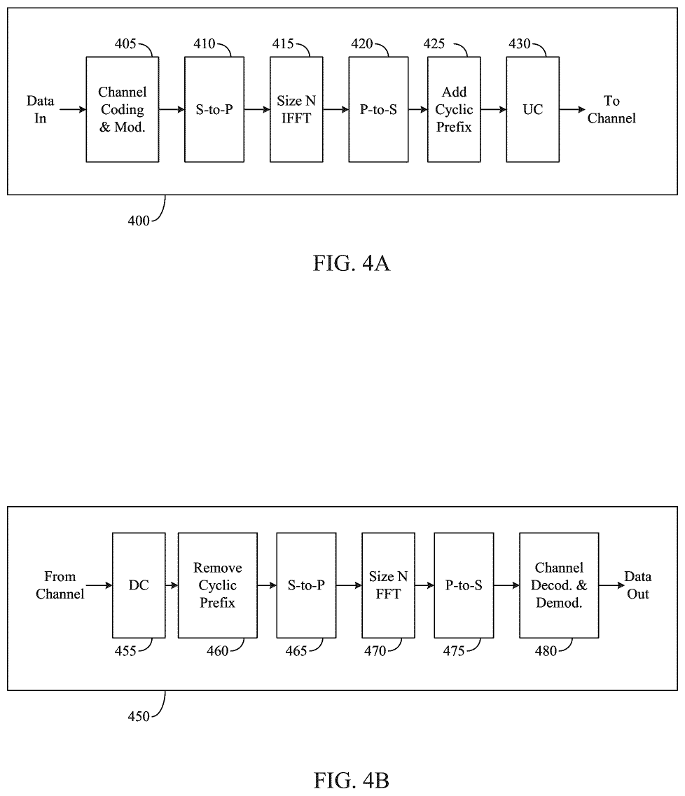

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured to receive information for parameters for supporting Toeplitz-based CSI feedback/reporting methods as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

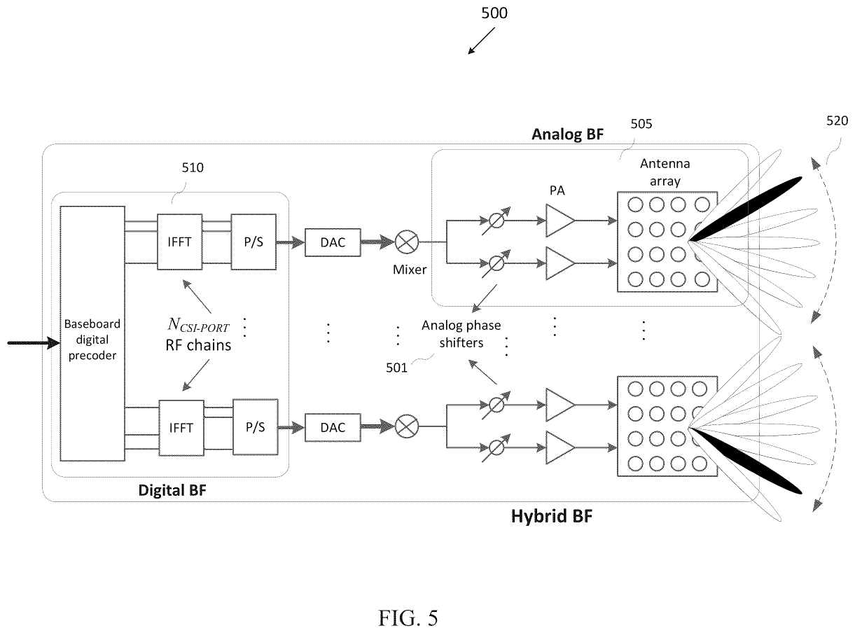

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are necessary to compensate for the additional path loss.

In 5G NR, a significant improvement in throughput can be obtained by supporting MU-MIMO transmission, where one gNB simultaneously transmits multiple data streams to multiple UEs. MU-MIMO transmission relies on the availability of accurate DL CSI at the gNB; in frequency division duplex (FDD) systems, each UE measures DL CSI and reports its measurements. Each CSI report can include PMI (the dominant channel directions), RI (the number of dominant channel directions), and/or CQI (the best modulation and code rate that the channel can support).

The overhead of DL CSI increases with the number of antenna ports at the gNB and the number of subbands (SBs). Current 5G systems support tens of SBs and a maximum of 32 antenna ports at the gNB. Each UE uses pre-defined codebooks (e.g., Type I and Type II) for compressing DL CSI before it is reported to the gNB. These codebooks exploit channel correlations in the spatial and frequency domains; the application of these codebooks has significantly reduced the overhead of DL CSI feedback. In Release-18, these codebooks are being extended to exploit channel correlations in the temporal (time) domain; the application of these codebooks could yield additional reductions in the overhead of DL CSI feedback.

The number of antenna ports at the gNB and the number of SBs are expected to increase for future systems to meet more stringent performance requirements—yet the overhead reduction from pre-defined codebooks may not scale accordingly (e.g., Type I and Type II codebooks utilize a DFT basis, which may not be applicable to future antenna configurations). Thus, embodiments of the present disclosure recognize it may be advantageous to configure a UE to support alternate methods of compressing DL CSI.

For example, assume that an AI/ML model architecture can be designed to train an autoencoder for generating/reporting CSI feedback, where the encoder utilizes a single convolutional neural network (CNN) layer. When this trained autoencoder is used for inference, applying this CNN layer is equivalent to pre-multiplying its input by a Toeplitz (or doubly-block Toeplitz, circulant, doubly-block circulant) matrix. For example, 1-D linear convolution is equivalent to pre-multiplication by a Toeplitz matrix, while 2-D linear convolution is equivalent to pre-multiplication by a doubly-block Toeplitz matrix. Also, 1-D circular convolution is equivalent to pre-multiplication by a circulant matrix, while 2-D circular convolution is equivalent to pre-multiplication by a doubly-block circulant matrix.

A Toeplitz matrix [5] has constant (same) values along its negative-sloping diagonals. An example is shown in (1) as values . . . , a₋₁, a₀, a₁, . . . .

$$\text{} A = [ \begin{matrix}{a}_{0} & {a}_{- 1} & {a}_{- 2} & … & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & … & {a}_{2} & {a}_{1} & {a}_{0}\end{matrix} ] \qquad ( 1 )$$

A doubly-block Toeplitz matrix [6] is a block matrix R where 1) its (i,j)-th block Rᵢⱼ is a function of i-j (thus, it can be denoted by Rᵢ₋ⱼ) and 2) Rᵢⱼ(denoted by Rᵢⱼ) is itself a Toeplitz matrix. An example is shown in (2), where each Rⱼ is a Toeplitz matrix.

$$R = [ \begin{matrix}{R}_{0} & {R}_{- 1} & {R}_{- 2} & … & {R}_{- n + 1} \\ {R}_{1} & {R}_{0} & {R}_{- 1} & ⋱ & ⋮ \\ {R}_{2} & {R}_{1} & {R}_{0} & ⋱ & {R}_{- 2} \\ ⋮ & ⋱ & ⋱ & ⋱ & {R}_{- 1} \\ {R}_{n - 1} & … & {R}_{2} & {R}_{1} & {R}_{0}\end{matrix} ] \qquad ( 2 )$$

A circulant matrix [7] is a special case of a Toeplitz matrix where each row (column) is a circular shift of the previous row (column). An example is shown in (3).

$$A = [ \begin{matrix}{a}_{0} & {a}_{- 1} & {a}_{- 2} & … & {a}_{- n + 1} \\ {a}_{- n + 1} & {a}_{0} & {a}_{- 1} & ⋱ & {a}_{- n + 2} \\ {a}_{- n + 2} & {a}_{- n + 1} & {a}_{0} & ⋱ & {a}_{- n + 3} \\ ⋮ & ⋱ & ⋱ & ⋱ & ⋮ \\ {a}_{- 1} & … & {a}_{- n + 2} & {a}_{- n + 1} & {a}_{0}\end{matrix} ] \qquad ( 3 )$$

A doubly-block circulant matrix is a special case of a doubly-block Toeplitz matrix R where 1) each block row (column) is a circular shift of the previous block row (column) and 2) its (i,j)-th block Rᵢⱼ(denoted by Rᵢⱼ) is itself a circulant matrix. An example is shown in (4), where each Rⱼ is a circulant matrix.

$$R = [ \begin{matrix}{R}_{0} & {R}_{- 1} & {R}_{- 2} & … & {R}_{- n + 1} \\ {R}_{- n + 1} & {R}_{0} & {R}_{- 1} & ⋱ & {R}_{- n + 2} \\ {R}_{- n + 2} & {R}_{- n + 1} & {R}_{0} & ⋱ & {R}_{- n + 3} \\ ⋮ & ⋱ & ⋱ & ⋱ & ⋮ \\ {R}_{- 1} & … & {R}_{- n + 2} & {R}_{- n + 1} & {R}_{0}\end{matrix} ] \qquad ( 4 )$$

Thus, using this trained autoencoder for inference is equivalent to applying a Toeplitz-based method for generating/reporting CSI feedback. This Toeplitz-based method can utilize a flexible basis that depends on a training dataset.

The present disclosure describes a framework for supporting Toeplitz-based methods for generating/reporting CSI feedback. The corresponding signaling details are discussed in this disclosure.

This disclosure addresses the issue that Toeplitz-based methods for generating/reporting temporal CSI feedback are not supported in the 5G-NR standard. This disclosure provides techniques that the network can use to configure a UE to generate CSI feedback using Toeplitz-based operations.

Details on the support of Toeplitz-based methods for generating/reporting CSI feedback are disclosed, including information elements to be exchanged between a transmitter and a receiver.

For illustrative purposes, a term “Toeplitz-based CSI feedback/report” is used to refer to a method for generating CSI reports that is based on a first component (or basis) W₁ which has a convolutional structure. For instance, the convolutional structure can correspond to a Toeplitz (or doubly-block Toeplitz, circulant, doubly-block circulant) matrix. The CSI reports are based on a dual-stage precoding structure, where the first stage can correspond to the convolutional W₁ and the second stage can correspond to a second component (or coefficients) W₂. The overall precoding operation essentially can be expressed as W₁W₂, i.e., multiplication of a coefficient matrix (W₂) by a Toeplitz (or doubly-block Toeplitz, circulant, doubly-block circulant) matrix (W₁). In this case, this Toeplitz (or doubly-block Toeplitz, circulant, doubly-block circulant) matrix is analogous to the basis matrices W₁ and/or Wᵣ or sets of basis vectors as in the Type II codebooks (cf. 5.2.2.2.3/4/5/6/7, document and standard [4]) that perform compression in spatial domain (SD) only or both SD and frequency domain (FD), respectively.

If the convolutional structure of W₁ corresponds to a Toeplitz (or doubly-block Toeplitz, circulant, doubly-block circulant) matrix, this Toeplitz (or doubly-block Toeplitz, circulant, doubly-block circulant) matrix can be a square (e.g., n×n) matrix. This Toeplitz (or doubly-block Toeplitz, circulant, doubly-block circulant) matrix can also be a tall (e.g., m×n, where m>n) or fat (e.g., n×m, where m>n) matrix.

Other terms that refer to a same method can also be used.

In one embodiment, the precoding matrix based on this disclosure has the following structure:

$$P = \frac{1}{γ} {W}_{1} {W}_{2} = \frac{1}{γ} A c = \frac{1}{γ} [ \begin{matrix}{a}_{0} & {a}_{- 1} & {a}_{- 2} & … & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & … & {a}_{2} & {a}_{1} & {a}_{0}\end{matrix} ] [ \begin{matrix}{c}_{0} \\ ⋮ \\ {c}_{n - 1}\end{matrix} ] \qquad ( 5 )$$

where γ is a normalization factor. In one example, W₁ is an SD basis (e.g., across P_{CSIRS} CSI-RS antenna ports). The quantities a₋ₙ₊₁ . . . , a₋₁, a₀, a₁, . . . , aₙ₋₁ in (5) can be configured to be determined by training an AI/ML model architecture. In another example, the quantities a₋ₙ₊₁ . . . a₋₁, a₀, a₁, . . . , aₙ₋₁ in (5) can be configured from a candidate set of quantities. In another example, the quantities a₋ₙ₊₁ . . . , a₋₁, a₀, a₁, . . . , aₙ₋₁ in (5) can be specified.

In a variation, the precoding matrix based on this disclosure has the following structure:

$$P = \frac{1}{γ} {W}_{1} {W}_{2} = \frac{1}{γ} [ \begin{matrix}{A}_{I} & 0 \\ 0 & {A}_{2}\end{matrix} ] c \qquad ( 6 )$$

where γ is a normalization factor. In one example, W₁ is an SD basis for two antenna groups (e.g., two antenna polarizations of the P_{CSIRS} CSI-RS antenna ports). Here, A₁ and A₂ are associated with the two groups. In one example, A₁=A₂=A. In one example, A₁ can be different from A₂.

In another variation, for a multi-TRP framework (i.e., D-MIMO setup), the precoding matrix based on this disclosure can incorporate the following structure:

$${W}_{1} = [ \begin{matrix}{W}_{1 , 1} & 0 & 0 \\ 0 & ⋱ & 0 \\ 0 & 0 & {W}_{1 , N}\end{matrix} ]$$

where W_{1,r} follows at least one of the examples (e.g., a Toeplitz matrix) in this disclosure, and N is the number of TRPs. In one example, N is the number of CSI-RS resources, i.e., one CSI-RS resource corresponds to a TRP. In one example, N is the number of port groups in a CSI-RS resource, i.e., one port group corresponds to a TRP.

In one example, a TRP-common configuration can be supported, i.e., W_{1,1}=W_{1,N}. In another example, a TRP-specific configuration can be supported, where W_{1,r} can be selected on a per-TRP basis.

This is akin to the Type I or Rel. 15 Type II codebook (cf. 5.2.2.2.1/2/3/4, document and standard [4]). When N_{SB}>1, for each SB:
In one example, W₁ can be the same (i.e., WB, one W₁ for each configured SBs), and W₂ can be per SB (i.e., multiple W₂s).
In one example, W₁ can be per SB (i.e., multiple W₁s) and W₂ can be the same (i.e., WB, one W₂ for each configured SBs).
In one example, both W₁ and W₂ can be the same (i.e., WB, one W₁ and one W₂ for each configured SBs).
In one example, both W₁ and W₂ can be per SB (i.e., multiple W₁s and W₂s).

In another example, a granularity other than SB or WB can be applied to the above examples. For example, a subcarrier, or multiple subcarriers, a resource block (RB), or multiple RBs, or SB/R where R=2 or 4 can be another granularity for W₁ and W₂.

Likewise, for rank >1, for each layer k, in one embodiment, the precoding matrix based on this disclosure has the following structure:

$${P}^{k} = \frac{1}{{γ}_{k}} {W}_{1}^{( k )} {W}_{2}^{( k )} = \frac{1}{{γ}_{k}} {A}^{( k )} {c}^{( k )} = \frac{1}{γ} [ \begin{matrix}{a}_{k , 0} & {a}_{k , - 1} & {a}_{k , - 2} & ⋯ & {a}_{k , - n + 1} \\ {a}_{k , 1} & {a}_{k , 0} & {a}_{k , - 1} & ⋱ & ⋮ \\ {a}_{k , 2} & {a}_{k , 1} & {a}_{k , 0} & ⋱ & {a}_{k , - 2} \\ ⋮ & ⋱ & ⋱ & ⋱ & {a}_{k , - 1} \\ {a}_{k , n - 1} & ⋯ & {a}_{k , 2} & {a}_{k , 1} & {a}_{k , 0}\end{matrix} ] [ \begin{matrix}{c}_{k , 0} \\ ⋮ \\ {c}_{k , n - 1}\end{matrix} ] \qquad ( 7 )$$

where γₖ is a normalization factor. In one example, W₁^{(k)} is an SD basis (e.g., across P_{CSIRS} CSI-RS antenna ports). The quantities a_{k,-n+1} . . . , a_{k,-1}, a_{k,0}, a_{k,1} . . . , a_{k,n-1} in (7) can be configured to be determined by training an AI/ML model architecture. In another example, the quantities a_{k,-n+1} . . . , a_{k,-1}, a_{k,0}, a_{k,1}, . . . , a_{k,n-1} in (7) can be configured from a candidate set of quantities. In another example, the quantities a_{k,-n+1} . . . , a_{k,-1}, a_{k,0}, a_{k,1}, . . . , a_{k,n-1} in (7) can be specified.

In a variation, for rank >1, for each layer k, the precoding matrix based on this disclosure has the following structure:

$${P}^{k} = \frac{1}{{γ}_{k}} {W}_{1}^{( k )} {W}_{2}^{( k )} = \frac{1}{{γ}_{k}} [ \begin{matrix}{A}_{k , 1} & 0 \\ 0 & {A}_{k , 2}\end{matrix} ] {c}^{( k )} \qquad ( 8 )$$

where γₖ is a normalization factor. In one example, W₁^{(k)} is an SD basis for two antenna groups (e.g., two antenna polarizations of the P_{CSIRS} CSI-RS antenna ports). Here, A_{k,1} and A_{k,2} are associated with the two groups. In one example, A_{k,1}=A_{k,2}=Aₖ. In one example, A_{k,1} can be different from A_{k,2}.

In another variation, for a multi-TRP framework (i.e., D-MIMO setup), for rank >1, for each layer k, the precoding matrix based on this disclosure can incorporate the following structure:

$${W}_{1}^{( k )} = [ \begin{matrix}{W}_{1 , 1}^{( k )} & 0 & 0 \\ 0 & ⋱ & 0 \\ 0 & 0 & {W}_{1 , N}^{( k )}\end{matrix} ]$$

where W_{1,r}^{(k)} follows at least one of the examples (e.g., a Toeplitz matrix) in this disclosure, and N is the number of TRPs. In one example, N is the number of CSI-RS resources, i.e., one CSI-RS resource corresponds to a TRP. In one example, N is the number of port groups in a CSI-RS resource, i.e., one port group corresponds to a TRP.

In one example, for a multi-TRP framework (i.e., D-MIMO setup), for rank >1, for each layer k, a TRP-common configuration can be supported, i.e., W_{1,1}^{(k)}= . . . =W_{1,N}^{(k)}. In another example, a TRP-specific configuration can be supported, where W_{1,r}^{(k)} can be selected on a per-TRP basis.

This is akin to the Type I or Rel. 15 Type II codebook. When N_{SB}>1, for each SB:
In one example, W₁^{(k)} can be the same (i.e., WB, one W₁^{(k)} for each configured SBs), and W₂^{(k)} can be per SB (i.e., multiple W₂^{(k)} s).
In one example, W₁^{(k)} can be per SB (i.e., multiple W₁^{(k)}s) and W₂^{(k)} can be the same (i.e., WB, one W₂^{(k)} for each configured SBs).
In one example, both W₁^{(k)} and W₂^{(k)} can be the same (i.e., WB, one W₁^{(k)} and one W₂^{(k)} for each configured SBs).
In one example, both W₁^{(k)} and W₂^{(k)} can be per SB (i.e., multiple W₁^{(k)}s and W₂^{(k)}s).

In another example, a granularity other than SB or WB can be applied to one or more examples described herein. For example, a subcarrier, or multiple subcarriers, an RB, or multiple RBs, or SB/R where R=2 or 4 can be another granularity for W₁^{(k)} and W₂^{(k)}.

In one example, W₁^{(k)} can be the same for each layer k while W₂^{(k)} can be the same for each layer k. In another example, W₁^{(k)} can be determined on a per-layer basis while W₂^{(k)} can be determined on a per-layer basis. In one example, W₁^{(k)} can be the same for each layer k while W₂^{(k)} can be determined on a per-layer basis. In another example, W₂^{(k)} can be the same for each layer k while W₁^{(k)} can be determined on a per-layer basis.

In one embodiment, for the frequency domain, the precoding matrix based on this disclosure has the following structure:

$$P = \frac{1}{γ} {W}_{2} {W}_{f}^{H} = \frac{1}{γ} {cA}_{f}^{H} = {\frac{1}{γ} [ \begin{matrix}{c}_{0} & ⋯ & {c}_{n - 1}\end{matrix} ] [ \begin{matrix}{a}_{f , 0} & {a}_{f , - 1} & {a}_{f , - 2} & ⋯ & {a}_{f , - n + 1} \\ {a}_{f , 1} & {a}_{f , 0} & {a}_{f , - 1} & ⋱ & ⋮ \\ {a}_{f , 2} & {a}_{f , 1} & {a}_{f , 0} & ⋱ & {a}_{f , - 2} \\ ⋮ & ⋱ & ⋱ & ⋱ & {a}_{f , - 1} \\ {a}_{f , n - 1} & ⋯ & {a}_{f , 2} & {a}_{f , 1} & {a}_{f , 0}\end{matrix} ]}^{H} \qquad ( 9 )$$

where γ is a normalization factor. In one example, W_{f} is an FD basis. The quantities a_{f,-n+1} . . . , a_{f,-1}, a_{f,0}, a_{f,1}, . . . , a_{f,n-1} in (9) can be configured to be determined by training an AI/ML model architecture. In another example, the quantities a_{f,-n+1} . . . , a_{f,-1}, a_{f,0}, a_{f,1}, a_{f,n-1} in (9) can be configured from a candidate set of quantities. In another example, the quantities a_{f,-n+1} . . . , a_{f,-1}, a_{f,0}, a_{f,1}, . . . , a_{f,n-1} in (9) can be specified.

Likewise, for rank >1, for each layer k, in one embodiment, for the frequency domain, the precoding matrix based on this disclosure has the following structure:

$${P}^{k} = \frac{1}{{γ}_{k}} {W}_{2}^{( k )} {W}_{f}^{( k ) H} = \frac{1}{{γ}_{k}} {c}^{( k )} {A}_{f}^{( k ) H} = {\frac{1}{{γ}_{k}} [ \begin{matrix}{c}_{k , 0} & ⋯ & {c}_{k , n - 1}\end{matrix} ] [ \begin{matrix}{a}_{f , k , 0} & {a}_{f , k , - 1} & {a}_{f , k , - 2} & ⋯ & {a}_{f , k , - n + 1} \\ {a}_{f , k , 1} & {a}_{f , k , 0} & {a}_{f , k , - 1} & ⋱ & ⋮ \\ {a}_{f , k , 2} & {a}_{f , k , 1} & {a}_{f , k , 0} & ⋱ & {a}_{f , k , - 2} \\ ⋮ & ⋱ & ⋱ & ⋱ & {a}_{f , k , - 1} \\ {a}_{f , k , n - 1} & ⋯ & {a}_{f , k , 2} & {a}_{f , k , 1} & {a}_{f , k , 0}\end{matrix} ]}^{H} \qquad ( 10 )$$

where γₖ is a normalization factor. In one example, W_{f}^{(k)} is an FD basis. The quantities a_{f,k,-n+1} . . . , a_{f,k,-1}, a_{f,k,0}, a_{f,k,1}, . . . , a_{f,k,n-1} in (10) can be configured to be determined by training an AI/ML model architecture. In another example, the quantities a_{f,k,-n+1} . . . , a_{f,k,-1}, a_{f,k,0}, a_{f,k,1}, . . . , a_{f,k,n-1} in (10) can be configured from a candidate set of quantities. In another example, the quantities a_{f,k,-n+1} . . . , a_{f,k,-1}, a_{f,k,0}, a_{f,k,1}, . . . , a_{f,k,n-1} in (10) can be specified.

In one example, W_{f}^{(k)} can be the same for each layer k while W₂^{(k)} can be the same for each layer k. In another example, W_{f}^{(k)} can be determined on a per-layer basis while W₂^{(k)} can be determined on a per-layer basis. In one example, W_{f}^{(k)} can be the same for each layer k while W₂^{(k)} can be determined on a per-layer basis. In another example, W₂^{(k)} can be the same for each layer k while W_{f}^{(k)} can be determined on a per-layer basis.

In one embodiment, for the space and frequency domains, the precoding matrix based on this disclosure has the following structure:

$$P = \frac{1}{γ} {W}_{1} {W}_{2} {W}_{f}^{H} = \frac{1}{γ} {ACA}_{f}^{H} = \frac{1}{γ} [ \begin{matrix}{a}_{0} & {a}_{- 1} & {a}_{- 2} & ⋯ & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & ⋯ & {a}_{2} & {a}_{1} & {a}_{0}\end{matrix} ] [ \begin{matrix}{c}_{0 , 0} & {c}_{0 , 1} & & {c}_{0 , m - 1} \\ ⋮ & ⋮ & ⋯ & ⋮ \\ {c}_{n - 1 , 0} & {c}_{n - 1 , 1} & & {c}_{n - 1 , m - 1}\end{matrix} ] {[ \begin{matrix}{a}_{f , 0} & {a}_{f , - 1} & {a}_{f , - 2} & ⋯ & {a}_{f , - n + 1} \\ {a}_{f , 1} & {a}_{f , 0} & {a}_{f , - 1} & ⋱ & ⋮ \\ {a}_{f , 2} & {a}_{f , 1} & {a}_{f , 0} & ⋱ & {a}_{f , - 2} \\ ⋮ & ⋱ & ⋱ & ⋱ & {a}_{f , - 1} \\ {a}_{f , n - 1} & ⋯ & {a}_{f , 2} & {a}_{f , 1} & {a}_{f , 0}\end{matrix} ]}^{H} \qquad ( 11 )$$

where γ is a normalization factor. In one example, W₁ is an SD basis (e.g., across P_{CSIRS} CSI-RS antenna ports), and W_{f} is an FD basis. The quantities a₋ₙ₊₁ . . . , a₋₁, a₀, a₁, . . . , aₙ₋₁ and/or a_{f,-m+1} . . . , a_{f,-1}, a_{f,0}, a_{f,1}, . . . , a_{f,m-1} in (11) can be configured to be determined by training an AI/ML model architecture. In another example, the quantities a₋ₙ₊₁, . . . , a₁, a₀, a₁, aₙ₋₁ and/or a_{f,m+1} . . . , a_{f,-1}, a_{f,0}, a_{f,1}, . . . , a_{f,m-1} in (11) can be configured from a candidate set of quantities. In another example, the quantities a₋ₙ₊₁ . . . , a₁, a₀, a₁, . . . , aₙ₋₁ and/or a_{f,-m+1} . . . , a_{f,-1}, a_{f,0}, a_{f,1} . . . , a_{f,m-1} in (11) can be specified.

In a variation, the precoding matrix based on this disclosure has the following structure:

$$P = \frac{1}{γ} {W}_{I} {W}_{2} {W}_{f}^{H} = \frac{1}{γ} [ \begin{matrix}{A}_{1} & 0 \\ 0 & {A}_{2}\end{matrix} ] C {A}_{f}^{H} \qquad ( 12 )$$

where γ is a normalization factor. In one example, W₁ is an SD basis for two antenna groups (e.g., two antenna polarizations of the P_{CSIRS} CSI-RS antenna ports). Here, A₁ and A₂ are associated with the two groups. In one example, A₁=A₂=A. In one example, A₁ can be different from A₂.

Likewise, for rank>1, for each layer k, in one embodiment, the precoding matrix based on this disclosure has the following structure:

$${P}^{k} = \frac{1}{{γ}_{k}} {W}_{1}^{( k )} {W}_{2}^{( k )} {W}_{f}^{( k ) H} = \frac{1}{{γ}_{k}} {A}^{( k )} {C}^{( k )} {A}_{f}^{( k ) H} = \frac{1}{{γ}_{k}} [ \begin{matrix}{a}_{k , 0} & {a}_{k , - 1} & {a}_{k , - 2} & ⋯ & {a}_{k , - n + 1} \\ {a}_{k , 1} & {a}_{k , 0} & {a}_{k , - 1} & ⋱ & ⋮ \\ {a}_{k , 2} & {a}_{k , 1} & {a}_{k , 0} & ⋱ & {a}_{k , - 2} \\ ⋮ & ⋱ & ⋱ & ⋱ & {a}_{k , - 1} \\ {a}_{k , n - 1} & ⋯ & {a}_{k , 2} & {a}_{k , 1} & {a}_{k , 0}\end{matrix} ] [ \begin{matrix}{c}_{k , 0 , 0} & {c}_{k , 0 , 1} & & {c}_{k , 0 , m - 1} \\ ⋮ & ⋮ & ⋯ & ⋮ \\ {c}_{k , n - 1 , 0} & {c}_{k , n - 1 , 1} & & {c}_{k , n - 1 , m - 1}\end{matrix} ] {[ \begin{matrix}{a}_{f , k , 0} & {a}_{f , k , - 1} & {a}_{f , k , - 2} & ⋯ & {a}_{f , k , - n + 1} \\ {a}_{f , k , 1} & {a}_{f , k , 0} & {a}_{f , k , - 1} & ⋱ & ⋮ \\ {a}_{f , k , 2} & {a}_{f , k , 1} & {a}_{f , k , 0} & ⋱ & {a}_{f , k , - 2} \\ ⋮ & ⋱ & ⋱ & ⋱ & {a}_{f , k , - 1} \\ {a}_{f , k , n - 1} & ⋯ & {a}_{f , k , 2} & {a}_{f , k , 1} & {a}_{f , k , 0}\end{matrix} ]}^{H} \qquad ( 13 )$$

where γₖ is a normalization factor. In one example, W₁^{(k)} is an SD basis (e.g., across P_{CSIRS} CSI-RS antenna ports), and W_{f}^{(k)} is an FD basis. The quantities a_{k,-n+1} . . . , a_{k,-1}, a_{k,0}, a_{k,1}, . . . , a_{k,n-1} and/or a_{f,k,-m+1} . . . , a_{f,k,1}, a_{f,k,0}, a_{f,k}, . . . , a_{f,k,m-1} in (13) can be configured to be determined by training an AI/ML model architecture. In another example, the quantities a_{k,-n+1} . . . , a_{k,-1}, a_{k,0}, a_{k,1}, . . . , a_{k,n-1} and/or a_{f,k,-m+1} . . . , a_{f,k,-1}, a_{f,k,0}, a_{f,k,1}, . . . , a_{f,k,m-1} in (13) can be configured from a candidate set of quantities. In another example, the quantities a_{k,-n+1} . . . a_{k,-1}, a_{k,0}, a_{k,1}, . . . , a_{k,n-1} and/or a_{f,k,-m+1} . . . , a_{f,k,-1}, a_{f,k,0}, a_{f,k,1}, . . . , a_{f,k,m-1} in (13) can be specified.

In one example, W₁^{(k)} can be the same for each layer k. In another example, W₁^{(k)} can be determined on a per-layer basis. In one example, W₂^{(k)} can be the same for each layer k. In another example, W₂^{(k)} can be determined on a per-layer basis. In one example, W_{f}^{(k)} can be the same for each layer k. In another example, W_{f}^{(k)} can be determined on a per-layer basis. Each combination of these examples can also be supported.

In a variation, for rank >1, for each layer k, the precoding matrix based on this disclosure has the following structure:

$${P}^{k} = \frac{1}{{γ}_{k}} {W}_{1}^{( k )} {W}_{2}^{( k )} {W}_{f}^{( k ) H} = \frac{1}{{γ}_{k}} [ \begin{matrix}{A}_{k , 1} & 0 \\ 0 & {A}_{k , 2}\end{matrix} ] {C}^{( k )} {A}_{f}^{( k ) H} \qquad ( 14 )$$

where γₖ is a normalization factor. In one example, W₁^{(k)} is an SD basis for two antenna groups (e.g., two antenna polarizations of the P_{CSIRS} CSI-RS antenna ports), and W_{f}^{(k)} is an FD basis. Here, A_{k,1} and A_{k,2} are associated with the two groups. In one example, A_{k,1}=A_{k,2}=Aₖ. In one example, A_{k,1} can be different from A_{k,2}.

In one embodiment, for the space and frequency domains, the precoding matrix based on this disclosure has the following structure:

$$P = \frac{1}{γ} {W}_{1} {W}_{2} {W}_{f}^{H} = \frac{1}{γ} {ACW}_{f}^{W} = \frac{1}{γ} [ \begin{matrix}{a}_{0} & {a}_{- 1} & {a}_{- 2} & ⋯ & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & ⋯ & {a}_{2} & {a}_{1} & {a}_{0}\end{matrix} ] [ \begin{matrix}{c}_{0 , 0} & {c}_{0 , 1} & & {c}_{0 , m - 1} \\ ⋮ & ⋮ & ⋯ & ⋮ \\ {c}_{n - 1 , 0} & {c}_{n - 1 , 1} & & {c}_{n - 1 , m - 1}\end{matrix} ] {W}_{f}^{H} \qquad ( 15 )$$

where γ is a normalization factor and W_{f} corresponds to a different basis from W₁ (e.g., the DFT basis that is used to perform FD compression in the Rel. 16 eType II codebook). In one example, W₁ is an SD basis (e.g., across P_{CSIRS} CSI-RS antenna ports). The quantities a₋ₙ₊₁ . . . , a₋₁, a₀, a₁, . . . , aₙ₋₁ in (15) can be configured to be determined by training an AI/ML model architecture. In another example, the quantities a₋ₙ₊₁ . . . , a₋₁, a₀, a₁, . . . , aₙ₋₁ in (15) can be configured from a candidate set of quantities. In another example, the quantities a₋ₙ₊₁ . . . , a₋₁, a₀, a₁, . . . , aₙ₋₁ in (15) can be specified.

In a variation, the precoding matrix based on this disclosure has the following structure:

$$P = \frac{1}{γ} {W}_{1} {W}_{2} {W}_{f}^{H} = \frac{1}{γ} [ \begin{matrix}{A}_{1} & 0 \\ 0 & {A}_{2}\end{matrix} ] C {W}_{f}^{H} \qquad ( 16 )$$

where γ is a normalization factor and W_{f} corresponds to a different basis from W₁ (e.g., the DFT basis that is used to perform FD compression in the Rel. 16 eType II codebook). In one example, W₁ is an SD basis for two antenna groups (e.g., two antenna polarizations of the P_{CSIRS} CSI-RS antenna ports). Here, A₁ and A₂ are associated with the two groups. In one example, A₁=A₂=A. In one example, A₁ can be different from A₂.

Likewise, for rank >1, for each layer k, in one embodiment, the precoding matrix based on this disclosure has the following structure:

$${P}^{k} = \frac{1}{{γ}_{k}} {W}_{1}^{( k )} {W}_{2}^{( k )} {W}_{f}^{( k ) H} = \frac{1}{{γ}_{k}} {A}^{( k )} {C}^{( k )} {W}_{f}^{( k ) H} = \frac{1}{{γ}_{k}} [ \begin{matrix}{a}_{k , 0} & {a}_{k , - 1} & {a}_{k , - 2} & ⋯ & {a}_{k , - n + 1} \\ {a}_{k , 1} & {a}_{k , 0} & {a}_{k , - 1} & ⋱ & ⋮ \\ {a}_{k , 2} & {a}_{k , 1} & {a}_{k , 0} & ⋱ & {a}_{k , - 2} \\ ⋮ & ⋱ & ⋱ & ⋱ & {a}_{k , - 1} \\ {a}_{k , n - 1} & ⋯ & {a}_{k , 2} & {a}_{k , 1} & {a}_{k , 0}\end{matrix} ] [ \begin{matrix}{c}_{k , 0 , 0} & {c}_{k , 0 , 1} & & {c}_{k , 0 , m - 1} \\ ⋮ & ⋮ & ⋯ & ⋮ \\ {c}_{k , n - 1 , 0} & {c}_{k , n - 1 , 1} & & {c}_{k , n - 1 , m - 1}\end{matrix} ] {w}_{f}^{( k ) H} \qquad ( 17 )$$

where γₖ is a normalization factor and W_{f}^{(k)} corresponds to a different basis from W₁^{(k)} (e.g., the DFT basis that is used to perform FD compression in the Rel. 16 eType II codebook). In one example, W₁^{(k)} is an SD basis (e.g., across P_{CSIRS} CSI-RS antenna ports). The quantities a_{k,-n+1} . . . , a_{k,-1}, a_{k,0}, a_{k,1}, . . . , a_{k,n-1} in (17) can be configured to be determined by training an AI/ML model architecture. In another example, the quantities a_{k,-n+1} . . . , a_{k,-1}, a_{k,0}, a_{k,1}, a_{k,n-1} in (17) can be configured from a candidate set of quantities. In another example, the quantities a_{k,-n+1} . . . , a_{k,-1}, a_{k,0}, a_{k,1}, . . . , a_{k,n-1} in (17) can be specified.

In one example, W₁^{(k)} can be the same for each layer k. In another example, W₁^{(k)} can be determined on a per-layer basis. In one example, W₂^{(k)} can be the same for each layer k. In another example, W₂^{(k)} can be determined on a per-layer basis. In one example, W_{f}^{(k)} can be the same for each layer k. In another example, W_{f}^{(k)} can be determined on a per-layer basis. Each combination of these examples can also be supported.

In a variation, for rank >1, for each layer k, the precoding matrix based on this disclosure has the following structure:

$${P}^{k} = \frac{1}{{γ}_{k}} {W}_{1}^{( k )} {W}_{2}^{( k )} {W}_{f}^{( k ) H} = \frac{1}{{γ}_{k}} [ \begin{matrix}{A}_{k , 1} & 0 \\ 0 & {A}_{k , 2}\end{matrix} ] {C}^{( k )} {W}_{f}^{( k ) H} \qquad ( 18 )$$

where γₖ is a normalization factor and W_{f}^{(k)} corresponds to a different basis from W₁^{(k)} (e.g., the DFT basis that is used to perform FD compression in the Rel. 16 eType II codebook). In one example, W₁^{(k)} is an SD basis for two antenna groups (e.g., two antenna polarizations of the P_{CSIRS} CSI-RS antenna ports). Here, A_{k,1} and A_{k,2} are associated with the two groups. In one example, A_{k,1}=A_{k,2}=Aₖ. In one example, A_{k,1} can be different from A_{k,2}.

In one embodiment, for the space and frequency domains, the precoding matrix based on this disclosure has the following structure:

$$( 19 )$$

$$P = \frac{1}{γ} {W}_{1} {W}_{2} {W}_{f}^{H} = \frac{1}{γ} {W}_{1} {CA}_{f}^{H} \text{} = \frac{1}{γ} {{W}_{1} [ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] [ \begin{matrix}{a}_{f , 0} & {a}_{f , - 1} & {a}_{f , - 2} & … & {a}_{f , - m + 1} \\ {a}_{f , 1} & {a}_{f , 0} & {a}_{f , - 1} & ⋱ & ⋮ \\ {a}_{f , 2} & {a}_{f , 1} & {a}_{f , 0} & ⋱ & {a}_{f , - 2} \\ ⋮ & ⋱ & ⋱ & ⋱ & {a}_{f , - 1} \\ {a}_{f , m - 1} & … & {a}_{f , 2} & {a}_{f , 1} & {a}_{f , 0}\end{matrix} ]}^{H}$$

where γ is a normalization factor and W₁ corresponds to a different basis from W_{f} (e.g., the DFT basis that is used to perform SD compression in the Rel. 16 eType II codebook). In one example, W_{f} is an FD basis. The quantities a_{f,-m+1} . . . , a_{f,-1}, a_{f,0}, a_{f,1}, . . . , a_{f,m-1} in (19) can be configured to be determined by training an AI/ML model architecture. In another example, the quantities a_{f,-m+1} . . . a_{f,-1}, a_{f,0}, a_{f,1}, . . . , a_{f,m-1} in (19) can be configured from a candidate set of quantities. In another example, the quantities a_{f,-m+1} . . . , a_{f,-1}, a_{f,0}, a_{f,1}, . . . , a_{f,m-1} in (19) can be specified.

Likewise, for rank >1, for each layer k, in one embodiment, the precoding matrix based on this disclosure has the following structure:

$$( 20 )$$

$${P}^{k} = \frac{1}{{γ}_{k}} {W}_{1}^{( k )} {W}_{2}^{( k )} {W}_{f}^{( k ) H} = \frac{1}{{γ}_{k}} {W}_{1}^{( k )} {C}_{k} {A}_{f}^{( k ) H} \text{} = \frac{1}{{γ}_{k}} {W}_{1}^{( k )} \text{} [ \begin{matrix}{c}_{k , 0 , 0} & {c}_{k , 0 , 1} & & {c}_{k , 0 , m - 1} \\ ⋮ & ⋮ & … & ⋮ \\ {c}_{k , n - 1 , 0} & {c}_{k , n - 1 , 1} & & {c}_{k , n - 1 , m - 1}\end{matrix} ] {[ \begin{matrix}{a}_{f , k , 0} & {a}_{f , k , - 1} & {a}_{f , k , - 2} & … & {a}_{f , k , - m + 1} \\ {a}_{f , k , 1} & {a}_{f , k , 0} & {a}_{f , k , - 1} & ⋱ & ⋮ \\ {a}_{f , k , 2} & {a}_{f , k , 1} & {a}_{f , k , 0} & ⋱ & {a}_{f , k , - 2} \\ ⋮ & ⋱ & ⋱ & ⋱ & {a}_{f , k , - 1} \\ {a}_{f , k , m - 1} & … & {a}_{f , k , 2} & {a}_{f , k , 1} & {a}_{f , k , 0}\end{matrix} ]}^{H}$$

where γₖ is a normalization factor and W₁^{(k)} corresponds to a different basis from W_{f}^{(k)} (e.g., the DFT basis that is used to perform SD compression in the Rel. 16 eType II codebook). In one example, W_{f}^{(k)} is an FD basis. The quantities a_{f,k,-m+1} . . . , a_{f,k,-1}, a_{f,k,0}, a_{f,k,1}, . . . , a_{f,k,m-1} in (20) can be configured to be determined by training an AI/ML model architecture. In another example, the quantities a_{f,k,-m+1} . . . , a_{f,k,-1}, a_{f,k,0}, a_{f,k,1}, . . . , a_{f,k,m-1} in (20) can be configured from a candidate set of quantities. In another example, the quantities a_{f,k,-m+1} . . . , a_{f,k,-1}, a_{f,k,0}, a_{f,k,1} . . . , a_{f,k,m-1} in (20) can be specified.

In one example, W₁^{(k)} can be the same for each layer k. In another example, W₁^{(k)} can be determined on a per-layer basis. In one example, W₂^{(k)} can be the same for each layer k. In another example, W₂^{(k)} can be determined on a per-layer basis. In one example, W_{f}^{(k)} can be the same for each layer k. In another example, W_{f}^{(k)} can be determined on a per-layer basis. Each combination of these examples can also be supported.

In a variation, the quantities a₋ₙ₊₁ . . . , a₋₁, a₀, a₁, . . . , aₙ₋₁ in (5), (11), and/or (15) can be selected from a DFT basis, i.e. each of these elements can have the form e^{j2πr/s}. In another variation, the quantities a_{f,-n+1} . . . , a_{f,-1}, a_{f,0}, a_{f,1}, . . . , a_{f,n-1} in (9) and/or a_{f,-m+1} . . . , a_{f,-1}, a_{f,0}, a_{f,1}, . . . , a_{f,m-1} in (11) and (19) can be selected from a DFT basis, i.e. each of these elements can have the form e^{j2πr/s}.

Likewise, for rank >1, for each layer k, the quantities a_{k,-n+1} . . . , a_{k,-1}, a_{k,0}, a_{k,1}, . . . , a_{k,n-1} in (7), (13), and/or (17) can be selected from a DFT basis, i.e. each of these elements can have the form e^{j2πr/s}. In another variation, the quantities a_{f,k,-n+1} . . . a_{f,k,-1}, a_{f,k,0}, a_{f,k,1}, . . . , a_{f,k,n-1} in (10) and/or a_{f,k,-m+1} . . . , a_{f,k,-1}, a_{f,k,0}, a_{f,k,1}, . . . , a_{f,k,m-1} in (13) and (20) can be selected from a DFT basis, i.e. each of these elements can have the form e^{j2πr/s}.

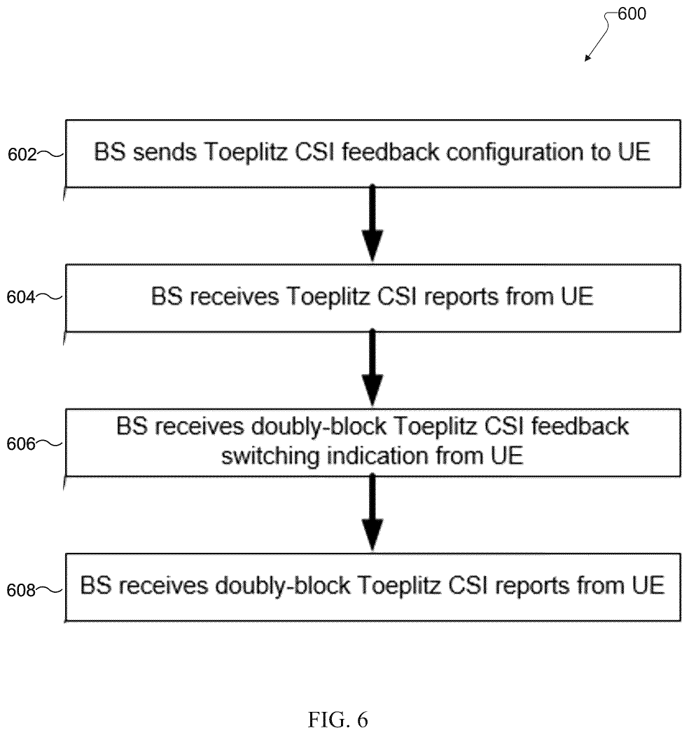

FIG. 6 illustrates a flowchart of an example BS procedure 600 to support UE-initiated switch to doubly-block Toeplitz CSI feedback/report method according to embodiments of the present disclosure. For example, procedure 600 to support UE-initiated switch to doubly-block Toeplitz CSI feedback/report method can be performed by the BS 102 of FIG. 1 and a complimentary method may be performed by the UE 116 of FIG. 3. This example is for illustration only and other embodiments can be used without departing from the scope of the present disclosure.

The procedure begins in 602, a BS sends a feedback configuration message for a CSI feedback/report method that utilizes a Toeplitz matrix to a UE. In 604, a BS receives a CSI report from a UE that has been generated based on a feedback/report method that utilizes a Toeplitz matrix. In 606, a BS receives a message from a UE that indicates a switch to a CSI feedback/report method that utilizes a doubly-block Toeplitz matrix. In one example, a dedicated/new MAC CE can be used for this message, or an existing MAC CE can be used for this message. In another example, this message can be sent on the physical uplink control channel (PUCCH) or the physical uplink shared channel (PUSCH), where a new uplink control information (UCI) format can be defined for this message, or an existing UCI format can be used for this message. If an existing UCI format is used for this message, this indication can be included as a part of UCI and therefore reported together with CSI feedback as, e.g., a 1-bit indication in a CSI report. In 608, a BS receives a CSI report from a UE that has been generated based on a feedback/report method that utilizes a doubly-block Toeplitz matrix.

In another example, a BS can pre-determine/configure information about the switching time to a CSI feedback/report method that utilizes a doubly-block Toeplitz matrix. In this case, 606 does not need to be performed; a BS can receive CSI reports from a UE that have been generated based on a feedback/report method that utilizes a doubly-block Toeplitz matrix at a pre-determined/configured time in 608.

In another example, between 606 and 608, a BS can perform 607. In 607, a BS can send an acknowledgement (ACK)/negative acknowledgement (NACK) to a UE in response to a received message from a UE that indicates a switch to a CSI feedback/report method that utilizes a doubly-block Toeplitz matrix. If a BS sends an ACK, then a UE switches to a CSI feedback/report method that utilizes a doubly-block Toeplitz matrix; a BS receives CSI reports from a UE that have been generated based on a feedback/report method that utilizes a doubly-block Toeplitz matrix in 608. If a BS sends a NACK, then a BS receives CSI reports from a UE that have been generated based on a feedback/report method that utilizes a Toeplitz matrix in 608. In 607, in another example, a BS can send a configuration message for a CSI feedback/report method that utilizes a doubly-block Toeplitz matrix to a UE.

In another example, a BS can enable/disable 606, 607, and 608, e.g., via RRC configuration. If these are disabled, then a BS continues receiving CSI reports from a UE that have been generated based on a feedback/report method that utilizes a Toeplitz matrix in 604.

In another example, a CSI feedback/report method that utilizes a Toeplitz matrix can be replaced by a traditional CSI feedback/report method in the preceding examples. In one example, this traditional CSI feedback/report method can correspond to the CSI feedback based on the Type I codebook or the Type II codebook.

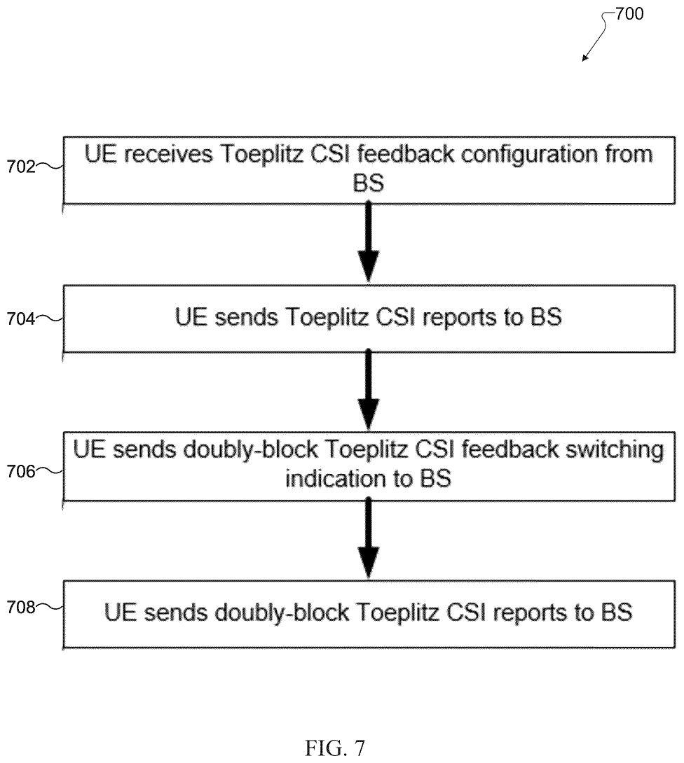

FIG. 7 illustrates a flowchart of an example UE procedure 700 to support UE-initiated switch to doubly-block Toeplitz CSI feedback/report method according to embodiments of the present disclosure. For example, procedure 700 to support UE-initiated switch to doubly-block Toeplitz CSI feedback/report method can be performed by the UE 116 of FIG. 3 and a complimentary process may be performed by the BS 102 of FIG. 1. This example is for illustration only and other embodiments can be used without departing from the scope of the present disclosure.

The procedure begins in 702, a UE receives a feedback configuration message for a CSI feedback/report method that utilizes a Toeplitz matrix from a BS. In 704, a UE sends CSI reports to a BS that have been generated based on a feedback/report method that utilizes a Toeplitz matrix. In 706, a UE sends a message to a BS that indicates a switch to a CSI feedback/report method that utilizes a doubly-block Toeplitz matrix. In one example, a dedicated/new MAC CE can be used for this message, or an existing MAC CE can be used for this message. In another example, this message can be sent on the PUCCH or the PUSCH, where a new UCI format can be defined for this message, or an existing UCI format can be used for this message. If an existing UCI format is used for this message, this indication can be included as a part of UCI and therefore reported together with CSI feedback, e.g., a 1-bit indication in a CSI report. In 708, a UE sends CSI reports to a BS that have been generated based on a feedback/report method that utilizes a doubly-block Toeplitz matrix.

In another example, a BS can pre-determine/configure information about the switching time to a CSI feedback/report method that utilizes a doubly-block Toeplitz matrix. In this case, 706 does not need to be performed; a UE can send CSI reports to a BS that have been generated based on a feedback/report method that utilizes a doubly-block Toeplitz matrix at a pre-determined/configured time in 708.

In another example, between 706 and 708, a UE can perform 707. In 707, a UE can receive an ACK/NACK from a BS in response to a received message from a UE that indicates a switch to a CSI feedback/report method that utilizes a doubly-block Toeplitz matrix. If a UE receives an ACK, then a UE switches to a CSI feedback/report method that utilizes a doubly-block Toeplitz matrix; a UE sends CSI reports to a BS that have been generated based on a feedback/report method that utilizes a doubly-block Toeplitz matrix in 708. If a UE receives a NACK, then a UE sends CSI reports to a BS that have been generated based on a feedback/report method that utilizes a Toeplitz matrix in 708. In 707, in another example, a UE can receive a configuration message for a CSI feedback/report method that utilizes a doubly-block Toeplitz matrix from a BS.

In another example, a BS can enable/disable 706, 707, and 708, e.g., via RRC configuration. If these are disabled, then a UE continues sending CSI reports to a BS that have been generated based on a feedback/report method that utilizes a Toeplitz matrix in 704.

In another example, a CSI feedback/report method that utilizes a Toeplitz matrix can be replaced by a traditional CSI feedback/report method in the preceding examples. In one example, this traditional CSI feedback/report method can correspond to the CSI feedback based on the Type I codebook or the Type II codebook.

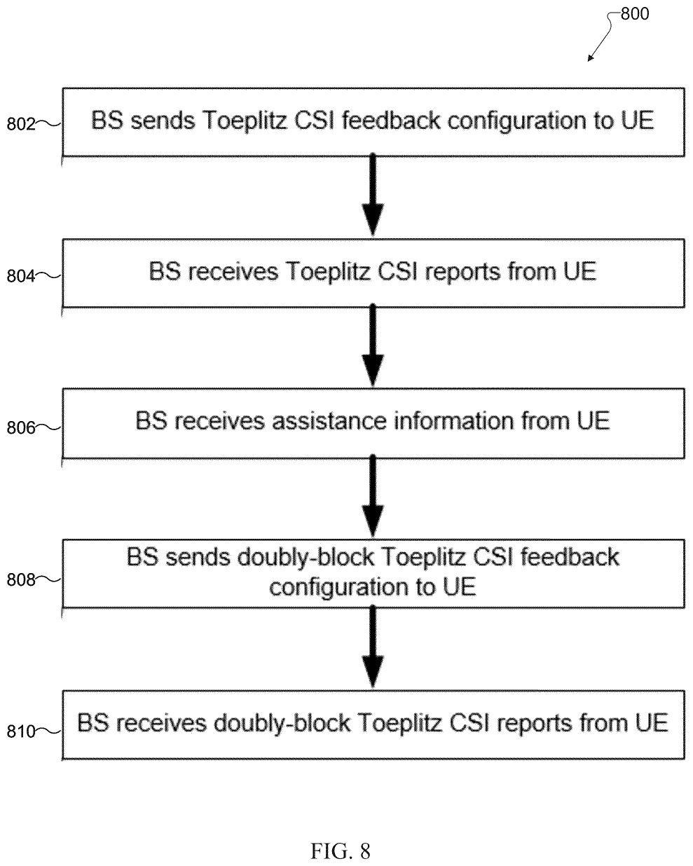

FIG. 8 illustrates a flowchart of an example BS procedure 800 to support BS-initiated switch to doubly-block Toeplitz CSI feedback/report method according to embodiments of the present disclosure. For example, procedure 800 to support BS-initiated switch to doubly-block Toeplitz CSI feedback/report method can be performed by the BS 102 of FIG. 1. This example is for illustration only and other embodiments can be used without departing from the scope of the present disclosure.

The procedure begins in 802, a BS sends a feedback configuration message for a CSI feedback/report method that utilizes a Toeplitz matrix to a UE. In 804, a BS receives a CSI report from a UE that has been generated based on a feedback/report method that utilizes a Toeplitz matrix. In 806, a BS receives assistance information from a UE; the assistance information can include a recommendation for switching to a CSI feedback/report method that utilizes a doubly-block Toeplitz matrix, which will be described in the “UE assistance information” section later in this disclosure. In 808, a BS sends a feedback configuration message for a CSI feedback/report method that utilizes a doubly-block Toeplitz matrix to a UE. In 810, a BS receives a CSI report from a UE that has been generated based on a feedback/report method that utilizes a doubly-block Toeplitz matrix.

In another example, a CSI feedback/report method that utilizes a Toeplitz matrix can be replaced by a traditional CSI feedback/report method in the preceding examples. In one example, this traditional CSI feedback/report method can correspond to the CSI feedback based on the Type I codebook or the Type II codebook.

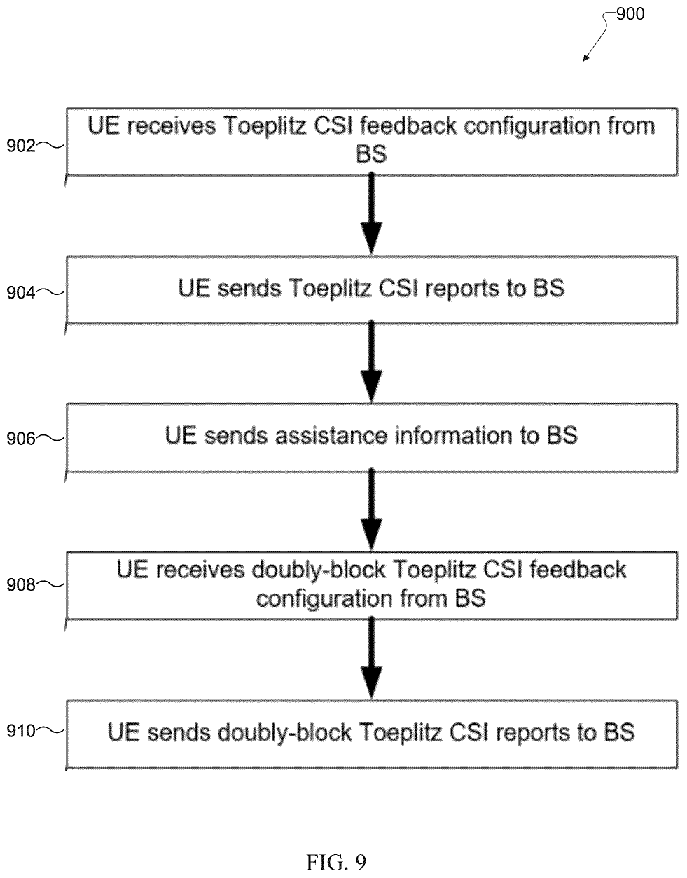

FIG. 9 illustrates a flowchart of an example UE procedure 900 to support BS-initiated switch to doubly-block Toeplitz CSI feedback/report method according to embodiments of the present disclosure. For example, procedure 900 to support BS-initiated switch to doubly-block Toeplitz CSI feedback/report method may be performed by the UE 116 of FIG. 3 and a complimentary procedure may be performed by the BS 102 of FIG. 1. This example is for illustration only and other embodiments can be used without departing from the scope of the present disclosure.

The procedure begins in 902, a UE receives a feedback configuration message for a CSI feedback/report method that utilizes a Toeplitz matrix from a BS. In 904, a UE sends a CSI report to a BS that has been generated based on a feedback/report method that utilizes a Toeplitz matrix. In 906, a UE sends assistance information to a BS; the assistance information can include a recommendation for switching to a CSI feedback/report method that utilizes a doubly-block Toeplitz matrix, which will be described in the “UE assistance information” section later in this disclosure. In 908, a UE receives a feedback configuration message for a CSI feedback/report method that utilizes a doubly-block Toeplitz matrix from a BS. In 910, a UE sends a CSI report to a BS that has been generated based on a feedback/report method that utilizes a doubly-block Toeplitz matrix.

In another example, a CSI feedback/report method that utilizes a Toeplitz matrix can be replaced by a traditional CSI feedback/report method in the preceding examples. In one example, this traditional CSI feedback/report method can correspond to the CSI feedback based on the Type I codebook or the Type II codebook.

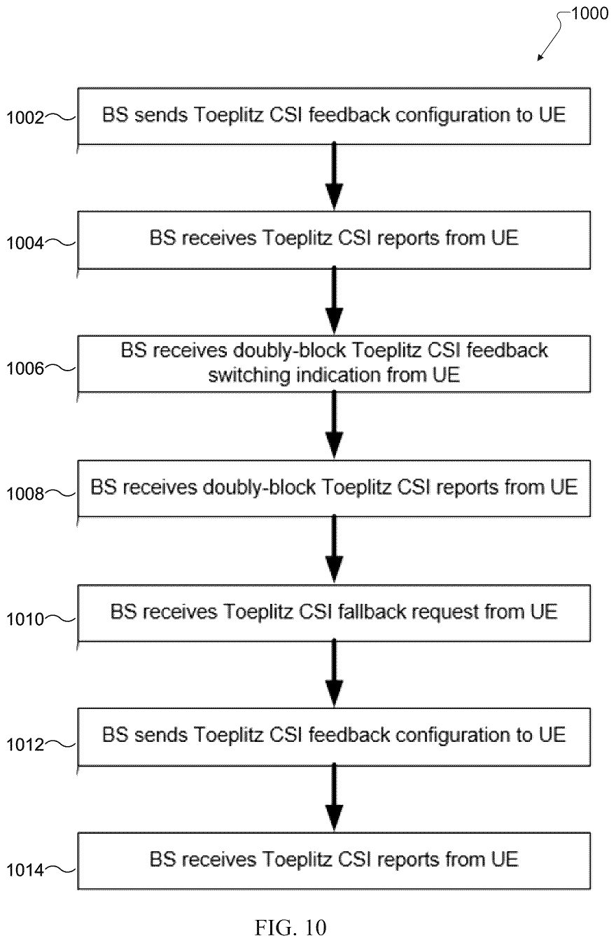

FIG. 10 illustrates a flowchart of an example BS procedure 1000 to support UE-initiated fallback to Toeplitz CSI feedback/report method according to embodiments of the present disclosure. For example, procedure 1000 may be performed by the BS 102 of FIG. 1 and a complimentary procedure may be performed by the UE 116 of FIG. 3. This example is for illustration only and other embodiments can be used without departing from the scope of the present disclosure.

The procedure begins in 1002, a BS sends a feedback configuration message for a CSI feedback/report method that utilizes a Toeplitz matrix to a UE. In 1004, a BS receives a CSI report from a UE that has been generated based on a feedback/report method that utilizes a Toeplitz matrix. In 1006, a BS receives a message from a UE that indicates a switch to a CSI feedback/report method that utilizes a doubly-block Toeplitz matrix. In one example, a dedicated/new MAC CE can be used for this message, or an existing MAC CE can be used for this message. In another example, this message can be sent on the PUCCH or the PUSCH, where a new UCI format can be defined for this message, or an existing UCI format can be used for this message. If an existing UCI format is used for this message, this indication can be included as a part of UCI and therefore reported together with CSI feedback as, e.g., a 1-bit indication in a CSI report. In 1008, a BS receives a CSI report from a UE that has been generated based on a feedback/report method that utilizes a doubly-block Toeplitz matrix. In 1010, a BS receives a message from a UE that corresponds to a request to fall back to a CSI feedback/report method that utilizes a Toeplitz matrix, which will be described in the “Toeplitz CSI fallback request” section later in this disclosure. In 1012, a BS sends a feedback configuration message for a CSI feedback/report method that utilizes a Toeplitz matrix to a UE. In 1014, a BS receives a CSI report from a UE that has been generated based on a feedback/report method that utilizes a Toeplitz matrix.

In another example, a BS can pre-determine/configure information about the switching time to a CSI feedback/report method that utilizes a doubly-block Toeplitz matrix. In this case, 1006 does not need to be performed; a BS can receive CSI reports from a UE that have been generated based on a feedback/report method that utilizes a doubly-block Toeplitz matrix at a pre-determined/configured time in 1008.

In another example, between 1006 and 1008, a BS can perform 1007. In 1007, a BS can send an ACK/NACK to a UE in response to a received message from a UE that indicates a switch to a CSI feedback/report method that utilizes a doubly-block Toeplitz matrix. If a BS sends an ACK, then a UE switches to a CSI feedback/report method that utilizes a doubly-block Toeplitz matrix; a BS receives CSI reports from a UE that have been generated based on a feedback/report method that utilizes a doubly-block Toeplitz matrix in 1008. If a BS sends a NACK, then a BS receives CSI reports from a UE that have been generated based on a feedback/report method that utilizes a Toeplitz matrix in 1008. In 1007, in another example, a BS can send a configuration message for a CSI feedback/report method that utilizes a doubly-block Toeplitz matrix to a UE.

In another example, a BS can enable/disable 1006, 1007, and 1008, e.g., via RRC configuration. If these are disabled, then a BS continues receiving CSI reports from a UE that have been generated based on a feedback/report method that utilizes a Toeplitz matrix in 1004.

In another example, a CSI feedback/report method that utilizes a Toeplitz matrix can be replaced by a traditional CSI feedback/report method in the preceding examples. In one example, this traditional CSI feedback/report method can correspond to the CSI feedback based on the Type I codebook or the Type II codebook.

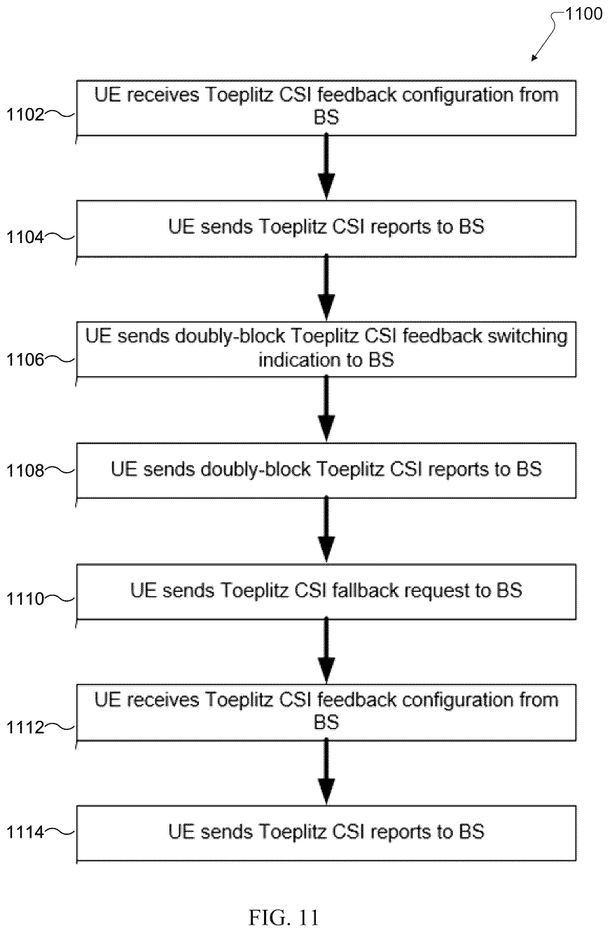

FIG. 11 illustrates a flowchart of an example UE procedure 1100 to support UE-initiated fallback to Toeplitz CSI feedback/report method according to embodiments of the present disclosure. For example, procedure 100 to support UE-initiated fallback to Toeplitz CSI feedback/report method can be performed by any of the UEs 111-116 of FIG. 1, such as the UE 116. This example is for illustration only and other embodiments can be used without departing from the scope of the present disclosure.

The procedure being in 1102, a UE receives a feedback configuration message for a CSI feedback/report method that utilizes a Toeplitz matrix from a BS. In 1104, a UE sends CSI reports to a BS that have been generated based on a feedback/report method that utilizes a Toeplitz matrix. In 1106, a UE sends a message to a BS that indicates a switch to a CSI feedback/report method that utilizes a doubly-block Toeplitz matrix. In one example, a dedicated/new MAC CE can be used for this message, or an existing MAC CE can be used for this message. In another example, this message can be sent on the PUCCH or the PUSCH, where a new UCI format can be defined for this message, or an existing UCI format can be used for this message. If an existing UCI format is used for this message, this indication can be included as a part of UCI and therefore reported together with CSI feedback, e.g., a 1-bit indication in a CSI report. In 1108, a UE sends CSI reports to a BS that have been generated based on a feedback/report method that utilizes a doubly-block Toeplitz matrix. In 1110, a UE sends a message to a BS that corresponds to a request to fall back to a CSI feedback/report method that utilizes a Toeplitz matrix, which will be described in the “Toeplitz CSI fallback request” section later in this disclosure. In 1112, a UE receives a feedback configuration message for a CSI feedback/report method that utilizes a Toeplitz matrix from a BS. In 1114, a UE sends a CSI report to a BS that has been generated based on a feedback/report method that utilizes a Toeplitz matrix.

In another example, a BS can pre-determine/configure information about the switching time to a CSI feedback/report method that utilizes a doubly-block Toeplitz matrix. In this case, 1106 does not need to be performed; a UE can send CSI reports to a BS that have been generated based on a feedback/report method that utilizes a doubly-block Toeplitz matrix at a pre-determined/configured time in 1108.

In another example, between 1106 and 1108, a UE can perform 1107. In 1107, a UE can receive an ACK/NACK from a BS in response to a received message from a UE that indicates a switch to a CSI feedback/report method that utilizes a doubly-block Toeplitz matrix. If a UE receives an ACK, then a UE switches to a CSI feedback/report method that utilizes a doubly-block Toeplitz matrix; a UE sends CSI reports to a BS that have been generated based on a feedback/report method that utilizes a doubly-block Toeplitz matrix in 1108. If a UE receives a NACK, then a UE sends CSI reports to a BS that have been generated based on a feedback/report method that utilizes a Toeplitz matrix in 1108. In 1107, in another example, a UE can receive a configuration message for a CSI feedback/report method that utilizes a doubly-block Toeplitz matrix from a BS.

In another example, a BS can enable/disable 1106, 1107, and 1108, e.g., via RRC configuration. If these are disabled, then a UE continues sending CSI reports to a BS that have been generated based on a feedback/report method that utilizes a Toeplitz matrix in 1104.

In another example, a CSI feedback/report method that utilizes a Toeplitz matrix can be replaced by a traditional CSI feedback/report method in the preceding examples. In one example, this traditional CSI feedback/report method can correspond to the CSI feedback based on the Type I codebook or the Type II codebook.

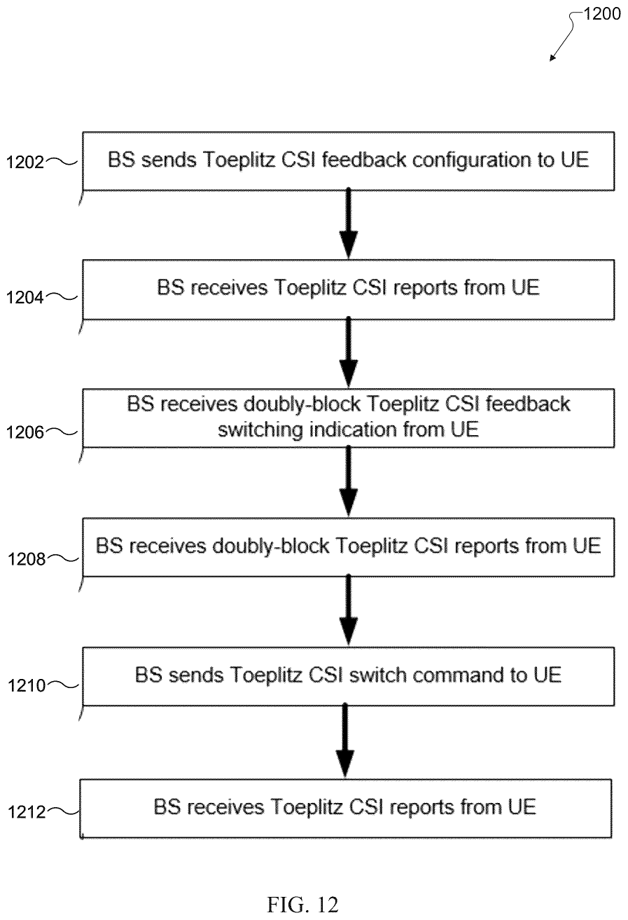

FIG. 12 illustrates a flowchart of an example BS procedure 1200 to support BS-initiated fallback to Toeplitz CSI feedback/report method according to embodiments of the present disclosure. For example, procedure 1200 to support BS-initiated fallback to Toeplitz CSI feedback/report can be performed by the BS 102 of FIG. 1. This example is for illustration only and other embodiments can be used without departing from the scope of the present disclosure.

The procedure begins in 1202, a BS sends a feedback configuration message for a CSI feedback/report method that utilizes a Toeplitz matrix to a UE. In 1204, a BS receives a CSI report from a UE that has been generated based on a feedback/report method that utilizes a Toeplitz matrix. In 1206, a BS receives a message from a UE that indicates a switch to a CSI feedback/report method that utilizes a doubly-block Toeplitz matrix. In one example, a dedicated/new MAC CE can be used for this message, or an existing MAC CE can be used for this message. In another example, this message can be sent on the PUCCH or the PUSCH, where a new UCI format can be defined for this message, or an existing UCI format can be used for this message. If an existing UCI format is used for this message, this indication can be included as a part of UCI and therefore reported together with CSI feedback as, e.g., a 1-bit indication in a CSI report. In 1208, a BS receives a CSI report from a UE that has been generated based on a feedback/report method that utilizes a doubly-block Toeplitz matrix. In 1210, a BS sends a message to a UE that corresponds to a command to fall back to a CSI feedback/report method that utilizes a Toeplitz matrix. In 1212, a BS receives a CSI report from a UE that has been generated based on a feedback/report method that utilizes a Toeplitz matrix.

In another example, a BS can pre-determine/configure information about the switching time to a CSI feedback/report method that utilizes a doubly-block Toeplitz matrix. In this case, 1206 does not need to be performed; a BS can receive CSI reports from a UE that have been generated based on a feedback/report method that utilizes a doubly-block Toeplitz matrix at a pre-determined/configured time in 1208.

In another example, between 1206 and 1208, a BS can perform 1207. In 1207, a BS can send an ACK/NACK to a UE in response to a received message from a UE that indicates a switch to a CSI feedback/report method that utilizes a doubly-block Toeplitz matrix. If a BS sends an ACK, then a UE switches to a CSI feedback/report method that utilizes a doubly-block Toeplitz matrix; a BS receives CSI reports from a UE that have been generated based on a feedback/report method that utilizes a doubly-block Toeplitz matrix in 1208. If a BS sends a NACK, then a BS receives CSI reports from a UE that have been generated based on a feedback/report method that utilizes a Toeplitz matrix in 1208. In 1207, in another example, a BS can send a configuration message for a CSI feedback/report method that utilizes a doubly-block Toeplitz matrix to a UE.

In another example, a BS can enable/disable 1206, 1207, and 1208, e.g., via RRC configuration. If these are disabled, then a BS continues receiving CSI reports from a UE that have been generated based on a feedback/report method that utilizes a Toeplitz matrix in 1204.

In another example, a CSI feedback/report method that utilizes a Toeplitz matrix can be replaced by a traditional CSI feedback/report method in the preceding examples. In one example, this traditional CSI feedback/report method can correspond to the CSI feedback based on the Type I codebook or the Type II codebook.

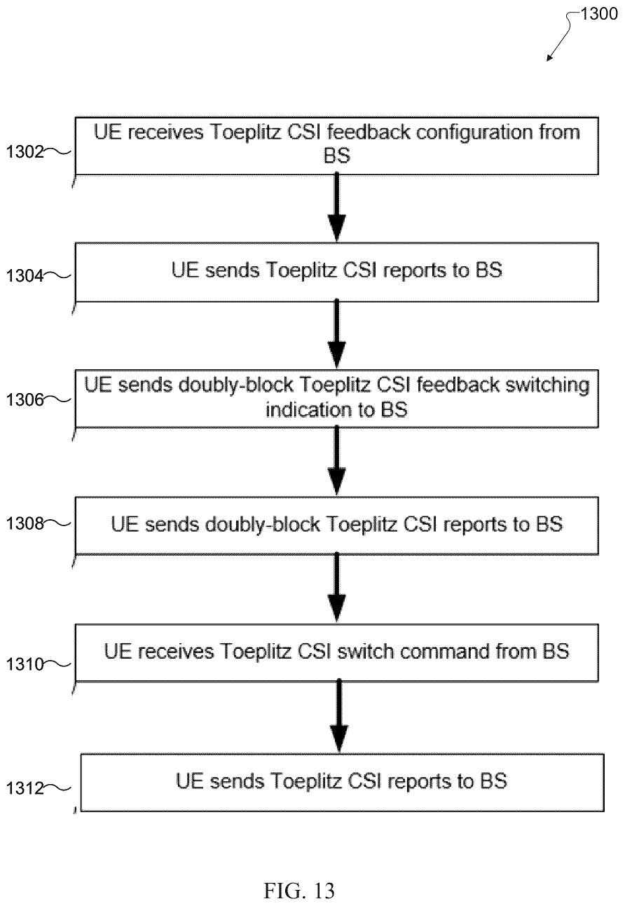

FIG. 13 illustrates a flowchart of an example UE procedure 1300 to support BS-initiated fallback to Toeplitz CSI report according to embodiments of the present disclosure. For example, procedure 1300 to support BS-initiated fallback to Toeplitz CSI feedback/report method can be performed by the UE 116 of FIG. 3 and a complimentary procedure may be performed by the BS 102 of FIG. 1. This example is for illustration only and other embodiments can be used without departing from the scope of the present disclosure.

The procedure begins in 1302, a UE receives a feedback configuration message for a CSI feedback/report method that utilizes a Toeplitz matrix from a BS. In 1304, a UE sends CSI reports to a BS that have been generated based on a feedback/report method that utilizes a Toeplitz matrix. In 1306, a UE sends a message to a BS that indicates a switch to a CSI feedback/report method that utilizes a doubly-block Toeplitz matrix. In one example, a dedicated/new MAC CE can be used for this message, or an existing MAC CE can be used for this message. In another example, this message can be sent on the PUCCH or the PUSCH, where a new UCI format can be defined for this message, or an existing UCI format can be used for this message. If an existing UCI format is used for this message, this indication can be included as a part of UCI and therefore reported together with CSI feedback, e.g., a 1-bit indication in a CSI report. In 1308, a UE sends CSI reports to a BS that have been generated based on a feedback/report method that utilizes a doubly-block Toeplitz matrix. In 1310, a UE receives a message from a BS that corresponds to a command to fall back to a CSI feedback/report method that utilizes a Toeplitz matrix. In 1312, a UE sends a CSI report to a BS that has been generated based on a feedback/report method that utilizes a Toeplitz matrix.

In another example, a BS can pre-determine/configure information about the switching time to a CSI feedback/report method that utilizes a doubly-block Toeplitz matrix. In this case, 1306 does not need to be performed; a UE can send CSI reports to a BS that have been generated based on a feedback/report method that utilizes a doubly-block Toeplitz matrix at a pre-determined/configured time in 1308.

In another example, between 1306 and 1308, a UE can perform 1307. In 1307, a UE can receive an ACK/NACK from a BS in response to a received message from a UE that indicates a switch to a CSI feedback/report method that utilizes a doubly-block Toeplitz matrix. If a UE receives an ACK, then a UE switches to a CSI feedback/report method that utilizes a doubly-block Toeplitz matrix; a UE sends CSI reports to a BS that have been generated based on a feedback/report method that utilizes a doubly-block Toeplitz matrix in 1308. If a UE receives a NACK, then a UE sends CSI reports to a BS that have been generated based on a feedback/report method that utilizes a Toeplitz matrix in 1308. In 1307, in another example, a UE can receive a configuration message for a CSI feedback/report method that utilizes a doubly-block Toeplitz matrix from a BS.

In another example, a BS can enable/disable 1306, 1307, and 1308, e.g., via RRC configuration. If these operations are disabled, then a UE continues sending CSI reports to a BS that have been generated based on a feedback/report method that utilizes a Toeplitz matrix in 1304.

In another example, a CSI feedback/report method that utilizes a Toeplitz matrix can be replaced by a traditional CSI feedback/report method in the preceding examples. In one example, this traditional CSI feedback/report method can correspond to the CSI feedback based on the Type I codebook or the Type II codebook.

In one embodiment, a BS can configure a UE to send an indication of switching to a CSI feedback/report method that utilizes a doubly-block Toeplitz matrix via RRC configuration. Table 1 is an example of modifying an IE PUSCH-Config to configure a UE to send this switching indication. In this example, doublyBlockToeplitzCBSwitch, if present, corresponds to this switching indication. In another example, an IE PUCCH-Config can be modified to configure a UE to send this switching indication.

TABLE 1
PUSCH-Config ::= SEQUENCE {
...
doublyBlockToeplitzCBSwitch BOOLEAN OPTIONAL, -- Need M
...
}

In one embodiment, a BS can configure a UE to send an indication of switching to a CSI feedback/report method that utilizes a doubly-block Toeplitz matrix via MAC CE activation command.

In one embodiment, a BS can configure a UE to send an indication of switching to a CSI feedback/report method that utilizes a doubly-block Toeplitz matrix via downlink control information (DCI).

In another embodiment, a BS can configure a UE to send an indication of switching to a CSI feedback/report method that utilizes a Toeplitz matrix, a circulant matrix, or a doubly-block circulant matrix.

In another embodiment, a BS can configure a UE to use a Toeplitz-based CSI feedback/report method via a physical downlink control channel (PDCCH) order, where a new DCI format can be defined and this PDCCH order can be triggered by this new DCI format.

In another example, a BS can configure a UE to use a Toeplitz-based CSI feedback/report method via MAC CE activation command.

In another example, a BS can configure a UE to use a Toeplitz-based CSI feedback/report method via RRC configuration. Table 2 is an example of modifying an IE CodebookConfig to configure a UE to use a Toeplitz-based CSI feedback/report method. For CodebookConfig, typeToeplitz, if present, determines which Toeplitz codebook out of a pre-defined set of Toeplitz codebooks are enabled; typeDBToeplitz, if present, determines which doubly-block Toeplitz codebook out of a pre-defined set of doubly-block Toeplitz codebooks are enabled.

TABLE 2

| CodebookConfig ::= SEQUENCE { | |
|---|---|
| codebookType | CHOICE { |
| ... | |
| typeToeplitz | SEQUENCE { |
| toeplitzIndex | INTEGER (1..NrToeplitzCB) |
| | OPTIONAL, -- Need M |
| }, | |
| typeDBToeplitz | SEQUENCE { |
| dbToeplitzIndex | INTEGER (1..NrDBToeplitzCB) |
| | OPTIONAL, -- Need M |
| }, | |
| } | |
| } | |

In one example, one Toeplitz (or circulant, doubly-block Toeplitz, doubly-block circulant) codebook is defined for each CSI-ResourceConfig (with a corresponding entry in csi-ResourceConfigId). In another example, one Toeplitz (or circulant, doubly-block Toeplitz, doubly-block circulant) codebook is defined for each CSI-ResourceConfigs (where each CSI-ResourceConfig has an entry in csi-ResourceConfigId).

In one example, a Toeplitz (or circulant) codebook can be configured to compress a precoder matrix in SD (e.g. if the rows of the precoder matrix correspond to the antenna ports at a gNB, then a Toeplitz (or circulant) codebook can be configured, where this codebook is equivalent to an (m, 1) 1-D convolution kernel in a CNN layer in an AI/ML model architecture). In another example, a Toeplitz (or circulant) codebook can be configured to compress a precoder matrix in FD (e.g. if the columns of the precoder matrix correspond to the SBs, then a Toeplitz (or circulant) codebook can be configured, where this codebook is equivalent to a (1, n) 1-D convolution kernel in a CNN layer in an AI/ML model architecture). In another example, a doubly-block Toeplitz (or doubly-block circulant) codebook can be configured to compress a precoder matrix in SD and FD (e.g. a doubly-block Toeplitz (or doubly-block circulant) codebook can be configured, where this codebook is equivalent to an (m, n) 2-D convolution kernel in a CNN layer in an AI/ML model architecture).

In one example, a Toeplitz (or circulant, doubly-block Toeplitz, doubly-block circulant) codebook can be configured to be trained based on an AI/ML model architecture; in this case, this codebook is determined by a training dataset. In another example, a Toeplitz (or circulant, doubly-block Toeplitz, doubly-block circulant) codebook can be configured from a candidate set of Toeplitz (or circulant, doubly-block Toeplitz, doubly-block circulant) matrices. In another example, a fixed Toeplitz (or circulant, doubly-block Toeplitz, doubly-block circulant) codebook can be specified.

In one example, typeToeplitz and typeDBToeplitz can be configured as aperiodic, semi-persistent, or periodic. This can facilitate adaptation to time-varying channel statistics. If one Toeplitz (or circulant, doubly-block Toeplitz, doubly-block circulant) codebook is defined for each CSI-ResourceConfig, then this can facilitate adaptation to frequency-varying channel statistics.

In one example, multiple Toeplitz (or circulant, doubly-block Toeplitz, doubly-block circulant) codebooks can be configured to be trained based on an AI/ML model architecture, where this architecture includes a single CNN layer that utilizes multiple filters; in this example, each Toeplitz (or circulant, doubly-block Toeplitz, doubly-block circulant) codebook could correspond to a single filter. In another example, multiple Toeplitz (or circulant, doubly-block Toeplitz, doubly-block circulant) codebooks can be configured in a deterministic manner, e.g., from a fixed set of Toeplitz (or circulant, doubly-block Toeplitz, doubly-block circulant) matrices. The products of the precoder matrix with each of these codebooks can be summed. In another example, a UE can be configured to only select one of these products.

In one example, each entry of a configured Toeplitz (or circulant, doubly-block Toeplitz, doubly-block circulant) codebook (i.e., the full matrix that corresponds to this codebook) can be signaled to a UE. In another example, only the first row and first column of a configured Toeplitz codebook can be signaled to a UE. In another example, only the nonzero entries in the first row and first column of a configured Toeplitz codebook can be signaled to a UE. The signaled entries can be tagged with their corresponding row and column indices.

In another example, only the first row and first column of each Toeplitz matrix in a configured doubly-block Toeplitz codebook can be signaled to a UE. In another example, only the nonzero entries in the first row and first column of each Toeplitz matrix in a configured doubly-block Toeplitz codebook can be signaled to a UE. In another example, only the first block row and first block column in a configured doubly-block Toeplitz codebook can be signaled to a UE. For each Toeplitz matrix in the first block row and first block column, only the first row and first column can be signaled to a UE (or only the nonzero entries in the first row and first column can be signaled to a UE). The signaled entries can be tagged with their corresponding row and column (or block row and block column) indices.

In another example, only the first column of a configured circulant codebook (i.e., the representer polynomial [8] of the circulant matrix that corresponds to this codebook) can be signaled to a UE. In another example, only the nonzero entries in the first column of a configured circulant codebook can be signaled to a UE. The signaled entries can be tagged with their corresponding row and column indices.

In another example, only the first column of each circulant matrix (i.e., its representer polynomial) in a configured doubly-block circulant codebook can be signaled to a UE. In another example, only the nonzero entries in the first column of each circulant matrix in a configured doubly-block circulant codebook can be signaled to a UE. In another example, only the first block column in a configured doubly-block circulant codebook can be signaled to a UE. For each circulant matrix in the first block column, only the first column (i.e., its representer polynomial) can be signaled to a UE (or only the nonzero entries in the first column can be signaled to a UE). The signaled entries can be tagged with their corresponding row (or block row) indices.

In another example, only the number of rows (and/or block rows) and/or columns (and/or block columns) of a configured Toeplitz (or circulant, doubly-block Toeplitz, doubly-block circulant) matrix can be signaled to a UE. A UE can then select a Toeplitz (or circulant, doubly-block Toeplitz, doubly-block circulant) matrix from a pre-defined set of Toeplitz (or circulant, doubly-block Toeplitz, doubly-block circulant) matrices according to the number of configured rows (and/or block rows) and/or columns (and/or block columns) and then indicate the selected matrix (e.g. an index to this pre-defined set) to a BS.

In another example, only the sparsity of a configured Toeplitz (or circulant, doubly-block Toeplitz, doubly-block circulant) codebook can be signaled to a UE. In one example, a BS can configure a UE with a sparsity value from a pre-defined set of sparsity values. A UE can then select a Toeplitz (or circulant, doubly-block Toeplitz, doubly-block circulant) matrix from a pre-defined set of Toeplitz (or circulant, doubly-block Toeplitz, doubly-block circulant) matrices according to the configured sparsity and then indicate the selected matrix (e.g., an index to this pre-defined set) to a BS.

In another example, each set of CSI-ResourceConfigs can be partitioned into disjoint subsets, and one Toeplitz (or circulant, doubly-block Toeplitz, doubly-block circulant) codebook can be mapped to one of these subsets. This partition can be configured as aperiodic, semi-persistent, or periodic.

Let (n1, n2) represent the number of antenna ports in the first (n1) and second (n2) dimensions. In one example, one Toeplitz (or circulant, doubly-block Toeplitz, doubly-block circulant) codebook can be defined for each supported combination of (n1, n2). In another example, one Toeplitz (or circulant, doubly-block Toeplitz, doubly-block circulant) codebook can be defined for each supported combination of (n1, n2), where appropriate pre-processing can be performed on the input to this Toeplitz (or circulant, doubly-block Toeplitz, doubly-block circulant) codebook.

The CodebookConfig IE can also be modified to configure a UE to use Toeplitz (or circulant, doubly-block Toeplitz, doubly-block circulant) codebooks for generating/reporting CSI feedback in a multi-TRP system, wherein the UE 116 can receive DL reception from or transmit UL transmission to multiple TRPs. In one example, a TRP is functionally equivalent to (or corresponds to) a non-zero power (NZP) CSI-RS resource, or a CSI-RS resource set, or a group of antenna ports. In one example, one Toeplitz (or circulant, doubly-block Toeplitz, doubly-block circulant) codebook is defined for each TRP (where each TRP can belong to a particular CORESET pool; each codebook can have a corresponding CORESET Pool ID). In another example, one Toeplitz (or circulant, doubly-block Toeplitz, doubly-block circulant) codebook is defined for each TRP (where the CORESET Pool ID for each TRP is mapped to this codebook).

In another embodiment, a BS can configure a UE to use batch normalization after applying a Toeplitz (or circulant, doubly-block Toeplitz, doubly-block circulant) codebook via RRC configuration. Table 3 is an example of modifying an IE CodebookConfig to configure a UE to use batch normalization after applying a Toeplitz or doubly-block Toeplitz codebook for generating/reporting CSI feedback. For CodebookConfig, gammaIndex and betaIndex, if present, determine the parameters that are applied for batch normalization. In one example, these values can be configured from a pre-defined set of parameters. In one example, the product of the desired values with a pre-defined constant N (rounded to the nearest integer) can be signaled to a UE; the signaled values can then be divided by N to obtain the desired values. In one example, if gammaIndex maps to a value of 1 and betaIndex maps to a value of 0, then batch normalization is disabled. gammaIndex and betaIndex can be configured as aperiodic, semi-persistent, or periodic. If one Toeplitz or doubly-block Toeplitz codebook is defined for each CSI-ResourceConfig, then gammaIndex and betaIndex can be configured for each CSI-ResourceConfig.

TABLE 3
CodebookConfig ::= SEQUENCE {

| | |
|---|---|
| codebookType | CHOICE { |
| ... | |
| typeToeplitz | SEQUENCE { |
| gammaIndex | INTEGER (1..NrGamma) OPTIONAL, -- |
| | Need M |
| betaIndex | INTEGER (1..NrBeta) OPTIONAL, -- |
| | Need M |
| ... | |
| }, | |
| typeDBToeplitz | SEQUENCE { |
| gammaIndex | INTEGER (1..NrGamma) OPTIONAL, -- |
| | Need M |
| betaIndex | INTEGER (1..NrBeta) OPTIONAL, -- |
| | Need M |
| ... | |
| }, | |
| } | |
| } | |

In another embodiment, a BS can configure a UE to use nonlinear operations after applying a Toeplitz (or circulant, doubly-block Toeplitz, doubly-block circulant) codebook via RRC configuration. Table 4 is an example of modifying an IE CodebookConfig to configure a UE to use nonlinear operations after applying a Toeplitz or doubly-block Toeplitz codebook for generating/reporting CSI feedback. For CodebookConfig, pReLUIndex, if present, determines the parameters that are applied for nonlinear operations. In one example, these values can be configured from a pre-defined set of parameters. In one example, the product of the desired values with a pre-defined constant N (rounded to the nearest integer) can be signaled to a UE; the signaled values can then be divided by N to obtain the desired values. In one example, if pReLUIndex maps to a value of 0, then nonlinear operations can be either disabled, or non-parametric nonlinear operations can be enabled. pReLUIndex can be configured as aperiodic, semi-persistent, or periodic. If one Toeplitz or doubly-block Toeplitz codebook is defined for each CSI-ResourceConfig, then pReLUIndex can be configured for each CSI-ResourceConfig.

TABLE 4
CodebookConfig ::= SEQUENCE {

| | |
|---|---|
| codebookType | CHOICE { |
| ... | |
| typeToeplitz | SEQUENCE { |
| pReLUIndex | INTEGER (1..NrPReLU) OPTIONAL, -- |
| | Need M |
| }, | |
| typeDBToeplitz | SEQUENCE { |
| pReLUIndex | INTEGER (1..NrPReLU) OPTIONAL, -- |
| | Need M |
| }, | |
| } | |
| } | |

In another embodiment, a BS can configure a UE to train Toeplitz (or circulant, doubly-block Toeplitz, doubly-block circulant) codebooks via RRC configuration (where an AI/ML model architecture was designed to support training/inference of these codebooks). Table 5 is an example of modifying an IE PDSCH-ServingCellConfig to configure training of Toeplitz codebooks. For PDSCH-ServingCellConfig, numToeplitzRows (corresponding to the number of rows of this codebook) and numToeplitzCols (corresponding to the number of columns of this codebook) can include trained values for other UEs that have trained a Toeplitz codebook. These trained values can assist this UE in training a Toeplitz codebook. The information in numToeplitzRows and numToeplitzCols can be tagged with the ID for the corresponding codebook, e.g., the ID of the corresponding CSI-ResourceConfig, the ID of the corresponding CORESET pool, etc. In one example, a BS can also signal recommended values (e.g., parameters and/or coefficients) for batch normalization and/or nonlinear operations from other UEs. In another example, a BS can also signal recommended values for the sparsity of a trained Toeplitz (or circulant, doubly-block Toeplitz, doubly-block circulant) codebook from other UEs.

TABLE 5
PDSCH-ServigCellConfig ::= SEQUENCE {

| | |
|---|---|
| codebookType | CHOICE { |
| ... | |
| pdsch-Encoder | SEQUENCE { |
| numToeplitzRows | SEQUENCE (SIZE (1..numUEs)) of |
| | INTERGER (1..maxNumTopeliztRows) |
| numToeplitzCols | SEQUENCE (SIZE (1..numUEs)) of |
| | INTERGER (1..maxNumTopeliztCols) |
| ... | |
| }, | |
| } | |
| } | |

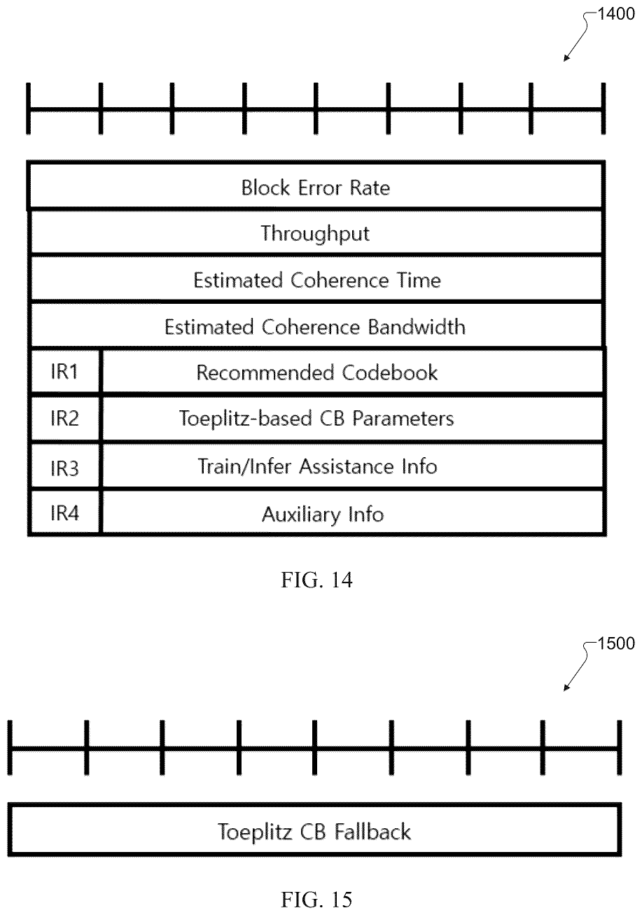

FIG. 14 illustrates a diagram 1400 of a new MAC CE for UE assistance information report according to embodiments of the present disclosure. For example, diagram 1400 of a new MAC CE for UE assistance information report can be utilized by the BS 102 of FIG. 1. This example is for illustration only and other embodiments can be used without departing from the scope of the present disclosure.

In one embodiment, a new MAC CE can be defined for the UE 116 assistance information report. This MAC CE can be identified by a MAC sub header with a logical channel ID that can be specified in Table 6.2.1-2 in document and standard [3]. This MAC CE can have a variable size and includes the following fields:
Block Error Rate: This field indicates the observed block error rate of the UE 116, e.g., the block error rate that has been computed over the last 1000 received transport blocks.
Throughput: This field indicates the observed throughput of the UE 116, e.g., the throughput in megabits/second that has been computed over the last 1000 received transport blocks.
Estimated Coherence Time: This field indicates the UE 116's estimate of the DL channel coherence time in milliseconds.
Estimated Coherence Bandwidth: This field indicates the UE 116's estimate of the DL channel coherence bandwidth in kilohertz.
IR1: This field indicates the presence of the octet(s) containing the Recommended Codebook field. If the IR1 field is set to 1, the octet(s) containing the Recommended Codebook field is (are) present. If the IR1 field is set to 0, the octet(s) containing the Recommended Codebook field is (are) not present.
Recommended Codebook: This field indicates the UE 116's recommended codebook for generating/reporting CSI feedback, e.g., an index to a table of codebooks.
   In one example, this field can include a recommendation of a Toeplitz (or circulant, doubly-block Toeplitz, doubly-block circulant) codebook.
   In one example, this field can include a recommendation of one or more domains that correspond to a Toeplitz (or circulant, doubly-block Toeplitz, doubly-block circulant) codebook, e.g. an index to a table of domains. In a first scenario, the recommendation may include time domain and frequency domain, while in a second scenario, the recommendation may include only the frequency domain.
IR2: This field indicates the presence of the octet containing the Toeplitz-based CB Parameters field. If the IR2 field is set to 1, the octet containing the Toeplitz-based CB Parameters field is present. If the IR2 field is set to 0, the octet containing the Toeplitz-based CB Parameters field is not present.
Toeplitz-based CB Parameters: This field indicates parameters that correspond to the recommended Toeplitz-based CSI feedback/report method, e.g., the first row and column of a recommended Toeplitz codebook.
   In one example, this field could indicate the recommended number of rows (and/or block rows) and/or columns (and/or block columns) of a Toeplitz (or circulant, doubly-block Toeplitz, doubly-block circulant) codebook.
   In one example, this field could indicate the recommended sparsity of a Toeplitz (or circulant, doubly-block Toeplitz, doubly-block circulant) codebook.
   In one example, this field could indicate parameters that correspond to recommendations for batch normalization and/or nonlinear operations.
IR3: This field indicates the presence of the octet containing the Train/Infer Assistance Info field. If the IR3 field is set to 1, the octet containing the Train/Infer Assistance Info field is present. If the IR3 field is set to 0, the octet containing the Train/Infer Assistance Info field is not present.
Train/Infer Assistance Info: This field indicates training/inference assistance information that corresponds to this UE's Toeplitz-based CSI feedback/report method (where an AI/ML model architecture was designed to support training/inference of this method), e.g., training error, hyperparameters, etc.
IR4: This field indicates the presence of the octet containing the Auxiliary Info field. If the IR4 field is set to 1, the octet containing the Auxiliary Info field is present. If the IR4 field is set to 0, the octet containing the Auxiliary field is not present.
Auxiliary Info: This field indicates additional information that the UE 116 can convey to the BS 102, e.g., detections of mobile reflectors/scatterers (including their estimated velocities).

With reference to FIG. 14 an example of a new MAC CE for the UE 116 assistance information report, where the Block Error Rate, UE Throughput, Estimated Coherence Time, and Estimated Coherence Bandwidth fields each have a length of 8 bits is shown. The Recommended Codebook, Toeplitz-based CB Parameters, Train/Infer Assistance Info, and Auxiliary Info fields each have a length of 7 bits.

FIG. 15 illustrates a diagram 1500 of a new MAC CE for Toeplitz CSI fallback request according to embodiments of the present disclosure. For example, diagram 1500 of a new MAC CE for Toeplitz CSI fallback request can be utilized by the BS 102 of FIG. 1. This example is for illustration only and other embodiments can be used without departing from the scope of the present disclosure.

In one embodiment, a new MAC CE can be defined for the Toeplitz CSI fallback request. This MAC CE can be identified by a MAC sub header with a logical channel ID that can be specified in Table 6.2.1-2 in document and standard [3]. This MAC CE can have a variable size and includes the following fields:
Toeplitz CB Fallback: This field can include one or more of the following information:
   Index to a set of pre-defined Toeplitz codebooks (in one example, an AI/ML model architecture is designed to support training/inference of a Toeplitz-based CSI feedback/report method, and this architecture includes a single CNN layer that utilizes multiple filters; in this example, each Toeplitz codebook could correspond to a single filter)
   Number of rows and/or columns of a requested Toeplitz codebook
   Sparsity of a requested Toeplitz codebook

For example, if one Toeplitz codebook has been configured for each CSI-ResourceConfig, then the Toeplitz CB Fallback field can include the ID of the Toeplitz codebook for a particular CSI-ResourceConfig. In another example, if one Toeplitz codebook has been configured for each CORESET pool, then the Toeplitz CB Fallback field can include the ID of the Toeplitz codebook for a particular CORESET pool.

With reference to FIG. 15, an example of a new MAC CE for the Toeplitz CSI fallback request, where the Toeplitz CB Fallback field has a length of 8 bits is shown.

In another example, a new MAC CE can be defined for a request to directly fall back to a traditional codebook (bypassing a Toeplitz codebook).

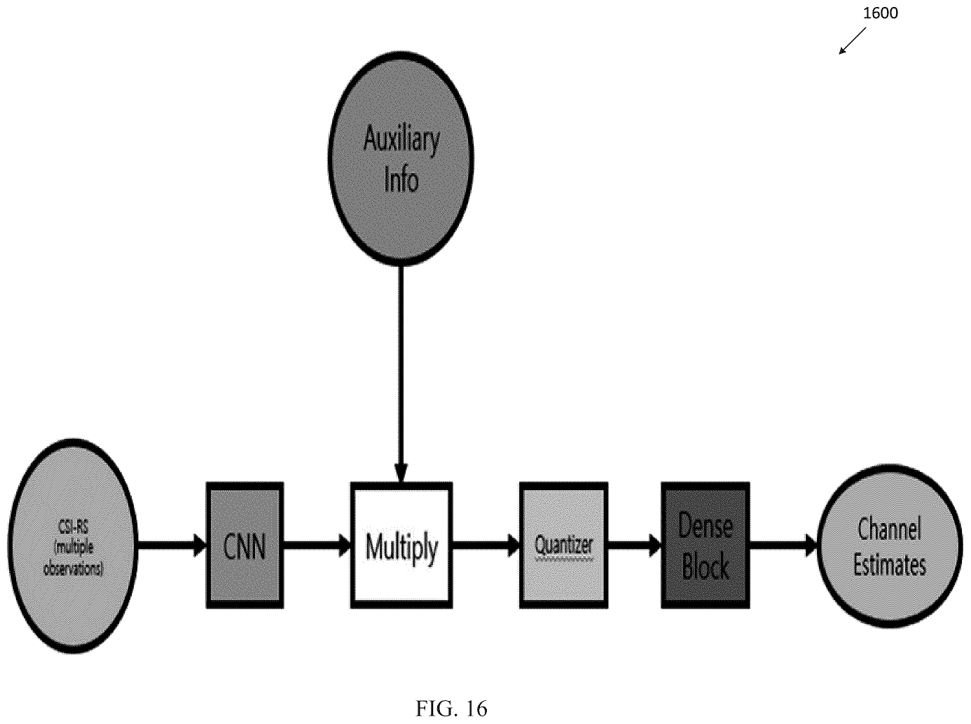

FIG. 16 illustrates a flow diagram 1600 of an example AI/ML architecture to support training/inference of a Toeplitz codebook according to embodiments of the present disclosure. For example, flow diagram 1600 can be utilized by the BS 102 of FIG. 1. This example is for illustration only and other embodiments can be used without departing from the scope of the present disclosure.

With reference to FIG. 16, an example of an AI/ML model architecture that can support training/inference of a Toeplitz (or circulant, doubly-block Toeplitz, doubly-block circulant) codebook (which can generate/report CSI feedback) is shown. A standard CNN can be augmented in this example with auxiliary information. Examples of auxiliary information are included herein.

In each slot, the full two-dimensional (number of Rx dimensions by number of Tx dimensions) channel over each subcarrier and OFDM symbol is provided as input to this AI/ML model architecture, where each RE that does not contain CSI-RS are filled with zeros.

Examples of inputs to an AI/ML model that can support training/inference of a Toeplitz (or circulant, doubly-block Toeplitz, doubly-block circulant) codebook include:
Full two-dimensional received channel over each subcarrier and OFDM symbol for one slot.
   Each RE that do not contain CSI-RS are filled with zeros.
Ground truth of full two-dimensional channel over each subcarrier and OFDM symbol for one or more slots.
   For example, this can be obtained via ideal channel estimation.
   In another example, this can be obtained via a realistic channel estimation method. (e.g., least squares (LS), linear minimum mean squared error (LMMSE))
   This can be a training label.
Auxiliary information
   UE speed
   UE acceleration/deceleration
   UE trajectory
   UE location
   Coherence time
   Coherence bandwidth
   Delay spread
   Doppler spread
   Block error rate
   Throughput
   Detections of mobile reflectors/scatterers (e.g., their estimated velocities)

Examples of outputs from an AI/ML model that can support training/inference of a Toeplitz (or circulant, doubly-block Toeplitz, doubly-block circulant) codebook include:
Full two-dimensional estimated channel over each subcarrier and OFDM symbol for one slot.
Parameters for a Toeplitz (or circulant, doubly-block Toeplitz, doubly-block circulant) codebook.
   These parameters can be determined from the “CNN” layer in the architecture in FIG. 16.
      Number of rows (and/or block rows) and/or columns (and/or block columns).
      Sparsity (i.e., ratio of number of zero elements to total number of elements).

In 5G NR, a significant improvement in throughput can be obtained by supporting MU-MIMO transmission, where one gNB simultaneously transmits multiple data streams to multiple UEs. MU-MIMO transmission relies on the availability of accurate DL CSI at the gNB; in FDD systems, each UE measures DL CSI and reports its measurements. Each CSI report can include PMI (the dominant channel directions), RI (the number of dominant channel directions), and/or CQI (the best modulation and code rate that the channel can support).

The overhead of DL CSI increases with the number of antenna ports at the gNB and the number of SBs. Current 5G systems support tens of SBs and a maximum of 32 antenna ports at the gNB. Each UE uses pre-defined codebooks (e.g., Type I and Type II) for compressing DL CSI before it is reported to the gNB. These codebooks exploit channel correlations in the spatial and frequency domains; the application of these codebooks has significantly reduced the overhead of DL CSI feedback. In Release-18, these codebooks are being extended to exploit channel correlations in the temporal domain; the application of these codebooks could yield additional reductions in the overhead of DL CSI feedback.

The number of antenna ports at the gNB and the number of SBs are expected to increase for future systems to meet more stringent performance requirements—yet the overhead reduction from pre-defined codebooks may not scale accordingly (e.g., Type I and Type II codebooks utilize a DFT basis, which may not be applicable to future antenna configurations). Thus, it may be advantageous to configure a UE to support alternate methods of compressing DL CSI.

For example, assume that an AI/ML model architecture can be designed to train an autoencoder for generating/reporting CSI feedback, where the encoder utilizes a single CNN layer. When this trained autoencoder is used for inference, applying this CNN layer is equivalent to pre-multiplying its input by a Toeplitz (or doubly-block Toeplitz, circulant, doubly-block circulant, concatenation of doubly-block Toeplitz/circulant) matrix. For example, 1-D linear convolution is equivalent to pre-multiplication by a Toeplitz matrix, while 2-D linear convolution is equivalent to pre-multiplication by a doubly-block Toeplitz matrix. Also, 1-D circular convolution is equivalent to pre-multiplication by a circulant matrix, while 2-D circular convolution is equivalent to pre-multiplication by a doubly-block circulant matrix. In addition, 3-D linear convolution is equivalent to pre-multiplication by a matrix that includes a concatenation of doubly-block Toeplitz matrices [8].

A Toeplitz matrix [5] has constant (same) values along its negative-sloping diagonals; an example is shown in (21) as values . . . , a₋₁, a₀, a₁, . . . .

$$A = [ \begin{matrix}{a}_{0} & {a}_{- 1} & {a}_{- 2} & … & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & … & {a}_{2} & {a}_{1} & {a}_{0}\end{matrix} ] \qquad ( 21 )$$

A doubly-block Toeplitz matrix [6] is a block matrix R where 1) its (i,j)-th block Rᵢⱼ is a function of i-j (thus, it can be denoted by Rᵢ₋ⱼ) and 2) Rᵢⱼ(denoted by Rᵢ₋ⱼ) is itself a Toeplitz matrix. An example is shown in (22), where each Rⱼ is a Toeplitz matrix.

$$R = [ \begin{matrix}{R}_{0} & {R}_{- 1} & {R}_{- 2} & … & {R}_{- n + 1} \\ {R}_{1} & {R}_{0} & {R}_{- 1} & ⋱ & ⋮ \\ {R}_{2} & {R}_{1} & {R}_{0} & ⋱ & {R}_{- 2} \\ ⋮ & ⋱ & ⋱ & ⋱ & {R}_{- 1} \\ {R}_{n - 1} & … & {R}_{2} & {R}_{1} & {R}_{0}\end{matrix} ] \qquad ( 22 )$$

A circulant matrix [7] is a special case of a Toeplitz matrix where each row (column) is a circular shift of the previous row (column). An example is shown in (23).

$$A = [ \begin{matrix}{a}_{0} & {a}_{- 1} & {a}_{- 2} & … & {a}_{- n + 1} \\ {a}_{- n + 1} & {a}_{0} & {a}_{- 1} & ⋱ & {a}_{- n + 2} \\ {a}_{- n + 2} & {a}_{- n + 1} & {a}_{0} & ⋱ & {a}_{- n + 3} \\ ⋮ & ⋱ & ⋱ & ⋱ & ⋮ \\ {a}_{- 1} & … & {a}_{- n + 2} & {a}_{- n + 1} & {a}_{0}\end{matrix} ] \qquad ( 23 )$$

A doubly-block circulant matrix is a special case of a doubly-block Toeplitz matrix R where 1) each block row (column) is a circular shift of the previous block row (column) and 2) its (i,j)-th block Rᵢⱼ(denoted by Rᵢ₋ⱼ) is itself a circulant matrix. An example is shown in (24), where each Rⱼ is a circulant matrix.

$$R = [ \begin{matrix}{R}_{0} & {R}_{- 1} & {R}_{- 2} & … & {R}_{- n + 1} \\ {R}_{- n + 1} & {R}_{0} & {R}_{- 1} & ⋱ & {R}_{- n + 2} \\ {R}_{- n + 2} & {R}_{- n + 1} & {R}_{0} & ⋱ & {R}_{- n + 3} \\ ⋮ & ⋱ & ⋱ & ⋱ & ⋮ \\ {R}_{- 1} & … & {R}_{- n + 2} & {R}_{- n + 1} & {R}_{0}\end{matrix} ] \qquad ( 24 )$$

Thus, using this trained autoencoder for inference is equivalent to applying a Toeplitz-based method for generating/reporting CSI feedback. This Toeplitz-based method can utilize a flexible basis that depends on a training dataset.

The present disclosure describes a framework for supporting Toeplitz-based methods for generating/reporting temporal-domain CSI feedback. The corresponding signaling details are discussed in this disclosure.

This disclosure addresses the issue that Toeplitz-based methods for generating/reporting temporal-domain CSI feedback are not supported in the 5G-NR standard. This disclosure provides techniques that the network can use to configure a UE to generate temporal-domain CSI feedback using Toeplitz-based operations.

Details on the support of Toeplitz-based methods for generating/reporting temporal-domain CSI feedback are disclosed, including information elements to be exchanged between a transmitter and a receiver.

For illustrative purposes, a term “Toeplitz-based CSI feedback/report” is used to refer to a method for generating CSI reports that is based on a first component (or basis) W₁ which has a convolutional structure. For instance, the convolutional structure can correspond to a Toeplitz (or doubly-block Toeplitz, circulant, doubly-block circulant, concatenation of doubly-block Toeplitz/circulant) matrix. The CSI reports are based on a dual-stage precoding structure, where the first stage can correspond to the convolutional W₁ and the second stage can correspond to a second component (or coefficients) W₂. The overall precoding operation essentially can be expressed as W₁W₂, i.e., multiplication of a coefficient matrix (W₂) by a Toeplitz (or doubly-block Toeplitz, circulant, doubly-block circulant, concatenation of doubly-block Toeplitz/circulant) matrix (W₁). In this case, this Toeplitz (or doubly-block Toeplitz, circulant, doubly-block circulant, concatenation of doubly-block Toeplitz/circulant) matrix is analogous to the basis matrices Wi and/or Wᵣ and/or W_{d} or sets of basis vectors as in the Type II codebooks (cf. 5.2.2.2.3/4/5/6/7, document and standard [4]) that perform compression in SD and/or FD and/or DD/TD, respectively.

If the convolutional structure of W₁ corresponds to a Toeplitz (or doubly-block Toeplitz, circulant, doubly-block circulant, concatenation of doubly-block Toeplitz/circulant) matrix, this Toeplitz (or doubly-block Toeplitz, circulant, doubly-block circulant, concatenation of doubly-block Toeplitz/circulant) matrix can be a square (e.g. n×n) matrix. This Toeplitz (or doubly-block Toeplitz, circulant, doubly-block circulant, concatenation of doubly-block Toeplitz/circulant) matrix can also be a tall (e.g., m×n, where m>n) or fat (e.g., n×m, where m>n) matrix.

Other terms that refer to a same method can also be used.

In one embodiment, for the temporal domain, the precoding matrix based on this disclosure has the following structure:

$$( 25 )$$

$$P = \frac{1}{γ} {W}_{2} {W}_{d}^{H} = \frac{1}{γ} c {A}_{d}^{H} = {\frac{1}{γ} [ {c}_{0} … {c}_{n - 1} ] [ \begin{matrix}{a}_{d , 0} & {a}_{d , - 1} & {a}_{d , - 2} & … & {a}_{d , - n + 1} \\ {a}_{d , 1} & {a}_{d , 0} & {a}_{d , - 1} & ⋱ & ⋮ \\ {a}_{d , 2} & {a}_{d , 1} & {a}_{d , 0} & ⋱ & {a}_{d , - 2} \\ ⋮ & ⋱ & ⋱ & ⋱ & {a}_{d , - 1} \\ {a}_{d , n - 1} & … & {a}_{d , 2} & {a}_{d , 1} & {a}_{d , 0}\end{matrix} ]}^{H}$$

where γ is a normalization factor. In one example, W_{d} is a DD/TD basis. The quantities a_{d,-n+1} . . . , a_{d,-1}, a_{d,0}, a_{d,1}, . . . , a_{d,n-1} in (25) can be configured to be determined by training an AI/ML model architecture. In another example, the quantities a_{d,-n+1} . . . , a_{d,-1}, a_{d,0}, a_{d,1}, . . . , a_{d,n-1} in (25) can be configured from a candidate set of quantities. In another example, the quantities a_{d,-n+1} . . . , a_{d,-1}, a_{d,0}, a_{d,1}, . . . , a_{d,n-1} in (25) can be specified.

Likewise, for rank W_{d}^{(k)}, for each layer k, in one embodiment, for the temporal domain, the precoding matrix based on this disclosure has the following structure:

$$( 26 )$$

$${P}^{k} = \frac{1}{{γ}_{k}} {W}_{2}^{( k )} {W}_{d}^{( k ) H} = \frac{1}{{γ}_{k}} {c}^{( k )} {A}_{d}^{( k ) H} = {\frac{1}{{γ}_{k}} [ {c}_{k , 0} … {c}_{k , n - 1} ] [ \begin{matrix}{a}_{d , k , 0} & {a}_{d , k , - 1} & {a}_{d , k , - 2} & … & {a}_{d , k , - n + 1} \\ {a}_{d , k , 1} & {a}_{d , k , 0} & {a}_{d , k , - 1} & ⋱ & ⋮ \\ {a}_{d , k , 2} & {a}_{d , k , 1} & {a}_{d , k , 0} & ⋱ & {a}_{d , k , - 2} \\ ⋮ & ⋱ & ⋱ & ⋱ & {a}_{d , k , - 1} \\ {a}_{d , k , n - 1} & … & {a}_{d , k , 2} & {a}_{d , k , 1} & {a}_{d , k , 0}\end{matrix} ]}^{H}$$

where γₖ is a normalization factor. In one example, W_{d}^{(k)} is a DD/TD basis. The quantities a_{d,k,-n+1} . . . , a_{d,k,-1}, a_{d,k,0}, a_{d,k,1}, . . . , a_{d,k,n-1} in (26) can be configured to be determined by training an AI/ML model architecture. In another example, the quantities a_{d,k,-n+1} . . . , a_{d,k,-1}, a_{d,k,0}, a_{d,k,1}, . . . , a_{d,k,n-1} in (26) can be configured from a candidate set of quantities. In another example, the quantities a_{d,k,-n+1} . . . , a_{d,k,-1}, a_{d,k,0}, a_{d,k,1}, . . . , a_{d,k,n-1} in (26) can be specified.

In one example, W_{d}^{(k)} can be the same for each layer k while W₂^{(k)} can be the same for each layer k. In another example, W_{d}^{(k)} can be determined on a per-layer basis while W₂^{(k)} can be determined on a per-layer basis. In one example, W_{d}^{(k)} can be the same for each layer k while W₂^{(k)} can be determined on a per-layer basis. In another example, W₂^{(k)} can be the same for each layer k while W_{d}^{(k)} can be determined on a per-layer basis.

In one embodiment, for the space and temporal domains, the precoding matrix based on this disclosure has the following structure:

$$( 27 )$$

$$P = \frac{1}{γ} {W}_{1} {W}_{2} {W}_{d}^{H} = \frac{1}{γ} A C {A}_{d}^{H} = \frac{1}{γ} [ \begin{matrix}{a}_{0} & {a}_{- 1} & {a}_{- 2} & … & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & … & {a}_{2} & {a}_{1} & {a}_{0}\end{matrix} ] {[ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] [ \text{} \begin{matrix}{a}_{d , 0} & {a}_{d , - 1} & {a}_{d , - 2} & … & {a}_{d , - m + 1} \\ {a}_{d , 1} & {a}_{d , 0} & {a}_{d , - 1} & ⋱ & ⋮ \\ {a}_{d , 2} & {a}_{d , 1} & {a}_{d , 0} & ⋱ & {a}_{d , - 2} \\ ⋮ & ⋱ & ⋱ & ⋱ & {a}_{d , - 1} \\ {a}_{d , m - 1} & … & {a}_{d , 2} & {a}_{f , 1} & {a}_{d , 0}\end{matrix} ]}^{H}$$

where γ is a normalization factor. In one example, W₁ is an SD basis (e.g., across P_{CSIRS} CSI-RS antenna ports), and W_{d} is a DD/TD basis. The quantities a₋ₙ₊₁ . . . , a₁, a₀, a₁, . . . , aₙ₋₁ and/or a_{d,-m+1} . . . , a_{d,-1}, a_{d,0}, a_{d,1}, . . . , a_{d,m-1} in (27) can be configured to be determined by training an AI/ML model architecture. In another example, the quantities a₋ₙ₊₁, a₋₁, a₀, a₁, . . . , aₙ₋₁ and/or a_{d,-m+1} . . . , a_{d,-1}, a_{d,0}, a_{d,1}, . . . , a_{d,m-1} in (27) can be configured from a candidate set of quantities. In another example, the quantities a₋ₙ₊₁ . . . , a₋₁, a₀, a₁, . . . , aₙ₋₁ and/or a_{d,-m+1} . . . , a_{d,-1}, a_{d,0}, a_{d,1}, . . . , a_{d,m-1} in (27) can be specified.

In a variation, the precoding matrix based on this disclosure has the following structure:

$$P = \frac{1}{γ} {W}_{1} {W}_{2} {W}_{d}^{H} = \frac{1}{γ} [ \begin{matrix}{A}_{1} & 0 \\ 0 & {A}_{2}\end{matrix} ] {CA}_{d}^{H} \qquad ( 28 )$$

where γ is a normalization factor. In one example, W₁ is an SD basis for two antenna groups (e.g., two antenna polarizations of the P_{CSIRS} CSI-RS antenna ports). Here, A₁ and A₂ are associated with the two groups. In one example, A₁=A₂=A. In one example, A₁ can be different from A₂.

In a variation, the precoding matrix based on this disclosure has the following structure:

$$( 28-sd )$$

$$P = \frac{1}{γ} {W}_{1} {W}_{2} = \frac{1}{γ} {A}_{s , d} C = \frac{1}{γ} [ \begin{matrix}{a}_{s , d , 0} & {a}_{s , d , - 1} & {a}_{s , d , - 2} & … & {a}_{s , d , - n + 1} \\ {a}_{s , d , 1} & {a}_{s , d , 0} & {a}_{s , d , - 1} & ⋱ & ⋮ \\ {a}_{s , d , 2} & {a}_{s , d , 1} & {a}_{s , d , 0} & ⋱ & {a}_{s , d , 2} \\ ⋮ & ⋱ & ⋱ & ⋱ & {a}_{s , d , - 1} \\ {a}_{s , d , n - 1} & … & {a}_{s , d , 2} & {a}_{s , d , 1} & {a}_{s , d , 0}\end{matrix} ] [ \text{} \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ]$$

where γ is a normalization factor. In one example, W₁ is a joint SD-DD/TD basis. The quantities a_{s,d,-n+1} . . . , a_{s,d,-1}, a_{s,d,0}, a_{s,d,1}, . . . , a_{s,d,n-1} in (28-sd) can be configured to be determined by training an AI/ML model architecture. In another example, the quantities a_{s,d,-n+1} . . . , a_{s,d,-1}, a_{s,d,0}, a_{s,d,1}, . . . , a_{s,d,n-1} in (28-sd) can be configured from a candidate set of quantities. In another example, the quantities a_{s,d,-n+1} . . . a_{s,d,-1}, a_{s,d,0}, a_{s,d,1}, . . . , a_{s,d,n-1} in (28-sd) can be specified.

Likewise, for rank >1, for each layer k, in one embodiment, the precoding matrix based on this disclosure has the following structure:

$$( 29 )$$

$${P}^{k} = \frac{1}{{γ}_{k}} {W}_{1}^{( k )} {W}_{2}^{( k )} {W}_{d}^{( k ) H} = \text{} \frac{1}{{γ}_{k}} {A}^{( k )} \text{} {C}^{( k )} \text{} {A}_{d}^{( k ) H} = \text{} \frac{1}{{γ}_{k}} [ \text{} \begin{matrix}{a}_{k , 0} & {a}_{k , - 1} & {a}_{k , - 2} & … & {a}_{k , - n + 1} \\ {a}_{k , 1} & {a}_{k , 0} & {a}_{k , - 1} & ⋱ & ⋮ \\ {a}_{k , 2} & {a}_{k , 1} & {a}_{k , 0} & ⋱ & {a}_{k , - 2} \\ ⋮ & ⋱ & ⋱ & ⋱ & {a}_{k , - 1} \\ {a}_{k , n - 1} & … & {a}_{k , 2} & {a}_{k , 1} & {a}_{k , 0}\end{matrix} ] * [ \text{} \begin{matrix}{c}_{k , 0 , 0} & {c}_{k , 0 , 1} & & {c}_{k , 0 , m - 1} \\ ⋮ & ⋮ & … & ⋮ \\ {c}_{k , n - 1 , 0} & {c}_{k , n - 1 , 1} & & {c}_{k , n - 1 , m - 1}\end{matrix} ] \text{} * {[ \begin{matrix}{a}_{d , k , 0} & {a}_{d , k , - 1} & {a}_{d , k , - 2} & … & {a}_{d , k , - m + 1} \\ {a}_{d , k , 1} & {a}_{d , k , 0} & {a}_{d , k , - 1} & ⋱ & ⋮ \\ {a}_{d , k , 2} & {a}_{d , k , 1} & {a}_{d , k , 0} & ⋱ & {a}_{d , k , - 2} \\ ⋮ & ⋱ & ⋱ & ⋱ & {a}_{d , k , - 1} \\ {a}_{d , k , m - 1} & … & {a}_{d , k , 2} & {a}_{d , k , 1} & {a}_{d , k , 0}\end{matrix} ]}^{H}$$

where γₖ is a normalization factor. In one example, W₁^{(k)} is an SD basis (e.g., across P_{CSIRS} CSI-RS antenna ports), and W_{d}^{(k)} is a DD/TD basis. The quantities a_{k,-n+1} . . . , a_{k,-1}, a_{k,0}, a_{k,1}, . . . , a_{k,n-1} and/or a_{d,k,-m+1} . . . , a_{d,k,-1}, a_{d,k,0}, a_{d,k,1}, . . . , a_{d,k,m-1} in (29) can be configured to be determined by training an AI/ML model architecture. In another example, the quantities a_{k,-n+1} . . . , a_{k,-1}, a_{k,0}, a_{k,1}, . . . , a_{k,n-1} and/or a_{d,k,-m+1} . . . , a_{d,k,1}, a_{d,k,0}, a_{d,k,1}, . . . , a_{d,k,m-1} in (29) can be configured from a candidate set of quantities. In another example, the quantities a_{k,-n+1} . . . , a_{k,-1}, a_{k,0}, a_{k,1}, . . . , a_{k,n-1} and/or a_{d,k,-m+1} . . . , a_{d,k,1}, a_{d,k,0}, a_{d,k,1}, . . . , a_{d,k,m-1} in (29) can be specified.

In one example, W₁^{(k)} can be the same for each layer k. In another example, W₁^{(k)} can be determined on a per-layer basis. In one example, W₂^{(k)} can be the same for each layer k. In another example, W₂^{(k)} can be determined on a per-layer basis. In one example, W_{d}^{(k)} can be the same for each layer k. In another example, W_{d}^{(k)} can be determined on a per-layer basis. Each combination of these examples can also be supported.

In a variation, for rank >1, for each layer k, the precoding matrix based on this disclosure has the following structure:

$${P}^{k} = \frac{1}{{γ}_{k}} {W}_{1}^{( k )} {W}_{2}^{( k )} {W}_{d}^{( k ) H} = \frac{1}{{γ}_{k}} [ \begin{matrix}{A}_{k , 1} & 0 \\ 0 & {A}_{k , 2}\end{matrix} ] {C}^{( k )} {A}_{d}^{( k ) H} \qquad ( 30 )$$

where γₖ is a normalization factor. In one example, W₁^{(k)} is an SD basis for two antenna groups (e.g., two antenna polarizations of the P_{CSIRS} CSI-RS antenna ports), and W_{d}^{(k)} is a DD/TD basis. Here, A_{k,1} and A_{k,2} are associated with the two groups. In one example, A_{k,1}=A_{k,2}=Aₖ. In one example, A_{k,1} can be different from A_{k,2}.

In a variation, for rank >1, for each layer k, in one embodiment, the precoding matrix based on this disclosure has the following structure:

$$( 29-sd )$$

$${P}^{k} = \frac{1}{{γ}_{k}} {W}_{1}^{( k )} {W}_{2}^{( k )} = \frac{1}{{γ}_{k}} {A}_{s , d}^{( k )} {C}^{( k )} = \frac{1}{{γ}_{k}} [ \begin{matrix}{a}_{s , d , k , 0} & {a}_{s , d , k , - 1} & {a}_{s , d , k , - 2} & … & {a}_{s , d , k , - n + 1} \\ {a}_{s , d , k , 1} & {a}_{s , d , k , 0} & {a}_{s , d , k , - 1} & ⋱ & ⋮ \\ {a}_{s , d , k , 2} & {a}_{s , d , k , 1} & {a}_{s , d , k , 0} & ⋱ & {a}_{s , d , k , - 2} \\ ⋮ & ⋱ & ⋱ & ⋱ & {a}_{s , d , k , - 1} \\ {a}_{s , d , k , n - 1} & … & {a}_{s , d , k , 2} & {a}_{s , d , k , 1} & {a}_{s , d , k , 0}\end{matrix} ] * [ \begin{matrix}{c}_{k , 0 , 0} & {c}_{k , 0 , 1} & & {c}_{k , 0 , m - 1} \\ ⋮ & ⋮ & … & ⋮ \\ {c}_{k , n - 1 , 0} & {c}_{k , n - 1 , 1} & & {c}_{k , n - 1 , m - 1}\end{matrix} ]$$

where γₖ is a normalization factor. In one example, W₁^{(k)} is a joint SD-DD/TD basis. The quantities a_{s,d,k,-n+1} . . . , a_{s,d,k,-1}, a_{s,d,k,0}, a_{s,d,k,1}, . . . , a_{s,d,k,n-1} in (29-sd) can be configured to be determined by training an AI/ML model architecture. In another example, the quantities a_{s,d,k,-n+1} . . . , a_{s,d,k,-1}, a_{s,d,k,0}, a_{s,d,k,1}, . . . , a_{s,d,k,n-1} in (29-sd) can be configured from a candidate set of quantities. In another example, the quantities a_{s,d,k,-n+1} . . . , a_{s,d,k,-1}, a_{s,d,k,0}, a_{s,d,k,1}, . . . , a_{s,d,k,n-1} in (29-sd) can be specified.

In one embodiment, for the frequency and temporal domains, the precoding matrix based on this disclosure has the following structure:

$$( 31 )$$

$$P = \frac{1}{γ} {{W}_{2} ( {W}_{f} ⊗ {W}_{d} )}^{H} = \frac{1}{γ} {C ( {A}_{f} ⊗ {A}_{d} )}^{H} = \frac{1}{γ} [ \begin{matrix}{c}_{0 , 0} & {c}_{0 , 1} & & {c}_{0 , m p - 1} \\ ⋮ & ⋮ & … & ⋮ \\ {c}_{n - 1 , 0} & {c}_{n - 1 , 1} & & {c}_{n - 1 , 0 , m p - 1}\end{matrix} ] {[ \begin{matrix}{a}_{f , 0} & {a}_{f , - 1} & {a}_{f , - 2} & … & {a}_{f , - m + 1} \\ {a}_{f , 1} & {a}_{f , 0} & {a}_{f , - 1} & ⋱ & ⋮ \\ {a}_{f , 2} & {a}_{f , 1} & {a}_{f , 0} & ⋱ & {a}_{f , - 2} \\ ⋮ & ⋱ & ⋱ & ⋱ & {a}_{f , - 1} \\ {a}_{f , m - 1} & … & {a}_{f , 2} & {a}_{f , 1} & {a}_{f , 0}\end{matrix} ]}^{H} ⊗ {[ \begin{matrix}{a}_{d , 0} & {a}_{d , - 1} & {a}_{d , - 2} & … & {a}_{d , - p + 1} \\ {a}_{d , 1} & {a}_{d , 0} & {a}_{d , - 1} & ⋱ & ⋮ \\ {a}_{d , 2} & {a}_{d , 1} & {a}_{d , 0} & ⋱ & {a}_{d , - 2} \\ ⋮ & ⋱ & ⋱ & ⋱ & {a}_{d , - 1} \\ {a}_{d , p - 1} & … & {a}_{d , 2} & {a}_{f , 1} & {a}_{d , 0}\end{matrix} ]}^{H}$$

where γ is a normalization factor. In one example, W_{f} is an FD basis and W_{d} is a DD/TD basis. The quantities a_{f,-m+1} . . . , a_{f,-1}, a_{f,0}, a_{f,1}, . . . , a_{f,m-1} and/or a_{d,-p+1} . . . , a_{d,-1}, a_{d,0}, a_{d,1}, . . . , a_{d,p-1} in (31) can be configured to be determined by training an AI/ML model architecture. In another example, the quantities a_{f,-m+1} . . . , a_{f,-1}, a_{f,0}, a_{f,1}, . . . , a_{f,m-1} and/or a_{d,-p+1} . . . , a_{d,-1}, a_{d,0}, a_{d,1}, . . . , a_{d,p-1} in (31) can be configured from a candidate set of quantities. In another example, the quantities a_{f,-m+1} . . . , a_{f,-1}, a_{f,0}, a_{f,1}, . . . , a_{f,m-1} and/or a_{d,-p+1} . . . , a_{d,-1}, a_{d,0}, a_{d,1}, . . . , a_{d,p-1} in (31) can be specified.

In a variation, the precoding matrix based on this disclosure has the following structure:

$$( 3 1-f d )$$

$$P = \frac{1}{γ} {W}_{2} {W}_{f , d}^{H} = \frac{1}{γ} \text{} {CA}_{f , d}^{H} = \frac{1}{γ}$$

$${[ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] [ \begin{matrix}{a}_{f , d , 0} & {a}_{f , d , - 1} & {a}_{f , d , - 2} & … & {a}_{f , d , - m + 1} \\ {a}_{f , d , 1} & {a}_{f , d , 0} & {a}_{f , d , - 1} & ⋱ & ⋮ \\ {a}_{f , d , 2} & {a}_{f , d , 1} & {a}_{f , d , 0} & ⋱ & {a}_{f , d , - 2} \\ ⋮ & ⋱ & ⋱ & ⋱ & {a}_{f , d , - 1} \\ {a}_{f , d , m - 1} & … & {a}_{f , d , 2} & {a}_{f , d , 1} & {a}_{f , d , 0}\end{matrix} ]}^{H}$$

where γ is a normalization factor. In one example, W_{f,d} is a joint FD-DD/TD basis. The quantities a_{f,d,-m+1} . . . , a_{f,d,-1}, a_{f,d,0}, a_{f,d,1} . . . , a_{f,d,m-1} in (31-fd) can be configured to be determined by training an AI/ML model architecture. In another example, the quantities a_{f,d,-m+1} . . . , a_{f,d,-1}, a_{f,d,0}, a_{f,d,1}, . . . , a_{f,d,m-1} in (31-fd) can be configured from a candidate set of quantities. In another example, the quantities a_{f,d,-m+1} . . . , a_{f,d,-1}, a_{f,d,0}, a_{f,d,1}, . . . , a_{f,d,m-1} in (31-fd) can be specified.

Likewise, for rank >1, for each layer k, in one embodiment, the precoding matrix based on this disclosure has the following structure:

$$( 32 )$$

$${P}^{k} = \frac{1}{{γ}_{k}} {{W}_{2}^{( k )} ( {W}_{f}^{( k )} ⊗ {W}_{d}^{( k )} )}^{H} = \frac{1}{{γ}_{k}} {{C}^{( k )} ( {A}_{f}^{( k )} ⊗ {A}_{d}^{( k )} )}^{H} = \frac{1}{{γ}_{k}} [ \begin{matrix}{c}_{k , 0 , 0} & {c}_{k , 0 , 1} & & {c}_{k , 0 , mp - 1} \\ ⋮ & ⋮ & … & ⋮ \\ {c}_{k , n - 1 , 0} & {c}_{k , n - 1 , 1} & & {c}_{k , n - 1 , mp - 1}\end{matrix} ] * {[ \begin{matrix}{a}_{f , k , 0} & {a}_{f , k , - 1} & {a}_{f , k , - 2} & … & {a}_{f , k , - m + 1} \\ {a}_{f , k , 1} & {a}_{f , k , 0} & {a}_{f , k , - 1} & ⋱ & ⋮ \\ {a}_{f , k , 2} & {a}_{f , k , 1} & {a}_{f , k , 0} & ⋱ & {a}_{f , k , - 2} \\ ⋮ & ⋱ & ⋱ & ⋱ & {a}_{f , k , - 1} \\ {a}_{f , k , m - 1} & … & {a}_{f , k , 2} & {a}_{f , k , 1} & {a}_{f , k , 0}\end{matrix} ]}^{H} ⊗ {[ \begin{matrix}{a}_{d , k , 0} & {a}_{d , k , - 1} & {a}_{d , k , - 2} & … & {a}_{d , k , - p + 1} \\ {a}_{d , k , 1} & {a}_{d , k , 0} & {a}_{d , k , - 1} & ⋱ & ⋮ \\ {a}_{d , k , 2} & {a}_{d , k , 1} & {a}_{d , k , 0} & ⋱ & {a}_{d , k , - 2} \\ ⋮ & ⋱ & ⋱ & ⋱ & {a}_{d , k , - 1} \\ {a}_{d , k , p - 1} & … & {a}_{d , k , 2} & {a}_{d , k , 1} & {a}_{d , k , 0}\end{matrix} ]}^{H}$$

where γₖ is a normalization factor. In one example, W_{f}^{(k)} is an FD basis and W_{d}^{(k)} is a DD/TD basis. The quantities a_{f,k,-m+1} . . . , a_{f,k,-1}, a_{f,k,0}, a_{f,k,1}, . . . , a_{f,k,m-1} and/or a_{d,k,-p+1} . . . , a_{d,k,-1}, a_{d,k,0}, a_{d,k,1}, . . . , a_{d,k,p-1} in (32) can be configured to be determined by training an AI/ML model architecture. In another example, the quantities a_{f,k,-m+1} . . . , a_{f,k,-1}, a_{f,k,0}, a_{f,k,1}, . . . , a_{f,k,m-1} and/or a_{d,k,-p+1} . . . , a_{d,k,-1}, a_{d,k,0}, a_{d,k,1}, . . . , a_{d,k,p-1} in (32) can be configured from a candidate set of quantities. In another example, the quantities a_{f,k,-m+1} . . . , a_{f,k,-1}, a_{f,k,0}, a_{f,k,1}, . . . , a_{f,k,m-1} and/or a_{d,k,-p+1} . . . , a_{d,k,-1}, a_{d,k,0}, a_{d,k,1}, . . . , a_{d,k,p-1} in (32) can be specified.

In one example, W_{f}^{(k)} can be the same for each layer k. In another example, W_{f}^{(k)} can be determined on a per-layer basis. In one example, W₂^{(k)} can be the same for each layer k. In another example, W₂^{(k)} can be determined on a per-layer basis. In one example, W_{d}^{(k)} can be the same for each layer k. In another example, W_{d}^{(k)} can be determined on a per-layer basis. Each combination of these examples can also be supported.

In a variation, for rank >1, for each layer k, in one embodiment, the precoding matrix based on this disclosure has the following structure:

$$( 32 - fd )$$

$${P}^{k} = \frac{1}{{γ}_{k}} {W}_{2}^{( k )} {W}_{f , d}^{( k ) H} = \frac{1}{{γ}_{k}} {C}^{( k )} {A}_{f , d}^{( k ) H} = \frac{1}{{γ}_{k}} [ \begin{matrix}{c}_{k , 0 , 0} & {c}_{k , 0 , 1} & & {c}_{k , 0 , m - 1} \\ ⋮ & ⋮ & … & ⋮ \\ {c}_{k , n - 1 , 0} & {c}_{k , n - 1 , 1} & & {c}_{k , n - 1 , m - 1}\end{matrix} ] * {[ \begin{matrix}{a}_{f , d , k , 0} & {a}_{f , d , k , - 1} & {a}_{f , d , k , - 2} & … & {a}_{f , d , k , - m + 1} \\ {a}_{f , d , k , 1} & {a}_{f , d , k , 0} & {a}_{f , d , k , - 1} & ⋱ & ⋮ \\ {a}_{f , d , k , 2} & {a}_{f , d , k , 1} & {a}_{f , d , k , 0} & ⋱ & {a}_{f , d , k , - 2} \\ ⋮ & ⋱ & ⋱ & ⋱ & {a}_{f , d , k , - 1} \\ {a}_{f , d , k , m - 1} & … & {a}_{f , d , k , 2} & {a}_{f , d , k , 1} & {a}_{f , d , k , 0}\end{matrix} ]}^{H}$$

where γₖ is a normalization factor. In one example, W_{f,d}^{(k)} is a joint FD-DD/TD basis. The quantities a_{f,d,k,-m+1} . . . , a_{f,d,k,-1}, a_{f,d,k,0}, a_{f,d,k,1}, . . . , a_{f,d,k,m-1} in (32-fd) can be configured to be determined by training an AI/ML model architecture. In another example, the quantities a_{f,d,k,-m+1} . . . , a_{f,d,k,-1}, a_{f,d,k,0}, a_{f,d,k,1}, . . . , a_{f,d,k,m-1} in (32-fd) can be configured from a candidate set of quantities. In another example, the quantities a_{f,d,k,-m+1} . . . , a_{f,d,k,-1}, a_{f,d,k,0}, a_{f,d,k,1}, a_{f,d,k,m-1} in (32-fd) can be specified.

In one embodiment, for the space, frequency, and temporal domains, the precoding matrix based on this disclosure has the following structure:

$$( 33 )$$

$$P = \frac{1}{γ} {W}_{1} {{W}_{2} ( {W}_{f} ⊗ {W}_{d} )}^{H} = \frac{1}{γ} A {C ( {A}_{f} ⊗ {A}_{d} )}^{H} = \frac{1}{γ} [ \begin{matrix}{a}_{0} & {a}_{- 1} & {a}_{- 2} & … & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & … & {a}_{2} & {a}_{1} & {a}_{0}\end{matrix} ] * [ \begin{matrix}{c}_{0 , 0} & {c}_{0 , 1} & & {c}_{0 , mp - 1} \\ ⋮ & ⋮ & … & ⋮ \\ {c}_{n - 1 , 0} & {c}_{n - 1 , 1} & & {c}_{n - 1 , mp - 1}\end{matrix} ] \text{} * {[ \begin{matrix}{a}_{f , 0} & {a}_{- f , 1} & {a}_{f , - 2} & … & {a}_{f , - m + 1} \\ {a}_{f , 1} & {a}_{f , 0} & {a}_{f , - 1} & ⋱ & ⋮ \\ {a}_{f , 2} & {a}_{f , 1} & {a}_{f , 0} & ⋱ & {a}_{f , - 2} \\ ⋮ & ⋱ & ⋱ & ⋱ & {a}_{f , - 1} \\ {a}_{f , m - 1} & … & {a}_{f , 2} & {a}_{f , 1} & {a}_{f , 0}\end{matrix} ]}^{H} ⊗ {[ \begin{matrix}{a}_{d , 0} & {a}_{d , - 1} & {a}_{d , - 2} & … & {a}_{d , - p + 1} \\ {a}_{d , 1} & {a}_{d , 0} & {a}_{d , - 1} & ⋱ & ⋮ \\ {a}_{d , 2} & {a}_{d , 1} & {a}_{d , 0} & ⋱ & {a}_{d , - 2} \\ ⋮ & ⋱ & ⋱ & ⋱ & {a}_{d , - 1} \\ {a}_{d , p - 1} & … & {a}_{d , 2} & {a}_{f , 1} & {a}_{d , 0}\end{matrix} ]}^{H}$$

where γ is a normalization factor. In one example, W₁ is an SD basis (e.g., across P_{CSIRS} CSI-RS antenna ports), W_{f} is an FD basis, and W_{d} is a DD/TD basis. The quantities a₋ₙ₊₁ . . . , a₋₁, a₀, a₁, . . . , aₙ₋₁, a_{f,-m+1} . . . , a_{f,-1}, a_{f,0}, a_{f,1}, . . . , a_{f,m-1}, and/or a_{d,-p+1} . . . , a_{d,-1}, a_{d,0}, a_{d,1}, . . . , a_{d,p-1} in (33) can be configured to be determined by training an AI/ML model architecture. In another example, the quantities a₋ₙ₊₁ . . . , a₋₁, a₀, a₁, . . . , aₙ₋₁, a_{f,-m+1}, a_{f,-1}, a_{f,0}, a_{f,1}, . . . , a_{f,m-1}, and/or a_{d,-p+1} . . . , a_{d,-1}, a_{d,0}, a_{d,1}, . . . , a_{d,p-1} in (33) can be configured from a candidate set of quantities. In another example, the quantities a₋ₙ₊₁ . . . , a₋₁, a₀, a₁, . . . , aₙ₋₁, a_{f,-m+1} . . . , a_{f,-1}, a_{f,0}, a_{f,1}, . . . , a_{f,m-1}, and/or a_{d,-p+1} . . . , a_{d,-1}, a_{d,0}, a_{d,1}, . . . , a_{d,p-1} in (33) can be specified.

In a variation, the precoding matrix based on this disclosure has the following structure:

$$P = \frac{1}{γ} {W}_{1} {{W}_{2} ( {W}_{f} ⊗ {W}_{d} )}^{H} = \frac{1}{γ} [ \begin{matrix}{A}_{1} & 0 \\ 0 & {A}_{2}\end{matrix} ] {C ( {A}_{f} ⊗ {A}_{d} )}^{H} \qquad ( 34 )$$

where γ is a normalization factor. In one example, W₁ is an SD basis for two antenna groups (e.g., two antenna polarizations of the P_{CSIRS} CSI-RS antenna ports). Here, A₁ and A₂ are associated with the two groups. In one example, A₁=A₂=A. In one example, A₁ can be different from A₂.

In a variation, the precoding matrix based on this disclosure has the following structure:

$$( 33 - fd )$$

$$P = \frac{1}{γ} {W}_{1} {W}_{2} {W}_{{f , d}^{}}^{H} = \frac{1}{γ} {ACA}_{{f , d}^{}}^{H} = \frac{1}{γ} [ \begin{matrix}{a}_{0} & {a}_{- 1} & {a}_{- 2} & … & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & … & {a}_{2} & {a}_{1} & {a}_{0}\end{matrix} ] * [ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] * {[ \begin{matrix}{a}_{f , d , 0} & {a}_{f , d , - 1} & {a}_{f , d , - 2} & … & {a}_{f , d , - m + 1} \\ {a}_{f , d , 1} & {a}_{f , d , 0} & {a}_{f , d , - 1} & ⋱ & ⋮ \\ {a}_{f , d , 2} & {a}_{f , d , 1} & {a}_{f , d , 0} & ⋱ & {a}_{f , d , - 2} \\ ⋮ & ⋱ & ⋱ & ⋱ & {a}_{f , d , - 1} \\ {a}_{f , d , m - 1} & … & {a}_{f , d , 2} & {a}_{f , d , 1} & {a}_{f , d , 0}\end{matrix} ]}^{H}$$

where γ is a normalization factor. In one example, W₁ is an SD basis (e.g., across P_{CSIRS} CSI-RS antenna ports) and W_{f,d} is a joint FD-DD/TD basis. The quantities a₋ₙ₊₁ . . . , a₋₁, a₀, a₁, . . . , aₙ₋₁ and/or a_{f,d,-m+1} . . . , a_{f,d,-1}, a_{f,d,0}, a_{f,d,1}, . . . , a_{f,d,m-1} in (33-fd) can be configured to be determined by training an AI/ML model architecture. In another example, the quantities a₋ₙ₊₁ . . . , a₋₁, a₀, a₁, . . . , aₙ₋₁ and/or a_{f,d,-m+1} . . . , a_{f,d,-1}, a_{f,d,0}, a_{f,d,1}, . . . , a_{f,d,m-1} in (33-fd) can be configured from a candidate set of quantities. In another example, the quantities a₋ₙ₊₁ . . . , a₋₁, a₀, a₁, . . . , aₙ₋₁ and/or a_{f,d,-m+1} . . . , a_{f,d,-1}, a_{f,d,0}, a_{f,d,1}, . . . , a_{f,d,m-1} in (33-fd) can be specified.

In a variation, the precoding matrix based on this disclosure has the following structure:

$$( 33 - sd )$$

$$P = \frac{1}{γ} {W}_{1} {W}_{2} {W}_{f}^{H} = \frac{1}{γ} {A}_{s , d} C {A}_{f}^{H} = \frac{1}{γ} [ \begin{matrix}{a}_{s , d , 0} & {a}_{s , d , - 1} & {a}_{s , d , - 2} & … & {a}_{s , d , - n + 1} \\ {a}_{s , d , 1} & {a}_{s , d , 0} & {a}_{s , d , - 1} & ⋱ & ⋮ \\ {a}_{s , d , 2} & {a}_{s , d , 1} & {a}_{s , d , 0} & ⋱ & {a}_{s , d , - 2} \\ ⋮ & ⋱ & ⋱ & ⋱ & {a}_{s , d , - 1} \\ {a}_{s , d , n - 1} & … & {a}_{s , d , 2} & {a}_{1} & {a}_{s , d , 0}\end{matrix} ] * [ \text{} \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] \text{} * {[ \begin{matrix}{a}_{f , 0} & {a}_{f , - 1} & {a}_{f , - 2} & … & {a}_{f , - m + 1} \\ {a}_{f , 1} & {a}_{f , 0} & {a}_{f , - 1} & ⋱ & ⋮ \\ {a}_{f , 2} & {a}_{f , 1} & {a}_{f , 0} & ⋱ & {a}_{f , - 2} \\ ⋮ & ⋱ & ⋱ & ⋱ & {a}_{f , - 1} \\ {a}_{f , m - 1} & … & {a}_{f , 2} & {a}_{f , 1} & {a}_{f , 0}\end{matrix} ]}^{H}$$

where γ is a normalization factor. In one example, W₁ is a joint SD-DD/TD basis and W_{f} is an FD basis. The quantities a_{s,d,-n+1} . . . , a_{s,d-1}, a_{s,d,0}, a_{s,d,1}, . . . , a_{s,d,n-1} and/or a_{f,-m+1} . . . , a_{f,-1}, a_{f,0}, a_{f,1}, . . . , a_{f,m-1} in (33-sd) can be configured to be determined by training an AI/ML model architecture. In another example, the quantities a_{s,d,-n+1} . . . , a_{s,d-1}, a_{s,d,0}, a_{s,d,1}, a_{s,d,n-1} and/or a_{f,-m+1} . . . , a_{f,-1}, a_{f,0}, a_{f,1}, . . . , a_{f,m-1} in (33-sd) can be configured from a candidate set of quantities. In another example, the quantities a_{s,d,-n+1} . . . , a_{s,d-1}, a_{s,d,0}, a_{s,d,1}, . . . , a_{s,d,n-1} and/or a_{f,-m+1} . . . , a_{f,-1}, a_{f,0}, a_{f,1}, . . . , a_{f,m-1} in (33-sd) can be specified.

In a variation, the precoding matrix based on this disclosure has the following structure:

$$( 3 3-s fd )$$

$$P = \frac{1}{γ} {W}_{1} {W}_{2} \frac{1}{γ} {A}_{s , f , d} C = \text{} \frac{1}{γ} [ \begin{matrix}{a}_{s , f , d , 0} & {a}_{s , f , d , - 1} & {a}_{s , f , d , - 2} & … & {a}_{s , f , d , - n + 1} \\ {a}_{s , f , d , 1} & {a}_{s , f , d , 0} & {a}_{s , f , d , - 1} & ⋱ & ⋮ \\ {a}_{s , f , d , 2} & {a}_{s , f , d , 1} & {a}_{s , f , d , 0} & ⋱ & {a}_{s , f , d , - 2} \\ ⋮ & ⋱ & ⋱ & ⋱ & {a}_{s , f , d , - 1} \\ {a}_{s , f , d , n - 1} & … & {a}_{s , f , d , 2} & {a}_{s , f , d , 1} & {a}_{s , f , d , 0}\end{matrix} ] * [ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ]$$

where γ is a normalization factor. In one example, W₁ is a joint SD-FD-DD/TD basis. The quantities a_{s,f,d,-n+1} . . . , a_{s,f,d-1}, a_{s,f,d,0}, a_{s,f,d,1}, . . . , a_{s,f,d,n-1} in (33-sfd) can be configured to be determined by training an AI/ML model architecture. In another example, the quantities a_{s,f,d,-n+1} . . . , a_{s,f,d-1}, a_{s,f,d,0}, a_{s,f,d,1}, . . . , a_{s,f,d,n-1} in (33-sfd) can be configured from a candidate set of quantities. In another example, the quantities a_{s,f,d,-n+1} . . . , a_{s,f,d-1}, a_{s,f,d,0}, a_{s,f,d,1}, a_{s,f,d,n-1} in (33-sfd) can be specified.

Likewise, for rank >1, for each layer k, in one embodiment, the precoding matrix based on this disclosure has the following structure:

$$( 35 )$$

$${P}^{k} = \frac{1}{{γ}_{k}} {W}_{1}^{( k )} {{W}_{2}^{( k )} ( {W}_{f}^{( k )} ⊗ {W}_{d}^{( k )} )}^{H} = \frac{1}{{γ}_{k}} {A}^{( k )} {{C}^{( k )} ( {A}_{f}^{( k )} ⊗ {A}_{d}^{( k )} )}^{H} = \frac{1}{{γ}_{k}} [ \text{} \begin{matrix}{a}_{k , 0} & {a}_{k , - 1} & {a}_{k , - 2} & … & {a}_{k , - n + 1} \\ {a}_{k , 1} & {a}_{k , 0} & {a}_{k , - 1} & ⋱ & ⋮ \\ {a}_{k , 2} & {a}_{k , 1} & {a}_{k , 0} & ⋱ & {a}_{k , - 2} \\ ⋮ & ⋱ & ⋱ & ⋱ & {a}_{k , - 1} \\ {a}_{k , n - 1} & … & {a}_{k , 2} & {a}_{k , 1} & {a}_{k , 0}\end{matrix} ] * [ \text{} \begin{matrix}{c}_{k , 0 , 0} & {c}_{k , 0 , 1} & & {c}_{k , 0 , mp - 1} \\ ⋮ & ⋮ & … & ⋮ \\ {c}_{k , n - 1 , 0} & {c}_{k , n - 1 , 1} & & {c}_{k , n - 1 , mp - 1}\end{matrix} ] \text{} * {[ \begin{matrix}{a}_{f , k , 0} & {a}_{f , k , - 1} & {a}_{f , k , - 2} & … & {a}_{f , k , - m + 1} \\ {a}_{f , k , 1} & {a}_{f , k , 0} & {a}_{f , k , - 1} & ⋱ & ⋮ \\ {a}_{f , k , 2} & {a}_{f , k , 1} & {a}_{f , k , 0} & ⋱ & {a}_{f , k , - 2} \\ ⋮ & ⋱ & ⋱ & ⋱ & {a}_{f , k , - 1} \\ {a}_{f , k , m - 1} & … & {a}_{f , k , 2} & {a}_{f , k , 1} & {a}_{f , k , 0}\end{matrix} ]}^{H} ⊗ \text{} {[ \begin{matrix}{a}_{d , k , 0} & {a}_{d , k , - 1} & {a}_{d , k , - 2} & … & {a}_{d , k , - p + 1} \\ {a}_{d , k , 1} & {a}_{d , k , 0} & {a}_{d , k , - 1} & ⋱ & ⋮ \\ {a}_{d , k , 2} & {a}_{d , k , 1} & {a}_{d , k , 0} & ⋱ & {a}_{d , k , - 2} \\ ⋮ & ⋱ & ⋱ & ⋱ & {a}_{d , k , - 1} \\ {a}_{d , k , p - 1} & … & {a}_{d , k , 2} & {a}_{d , k , 1} & {a}_{d , k , 0}\end{matrix} ]}^{H}$$

where γₖ is a normalization factor. In one example, W₁^{(k)} is an SD basis (e.g. across P_{CSIRS} CSI-RS antenna ports), W_{f}^{(k)} is an FD basis, and W_{f}^{(k)} is a DD/TD basis. The quantities a_{k,-n+1} . . . , a_{k,-1}, a_{k,0}, a_{k,1}, . . . , a_{k,n-1}, a_{f,k,-m+1} . . . , a_{f,k,-1}, a_{f,k,0}, a_{f,k,1}, . . . , a_{f,k,m-1}, and/or a_{d,k,-p+1} . . . , a_{d,k,-1}, a_{d,k,0}, a_{d,k,1}, . . . , a_{d,k,p-1} in (35) can be configured to be determined by training an AI/ML model architecture. In another example, the quantities a_{k,-n+1} . . . , a_{k,-1}, a_{k,0}, a_{k,1}, . . . , a_{k,n-1}, a_{f,k,-m+1} . . . , a_{f,k,-1}, a_{f,k,0}, a_{f,k,1}, . . . , a_{f,k,m-1}, and/or a_{d,k,-p+1} . . . , a_{d,k,-1}, a_{d,k,0}, a_{d,k,1}, . . . , a_{d,k,p-1} in (35) can be configured from a candidate set of quantities. In another example, the quantities a_{k,-n+1} . . . , a_{k,-1}, a_{k,0}, a_{k,1}, . . . , a_{k,n-1}, a_{f,k,-m+1} . . . a_{f,k,-1}, a_{f,k,0}, a_{f,k,1}, . . . , a_{f,k,m-1}, and/or a_{d,k,-p+1} . . . , a_{d,k,-1}, a_{d,k,0}, a_{d,k,1}, . . . a_{d,k,p-1} in (35) can be specified.

In one example, W₁^{(k)} can be the same for each layer k. In another example, W₁^{(k)} can be determined on a per-layer basis. In one example, W₂^{(k)} can be the same for each layer k. In another example, W₂^{(k)} can be determined on a per-layer basis. In one example, W_{f}^{(k)} can be the same for each layer k. In another example, W_{f}^{(k)} can be determined on a per-layer basis. In one example, W_{d}^{(k)} can be the same for each layer k. In another example, W_{d}^{(k)} can be determined on a per-layer basis. Each combination of these examples can also be supported.

In a variation, for rank >1, for each layer k, the precoding matrix based on this disclosure has the following structure:

$${P}^{k} = \frac{1}{{γ}_{k}} {W}_{1}^{( k )} {{W}_{2}^{( k )} ( {W}_{f}^{( k )} ⊗ {W}_{d}^{( k )} )}^{H} = \frac{1}{{γ}_{k}} [ \begin{matrix}{A}_{{k}_{,} 1} & 0 \\ 0 & {A}_{k , 2}\end{matrix} ] {{C}^{( k )} ( {A}_{f}^{( k )} ⊗ {A}_{d}^{( k )} )}^{H} \qquad ( 36 )$$

where γₖ is a normalization factor. In one example, W₁^{(k)} is an SD basis for two antenna groups (e.g. two antenna polarizations of the P_{CSIRS} CSI-RS antenna ports), W_{f}^{(k)} is an FD basis, and W_{d}^{(k)} is a DD/TD basis. Here, A_{k,1} and A_{k,2} are associated with the two groups. In one example, A_{k,1}=A_{k,2}=Aₖ. In one example, A_{k,1} can be different from A_{k,2}.

In a variation, for rank >1, for each layer k, in one embodiment, the precoding matrix based on this disclosure has the following structure:

$$( 3 5-f d )$$

$${P}^{k} = \frac{1}{{γ}_{k}} {W}_{1}^{( k )} {W}_{2}^{( k )} {W}_{f , d}^{( k ) H} = \frac{1}{{γ}_{k}} \text{} {A}^{( k )} {C}^{( k )} \text{} {A}_{f , d}^{( k ) H} = \frac{1}{{γ}_{k}} \text{} \text{} [ \text{} \begin{matrix}{a}_{k , 0} & {a}_{k , - 1} & {a}_{k , - 2} & … & {a}_{k , - n + 1} \\ {a}_{k , 1} & {a}_{k , 0} & {a}_{k , - 1} & ⋱ & ⋮ \\ {a}_{k , 2} & {a}_{k , 1} & {a}_{k , 0} & ⋱ & {a}_{k , - 2} \\ ⋮ & ⋱ & ⋱ & ⋱ & {a}_{k , - 1} \\ {a}_{k , n - 1} & … & {a}_{k , 2} & {a}_{k , 1} & {a}_{k , 0}\end{matrix} ] * [ \text{} \begin{matrix}{c}_{k , 0 , 0} & {c}_{k , 0 , 1} & & {c}_{k , 0 , m - 1} \\ ⋮ & ⋮ & … & ⋮ \\ {c}_{k , n - 1 , 0} & {c}_{k , n - 1 , 1} & & {c}_{k , n - 1 , m - 1}\end{matrix} \text{} ] * {[ \begin{matrix}{a}_{f , d , k , 0} & {a}_{f , d , k , - 1} & {a}_{f , d , k , - 2} & … & {a}_{f , d , k , - m + 1} \\ {a}_{f , d , k , 1} & {a}_{f , d , k , 0} & {a}_{f , d , k , - 1} & ⋱ & ⋮ \\ {a}_{f , d , k , 2} & {a}_{f , d , k , 1} & {a}_{f , d , k , 0} & ⋱ & {a}_{f , d , k , - 2} \\ ⋮ & ⋱ & ⋱ & ⋱ & {a}_{f , d , k , - 1} \\ {a}_{f , d , k , m - 1} & … & {a}_{f , d , k , 2} & {a}_{f , d , k , 1} & {a}_{f , d , k , 0}\end{matrix} ]}^{H}$$

where γₖ is a normalization factor. In one example, W₁^{(k)} is an SD basis (e.g., across P_{CSIRS} CSI-RS antenna ports) and W_{f,d}^{(k)} is a joint FD-DD/TD basis. The quantities a_{k,-n+1} . . . , a_{k,-1}, a_{k,0}, a_{k,1}, . . . , a_{k,n-1} and/or a_{f,d,k,-m+1} . . . , a_{f,d,k,-1} a_{f,d,k,0}, a_{f,d,k,1}, a_{f,d,k,m-1} in (35-fd) can be configured to be determined by training an AI/ML model architecture. In another example, the quantities a_{k,-n+1} . . . , a_{k,-1}, a_{k,0}, a_{k,1}, . . . , a_{k,n-1} and/or a_{f,d,k,-m+1} . . . , a_{f,d,k,-1}, a_{f,d,k,0}, a_{f,d,k,1}, a_{f,d,k,m-1} in (35-fd) can be configured from a candidate set of quantities. In another example, the quantities a_{k,-n+1} . . . , a_{k,-1}, a_{k,0}, a_{k,1}, . . . , a_{k,n-1} and/or a_{f,d,k,-m+1} a_{f,d,k,-1}, a_{f,d,k,0}, a_{f,d,k,1}, . . . , a_{f,d,k,m-1} in (35-fd) can be specified.

In a variation, for rank >1, for each layer k, in one embodiment, the precoding matrix based on this disclosure has the following structure:

$$( 3 5-s d )$$

$${P}^{k} = \frac{1}{{γ}_{k}} {W}_{1}^{( k )} {W}_{2}^{( k )} {W}_{f}^{( k ) H} = \frac{1}{{γ}_{k}} {A}_{s , d}^{( k )} {C}^{( k )} {A}_{f , d}^{( k ) H} = \text{} \frac{1}{{γ}_{k}} [ \text{} \begin{matrix}{a}_{s , d , k , 0} & {a}_{s , d , k , - 1} & {a}_{s , d , k , - 2} & … & {a}_{s , d , k , - n + 1} \\ {a}_{s , d , k , 1} & {a}_{s , d , k , 0} & {a}_{s , d , k , - 1} & ⋱ & ⋮ \\ {a}_{s , d , k , 2} & {a}_{s , d , k , 1} & {a}_{s , d , k , 0} & ⋱ & {a}_{s , d , k , - 2} \\ ⋮ & ⋱ & ⋱ & ⋱ & {a}_{s , d , k , - 1} \\ {a}_{s , d , k , n - 1} & … & {a}_{s , d , k , 2} & {a}_{s , d , k , 1} & {a}_{s , d , k , 0}\end{matrix} ] * [ \text{} \begin{matrix}{c}_{k , 0 , 0} & {c}_{k , 0 , 1} & & {c}_{k , 0 , m - 1} \\ ⋮ & ⋮ & … & ⋮ \\ {c}_{k , n - 1 , 0} & {c}_{k , n - 1 , 1} & & {c}_{k , n - 1 , m - 1}\end{matrix} ] \text{} * {[ \begin{matrix}{a}_{f , k , 0} & {a}_{f , k , - 1} & {a}_{f , k , - 2} & … & {a}_{f , k , - m + 1} \\ {a}_{f , k , 1} & {a}_{f , k , 0} & {a}_{f , k , - 1} & ⋱ & ⋮ \\ {a}_{f , k , 2} & {a}_{f , k , 1} & {a}_{f , k , 0} & ⋱ & {a}_{f , k , - 2} \\ ⋮ & ⋱ & ⋱ & ⋱ & {a}_{f , k , - 1} \\ {a}_{f , k , m - 1} & … & {a}_{f , k , 2} & {a}_{f , k , 1} & {a}_{f , k , 0}\end{matrix} ]}^{H}$$

where γₖ is a normalization factor. In one example, W₁^{(k)} is a joint SD-DD/TD basis and W_{f}^{(k)} is an FD basis. The quantities a_{s,d,k,-n+1} . . . , a_{s,d,k,-1}, a_{s,d,k,0}, a_{s,d,k,1}, . . . , a_{s,d,k,n-1} and/or a_{f,k,-m+1} . . . , a_{f,k,-1}, a_{f,k,0}, a_{f,k,1}, . . . , a_{f,k,m-1} in (35-sd) can be configured to be determined by training an AI/ML model architecture. In another example, the quantities a_{s,d,k,-n+1} . . . , a_{s,d,k,-1}, a_{s,d,k,0}, a_{s,d,k,1} . . . , a_{s,d,k,n-1} and/or a_{f,k,-m+1} . . . , a_{f,k,-1}, a_{f,k,0}, a_{f,k,1}, . . . , a_{f,k,m-1} in (35-sd) can be configured from a candidate set of quantities. In another example, the quantities a_{s,d,k,-n+1} . . . , a_{s,d,k,-1}, a_{s,d,k,0}, a_{s,d,k,1}, . . . , a_{s,d,k,n-1} and/or a_{f,k,-m+1} . . . , a_{f,k,-1}, a_{f,k,0}, a_{f,k,1}, . . . , a_{f,k,m-1} in (35-sd) can be specified.

In a variation, for rank >1, for each layer k, in one embodiment, the precoding matrix based on this disclosure has the following structure:

$$( 3 5-s fd )$$

$${P}^{k} = \frac{1}{{γ}_{k}} {W}_{1}^{( k )} {W}_{2}^{( k )} = \frac{1}{{γ}_{k}} {A}_{s , f , d}^{( k )} {C}^{( k )} = \frac{1}{{γ}_{k}} [ \text{} \begin{matrix}{a}_{s , f , d , k , 0} & {a}_{s , f , d , k , - 1} & {a}_{s , f , d , k , - 2} & … & {a}_{s , f , d , k , - n + 1} \\ {a}_{s , f , d , k , 1} & {a}_{s , f , d , k , 0} & {a}_{s , f , d , k , - 1} & ⋱ & ⋮ \\ {a}_{s , f , d , k , 2} & {a}_{s , f , d , k , 1} & {a}_{s , f , d , k , 0} & ⋱ & {a}_{s , f , d , k , - 2} \\ ⋮ & ⋱ & ⋱ & ⋱ & {a}_{s , f , d , k , - 1} \\ {a}_{s , f , d , k , n - 1} & … & {a}_{s , f , d , k , 2} & {a}_{s , f , d , k , 1} & {a}_{s , f , d , k , 0}\end{matrix} ] * [ \text{} \begin{matrix}{c}_{k , 0 , 0} & {c}_{k , 0 , 1} & & {c}_{k , 0 , m - 1} \\ ⋮ & ⋮ & … & ⋮ \\ {c}_{k , n - 1 , 0} & {c}_{k , n - 1 , 1} & & {c}_{k , n - 1 , m - 1}\end{matrix} ] \text{}$$

where γₖ is a normalization factor. In one example, W₁^{(k)} is a joint SD-FD-DD/TD basis. The quantities a_{s,f,d,k,-n+1} . . . , a_{s,f,d,k,-1}, a_{s,f,d,k,0}, a_{s,f,d,k,1} . . . , a_{s,f,d,k,n-1} in (35-sfd) can be configured to be determined by training an AI/ML model architecture. In another example, the quantities a_{s,f,d,k,-n+1} . . . , a_{s,f,d,k,-1}, a_{s,f,d,k,0}, a_{s,f,d,k,1} . . . , a_{s,f,d,k,n-1} in (35-sfd) can be configured from a candidate set of quantities. In another example, the quantities a_{s,f,d,k,-n+1} . . . , a_{s,f,d,k,-1}, a_{s,f,d,k,0}, a_{s,f,d,k,1}, . . . , a_{s,f,d,k,n-1} in (35-sfd) can be specified.

In one embodiment, for the space and temporal domains, the precoding matrix based on this disclosure has the following structure:

$$( 37 )$$

$$P = \frac{1}{γ} {W}_{1} {W}_{2} {W}_{d}^{H} = \frac{1}{γ} {ACW}_{d}^{H} = \frac{1}{γ} [ \begin{matrix}{a}_{0} & {a}_{- 1} & {a}_{- 2} & … & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & … & {a}_{2} & {a}_{1} & {a}_{0}\end{matrix} ] [ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] {W}_{d}^{H}$$

where γ is a normalization factor and W_{d} corresponds to a different basis from W₁ (e.g., the DFT basis that is used to perform DD compression in the Rel. 18 Type II codebook refinement for high/medium velocities). In one example, W₁ is an SD basis (e.g., across P_{CSIRS} CSI-RS antenna ports). The quantities a₋ₙ₊₁ . . . , a₋₁, a₀, a₁, . . . , aₙ₋₁ in (37) can be configured to be determined by training an AI/ML model architecture. In another example, the quantities a₋ₙ₊₁ . . . , a₋₁, a₀, a₁, . . . , aₙ₋₁ in (37) can be configured from a candidate set of quantities. In another example, the quantities a₋ₙ₊₁ . . . , a₋₁, a₀, a₁, . . . , aₙ₋₁ in (37) can be specified.

In a variation, the precoding matrix based on this disclosure has the following structure:

$$P = \frac{1}{γ} {W}_{1} {W}_{2} {W}_{d}^{H} = \frac{1}{γ} [ \begin{matrix}{A}_{1} & 0 \\ 0 & {A}_{2}\end{matrix} ] {CW}_{d}^{H} \qquad ( 38 )$$

where γ is a normalization factor and W_{d} corresponds to a different basis from W₁ (e.g., the DFT basis that is used to perform DD compression in the Rel. 18 Type II codebook refinement for high/medium velocities). In one example, W₁ is an SD basis for two antenna groups (e.g., two antenna polarizations of the P_{CSIRS} CSI-RS antenna ports). Here, A₁ and A₂ are associated with the two groups. In one example, A₁=A₂=A. In one example, A₁ can be different from A₂.

Likewise, for rank>1, for each layer k, in one embodiment, the precoding matrix based on this disclosure has the following structure:

$${P}^{k} = \frac{1}{{γ}_{k}} {W}_{1}^{( k )} {W}_{2}^{( k )} {W}_{d}^{( k ) H} = \frac{1}{{γ}_{k}} {A}^{( k )} {C}^{( k )} {W}_{d}^{( k ) H} = \qquad ( 39 )$$

$$\frac{1}{{γ}_{k}} [ \begin{matrix}{a}_{k , 0} & {a}_{k , - 1} & {a}_{k , - 2} & … & {a}_{k , - n + 1} \\ {a}_{k , 1} & {a}_{k , 0} & {a}_{k , - 1} & ⋱ & ⋮ \\ {a}_{k , 2} & {a}_{k , 1} & {a}_{k , 0} & ⋱ & {a}_{k , - 2} \\ ⋮ & ⋱ & ⋱ & ⋱ & {a}_{k , - 1} \\ {a}_{k , n - 1} & … & {a}_{k , 2} & {a}_{k , 1} & {a}_{k , 0}\end{matrix} ]$$

$$[ \begin{matrix}{c}_{k , 0 , 0} & {c}_{k , 0 , 1} & & {c}_{k , 0 , m - 1} \\ ⋮ & ⋮ & … & ⋮ \\ {c}_{k , n - 1 , 0} & {c}_{k , n - 1 , 1} & & {c}_{k , n - 1 , m - 1}\end{matrix} ] {W}_{d}^{( k ) H}$$

where γₖ is a normalization factor and W_{d}^{(k)} corresponds to a different basis from W₁^{(k)} (e.g., the DFT basis that is used to perform DD compression in the Rel. 18 Type II codebook refinement for high/medium velocities). In one example, W₁^{(k)} is an SD basis (e.g., across P_{CSIRS} CSI-RS antenna ports). The quantities a_{k,-n+1} . . . a_{k,-1}, a_{k,0}, a_{k,1}, . . . , a_{k,n-1} in (39) can be configured to be determined by training an AI/ML model architecture. In another example, the quantities a_{k,-n+1} . . . a_{k,-1}, a_{k,0}, a_{k,1}, . . . , a_{k,n-1} in (39) can be configured from a candidate set of quantities. In another example, the quantities a_{k,-n+1} . . . , a_{k,-1}, a_{k,0}, a_{k,1}, . . . , a_{k,n-1} in (39) can be specified. In one example, W₁^{(k)} can be the same for each layer k. In another example, W₁^{(k)} can be determined on a per-layer basis. In one example, W₂^{(k)} can be the same for each layer k. In another example, W₂^{(k)} can be determined on a per-layer basis. In one example, W₁^{(k)} can be the same for each layer k. In another example, W₁^{(k)} can be determined on a per-layer basis. Each combination of these examples can also be supported.

In a variation, for rank >1, for each layer k, the precoding matrix based on this disclosure has the following structure:

$${P}^{k} = \frac{1}{{γ}_{k}} {W}_{1}^{( k )} {W}_{2}^{( k )} {W}_{d}^{( k ) H} = \frac{1}{{γ}_{k}} [ \begin{matrix}{A}_{k , 1} & 0 \\ 0 & {A}_{k , 2}\end{matrix} ] {C}^{( k )} {W}_{d}^{( k ) H} \qquad ( 40 )$$

where γₖ is a normalization factor and W_{d}^{(k)} corresponds to a different basis from W₁^{(k)} (e.g., the DFT basis that is used to perform DD compression in the Rel. 18 Type II codebook refinement for high/medium velocities). In one example, W₁^{(k)} is an SD basis for two antenna groups (e.g., two antenna polarizations of the P_{CSIRS} CSI-RS antenna ports). Here, A_{k,1} and A_{k,2} are associated with the two groups. In one example, A_{k,1}=A_{k,2}=Aₖ. In one example, A_{k,1} can be different from A_{k,2}.

In one embodiment, for the space and temporal domains, the precoding matrix based on this disclosure has the following structure:

$$P = \frac{1}{γ} {W}_{1} {W}_{2} {W}_{d}^{H} = \frac{1}{γ} {W}_{1} {CA}_{d}^{H} = \qquad ( 41 )$$

$$\frac{1}{γ} {{W}_{1} [ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] [ \begin{matrix}{a}_{d , 0} & {a}_{d , - 1} & {a}_{d , - 2} & … & {a}_{d , - m + 1} \\ {a}_{d , 1} & {a}_{d , 0} & {a}_{d , - 1} & ⋱ & ⋮ \\ {a}_{d , 2} & {a}_{d , 1} & {a}_{d , 0} & ⋱ & {a}_{d , - 2} \\ ⋮ & ⋱ & ⋱ & ⋱ & {a}_{d , - 1} \\ {a}_{d , m - 1} & … & {a}_{d , 2} & {a}_{d , 1} & {a}_{d , 0}\end{matrix} ]}^{H}$$

where γ is a normalization factor and W₁ corresponds to a different basis from W_{d} (e.g., the DFT basis that is used to perform SD compression in the Rel. 16 eType II codebook). In one example, W_{d} is a DD/TD basis. The quantities a_{d,-m+1} . . . , a_{d,-1}, a_{d,0}, a_{d,1}, . . . , a_{d,m-1} in (41) can be configured to be determined by training an AI/ML model architecture. In another example, the quantities a_{d,-m+1} . . . , a_{d,-1}, a_{d,0}, a_{d,1}, . . . , a_{d,m-1} in (41) can be configured from a candidate set of quantities. In another example, the quantities a_{d,-m+1} . . . , a_{d,-1}, a_{d,0}, a_{d,1}, . . . , a_{d,m-1} in (41) can be specified.

Likewise, for rank >1, for each layer k, in one embodiment, the precoding matrix based on this disclosure has the following structure:

$${P}^{k} = \frac{1}{{γ}_{k}} {W}_{1}^{( k )} {W}_{2}^{( k )} {W}_{d}^{( k ) H} = \frac{1}{{γ}_{k}} {W}_{1}^{( k )} {C}^{( k )} {A}_{d}^{( k ) H} = \qquad ( 42 )$$

$$\frac{1}{{γ}_{k}} {W}_{1}^{( k )} [ \begin{matrix}{c}_{k , 0 , 0} & {c}_{k , 0 , 1} & & {c}_{k , 0 , m - 1} \\ ⋮ & ⋮ & … & ⋮ \\ {c}_{k , n - 1 , 0} & {c}_{k , n - 1 , 1} & & {c}_{k , n - 1 , m - 1}\end{matrix} ]$$

$${[ \begin{matrix}{a}_{d , k , 0} & {a}_{d , k , - 1} & {a}_{d , k , - 2} & … & {a}_{d , k , - m + 1} \\ {a}_{d , k , 1} & {a}_{d , k , 0} & {a}_{d , k , - 1} & ⋱ & ⋮ \\ {a}_{d , k , 2} & {a}_{d , k , 1} & {a}_{d , k , 0} & ⋱ & {a}_{d , k , - 2} \\ ⋮ & ⋱ & ⋱ & ⋱ & {a}_{d , k , - 1} \\ {a}_{d , k , m - 1} & … & {a}_{d , k , 2} & {a}_{d , k , 1} & {a}_{d , k , 0}\end{matrix} ]}^{H}$$

where γₖ is a normalization factor and W₁^{(k)} corresponds to a different basis from W_{d}^{(k)} (e.g., the DFT basis that is used to perform SD compression in the Rel. 16 eType II codebook). In one example, W_{d}^{(k)} is a DD/TD basis. The quantities a_{d,k,-m+1} . . . , a_{d,k,-1}, a_{d,k,0}, a_{d,k,1}, . . . , a_{d,k,m-1} in (42) can be configured to be determined by training an AI/ML model architecture. In another example, the quantities a_{d,k,-m+1} . . . , a_{d,k,-1}, a_{d,k,0}, a_{d,k,1}, . . . , a_{d,k,m-1} in (42) can be configured from a candidate set of quantities. In another example, the quantities a_{d,k,-m+1} . . . , a_{d,k,-1}, a_{d,k,0}, a_{d,k,1}, . . . , a_{d,k,m-1} in (42) can be specified.

In one example, W₁^{(k)} can be the same for each layer k. In another example, W₁^{(k)} can be determined on a per-layer basis. In one example, W₂^{(k)} can be the same for each layer k. In another example, W₂^{(k)} can be determined on a per-layer basis. In one example, W₁^{(k)} can be the same for each layer k. In another example, W_{d}^{(k)} can be determined on a per-layer basis. Each combination of these examples can also be supported.

In one embodiment, for the frequency and temporal domains, the precoding matrix based on this disclosure has the following structure:

$$P = \frac{1}{γ} {{W}_{2} ( {W}_{f} ⊗ {W}_{d} )}^{H} = \frac{1}{γ} {CA}_{f}^{H} ⊗ {W}_{d}^{H} = \qquad ( 43 )$$

$$\frac{1}{γ} [ \begin{matrix}{c}_{0 , 0} & {c}_{0 , 1} & & {c}_{0 , mp - 1} \\ ⋮ & ⋮ & … & ⋮ \\ {c}_{n - 1 , 0} & {c}_{n - 1 , 1} & & {c}_{n - 1 , mp - 1}\end{matrix} ] *$$

$${[ \begin{matrix}{a}_{f , 0} & {a}_{f , - 1} & {a}_{f , - 2} & … & {a}_{f , - m + 1} \\ {a}_{f , 1} & {a}_{f , 0} & {a}_{f , - 1} & ⋱ & ⋮ \\ {a}_{f , 2} & {a}_{f , 1} & {a}_{f , 0} & ⋱ & {a}_{f , - 2} \\ ⋮ & ⋱ & ⋱ & ⋱ & {a}_{f , - 1} \\ {a}_{f , m - 1} & … & {a}_{f , 2} & {a}_{f , 1} & {a}_{f , 0}\end{matrix} ]}^{H} ⊗ {W}_{d}^{H}$$

where γ is a normalization factor and W_{d} corresponds to a different basis from W_{f} (e.g., the DFT basis that is used to perform DD compression in the Rel. 18 Type II codebook refinement for high/medium velocities). In one example, W_{f} is an FD basis. The quantities a_{f,-m+1} . . . , a_{f,-1}, a_{f,0}, a_{f,1}, . . . , a_{f,m-1} in (43) can be configured to be determined by training an AI/ML model architecture. In another example, the quantities a_{f,-m+1} . . . , a_{f,-1}, a_{f,0}, a_{f,1}, . . . , a_{f,m-1} in (43) can be configured from a candidate set of quantities. In another example, the quantities a_{f,-m+1} . . . , a_{f,-1}, a_{f,0}, a_{f,1}, . . . , a_{f,m-1} in (43) can be specified.

Likewise, for rank >1, for each layer k, in one embodiment, the precoding matrix based on this disclosure has the following structure:

$${P}^{k} = \frac{1}{{γ}_{k}} {{W}_{2}^{( k )} ( {W}_{f}^{( k )} ⊗ {W}_{d}^{( k )} )}^{H} = \frac{1}{{γ}_{k}} {C}^{( k )} {A}_{f}^{( k ) H} ⊗ {W}_{d}^{( k ) H} = \qquad ( 44 )$$

$$\frac{1}{{γ}_{k}} [ \begin{matrix}{c}_{k , 0 , 0} & {c}_{k , 0 , 1} & & {c}_{k , 0 , mp - 1} \\ ⋮ & ⋮ & … & ⋮ \\ {c}_{k , n - 1 , 0} & {c}_{k , n - 1 , 1} & & {c}_{k , n - 1 , mp - 1}\end{matrix} ]$$

$$[ \begin{matrix}{a}_{f , k , 0} & {a}_{f , k , - 1} & {a}_{f , k , - 2} & … & {a}_{f , k , - m + 1} \\ {a}_{f , k , 1} & {a}_{f , k , 0} & {a}_{f , k , - 1} & ⋱ & ⋮ \\ {a}_{f , k , 2} & {a}_{f , k , 1} & {a}_{f , k , 0} & ⋱ & {a}_{f , k , - 2} \\ ⋮ & ⋱ & ⋱ & ⋱ & {a}_{f , k , - 1} \\ {a}_{f , k , m - 1} & … & {a}_{f , k , 2} & {a}_{f , k , 1} & {a}_{f , k , 0}\end{matrix} ] ⊗ {W}_{d}^{( k ) H}$$

where γₖ is a normalization factor and W_{d}^{(k)} corresponds to a different basis from W_{f}^{(k)} (e.g., the DFT basis that is used to perform DD compression in the Rel. 18 Type II codebook refinement for high/medium velocities). In one example, W_{f}^{(k)} is an FD basis. The quantities a_{f,k,-m+1} . . . , a_{f,k,-1}, a_{f,k,0}, a_{f,k,1}, . . . , a_{f,k,m-1} in (44) can be configured to be determined by training an AI/ML model architecture. In another example, the quantities a_{f,k,-m+1} . . . , a_{f,k,-1}, a_{f,k,0}, a_{f,k,1}, a_{f,k,m-1} in (44) can be configured from a candidate set of quantities. In another example, the quantities a_{f,k,-m+1} . . . , a_{f,k,-1}, a_{f,k,0}, a_{f,k,1}, . . . , a_{f,k,m-1} in (44) can be specified.

In one example, W_{f}^{(k)} can be the same for each layer k. In another example, W_{f}^{(k)} can be determined on a per-layer basis. In one example, W₂^{(k)} can be the same for each layer k. In another example, W₂^{(k)} can be determined on a per-layer basis. In one example, W_{d}^{(k)} can be the same for each layer k. In another example, W_{f}^{(k)} can be determined on a per-layer basis. Each combination of these examples can also be supported.

In one embodiment, for the frequency and temporal domains, the precoding matrix based on this disclosure has the following structure:

$$P = \frac{1}{γ} {{W}_{2} ( {W}_{f} ⊗ {W}_{d} )}^{H} = \frac{1}{γ} {CW}_{f}^{H} ⊗ {A}_{d}^{H} = \qquad ( 45 )$$

$$\frac{1}{γ} [ \begin{matrix}{c}_{0 , 0} & {c}_{0 , 1} & & {c}_{0 , mp - 1} \\ ⋮ & ⋮ & … & ⋮ \\ {c}_{n - 1 , 0} & {c}_{n - 1 , 1} & & {c}_{n - 1 , mp - 1}\end{matrix} ] * {W}_{f}^{H} ⊗$$

$${[ \begin{matrix}{a}_{d , 0} & {a}_{d , - 1} & {a}_{d , - 2} & … & {a}_{d , - p + 1} \\ {a}_{d , 1} & {a}_{d , 0} & {a}_{d , - 1} & ⋱ & ⋮ \\ {a}_{d , 2} & {a}_{d , 1} & {a}_{d , 0} & ⋱ & {a}_{d , - 2} \\ ⋮ & ⋱ & ⋱ & ⋱ & {a}_{d , - 1} \\ {a}_{d , p - 1} & … & {a}_{d , 2} & {a}_{f , 1} & {a}_{d , 0}\end{matrix} ]}^{H}$$

where γ is a normalization factor and W_{f} corresponds to a different basis from W_{d} (e.g., the DFT basis that is used to perform FD compression in the Rel. 16 eType II codebook). In one example, W_{d} is a DD/TD basis. The quantities a_{d,-p+1} . . . a_{d,-1}, a_{d,0}, a_{d,1}, . . . , a_{d,p-1} in (45) can be configured to be determined by training an AI/ML model architecture. In another example, the quantities a_{d,-p+1} . . . , a_{d,-1}, a_{d,0}, a_{d,1}, . . . , a_{d,p-1} in (45) can be configured from a candidate set of quantities. In another example, the quantities a_{d,-p+1} . . . , a_{d,-1}, a_{d,0}, a_{d,1}, . . . , a_{d,p-1} in (45) can be specified.

Likewise, for rank >1, for each layer k, in one embodiment, the precoding matrix based on this disclosure has the following structure:

$${P}^{k} = \frac{1}{{γ}_{k}} {{W}_{2}^{( k )} ( {W}_{f}^{( k )} ⊗ {W}_{d}^{( k )} )}^{H} = \frac{1}{{γ}_{k}} {C}^{( k )} {W}_{f}^{( k ) H} ⊗ {A}_{d}^{( k ) H} = \qquad ( 46 )$$

$$\frac{1}{{γ}_{k}} [ \begin{matrix}{c}_{k , 0 , 0} & {c}_{k , 0 , 1} & & {c}_{k , 0 , mp - 1} \\ ⋮ & ⋮ & … & ⋮ \\ {c}_{k , n - 1 , 0} & {c}_{k , n - 1 , 1} & & {c}_{k , n - 1 , mp - 1}\end{matrix} ] {W}_{f}^{( k ) H} ⊗$$

$${[ \begin{matrix}{a}_{d , k , 0} & {a}_{d , k , - 1} & {a}_{d , k , - 2} & … & {a}_{d , k , - p + 1} \\ {a}_{d , k , 1} & {a}_{d , k , 0} & {a}_{d , k , - 1} & ⋱ & ⋮ \\ {a}_{d , k , 2} & {a}_{d , k , 1} & {a}_{d , k , 0} & ⋱ & {a}_{d , k , - 2} \\ ⋮ & ⋱ & ⋱ & ⋱ & {a}_{d , k , - 1} \\ {a}_{d , k , p - 1} & … & {a}_{d , k , 2} & {a}_{d , k , 1} & {a}_{d , k , 0}\end{matrix} ]}^{H}$$

where γₖ is a normalization factor and W_{f}^{(k)} corresponds to a different basis from W_{d}^{(k)} (e.g., the DFT basis that is used to perform FD compression in the Rel. 16 eType II codebook). In one example, W_{d}^{(k)} is a DD/TD basis. The quantities a_{d,k,-p+1} . . . , a_{d,k,-1}, a_{d,k,0}, a_{d,k,1}, . . . , a_{d,k,p-1} in (46) can be configured to be determined by training an AI/ML model architecture. In another example, the quantities a_{d,k,-p+1} . . . , a_{d,k,-1}, a_{d,k,0}, a_{d,k,1}, . . . , a_{d,k,p-1} in (46) can be configured from a candidate set of quantities. In another example, the quantities a_{d,k,-p+1} . . . , a_{d,k,-1}, a_{d,k,0}, a_{d,k,1}, . . . , a_{d,k,p-1} in (46) can be specified.

In one example, W_{f}^{(k)} can be the same for each layer k. In another example, W_{f}^{(k)} can be determined on a per-layer basis. In one example, W₂^{(k)} can be the same for each layer k. In another example, W₂^{(k)} can be determined on a per-layer basis. In one example, W_{f}^{(k)} can be the same for each layer k. In another example, W_{d}^{(k)} can be determined on a per-layer basis. Each combination of these examples can also be supported.

In one embodiment, for the space, frequency, and temporal domains, the precoding matrix based on this disclosure has the following structure:

$$P = \frac{1}{γ} {W}_{1} {{W}_{2} ( {W}_{f} ⊗ {W}_{d} )}^{H} = \frac{1}{γ} {W}_{1} {C ( {A}_{f} ⊗ {A}_{d} )}^{H} = \frac{1}{γ} {W}_{1} * \qquad ( 47 )$$

$$[ \begin{matrix}{c}_{0 , 0} & {c}_{0 , 1} & & {c}_{0 , mp - 1} \\ ⋮ & ⋮ & … & ⋮ \\ {c}_{n - 1 , 0} & {c}_{n - 1 , 1} & & {c}_{n - 1 , mp - 1}\end{matrix} ] * {[ \begin{matrix}{a}_{f , 0} & {a}_{f , - 1} & {a}_{f , - 2} & … & {a}_{f , - m + 1} \\ {a}_{f , 1} & {a}_{f , 0} & {a}_{f , - 1} & ⋱ & ⋮ \\ {a}_{f , 2} & {a}_{f , 1} & {a}_{f , 0} & ⋱ & {a}_{f , - 2} \\ ⋮ & ⋱ & ⋱ & ⋱ & {a}_{f , - 1} \\ {a}_{f , m - 1} & … & {a}_{f , 2} & {a}_{f , 1} & {a}_{f , 0}\end{matrix} ]}^{H} ⊗$$

$${[ \begin{matrix}{a}_{d , 0} & {a}_{d , - 1} & {a}_{d , - 2} & … & {a}_{d , - p + 1} \\ {a}_{d , 1} & {a}_{d , 0} & {a}_{d , - 1} & ⋱ & ⋮ \\ {a}_{d , 2} & {a}_{d , 1} & {a}_{d , 0} & ⋱ & {a}_{d , - 2} \\ ⋮ & ⋱ & ⋱ & ⋱ & {a}_{d , - 1} \\ {a}_{d , p - 1} & … & {a}_{d , 2} & {a}_{f , 1} & {a}_{d , 0}\end{matrix} ]}^{H}$$

where γ is a normalization factor and W₁ corresponds to a different basis from W_{f} and W_{d} (e.g., the DFT basis that is used to perform SD compression in the Rel. 16 eType II codebook). In one example, W_{f} is an FD basis, and W_{d} is a DD/TD basis. The quantities a_{f,-m+1} . . . , a_{f,-1}, a_{f,0}, a_{f,1}, . . . , a_{f,m-1} and/or a_{d,p+1} . . . , a_{d,-1}, a_{d,0}, a_{d,1}, . . . , a_{d,p-1} in (47) can be configured to be determined by training an AI/ML model architecture. In another example, the quantities a_{f,m+1} . . . , a_{f,-1}, a_{f,0}, a_{f,1}, . . . , a_{f,m-1} and/or a_{d-p+1} . . . , a_{d,-1}, a_{d,0}, a_{d,1}, . . . , a_{d,p-1} in (47) can be configured from a candidate set of quantities. In another example, the quantities a_{f,-m+1}, . . . , a_{f,-1}, a_{f,0}, a_{f,1}, . . . , a_{f,m-1} and/or a_{d,-p+1} . . . , a_{d,-1}, a_{d,0}, a_{d,1}, . . . , a_{d,p-1} in (47) can be specified.

In a variation, the precoding matrix based on this disclosure has the following structure:

$$P = \frac{1}{γ} {W}_{1} {W}_{2} {W}_{f , d}^{H} = \frac{1}{γ} {W}_{1} {CA}_{f , d}^{H} = \frac{1}{γ} {W}_{1} * \qquad ( 47 - fd )$$

$$[ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] * [ \begin{matrix}{a}_{f , d , 0} & {a}_{f , d , - 1} & {a}_{f , d , - 2} & … & {a}_{f , d , - m + 1} \\ {a}_{f , d , 1} & {a}_{f , d , 0} & {a}_{f , d , - 1} & ⋱ & ⋮ \\ {a}_{f , d , 2} & {a}_{f , d , 1} & {a}_{f , d , 0} & ⋱ & {a}_{f , d , - 2} \\ ⋮ & ⋱ & ⋱ & ⋱ & {a}_{f , d , - 1} \\ {a}_{f , d , m - 1} & … & {a}_{f , d , 2} & {a}_{f , d , 1} & {a}_{f , d , 0}\end{matrix} ]$$

where γ is a normalization factor and W₁ corresponds to a different basis from W_{f,d} (e.g., the DFT basis that is used to perform SD compression in the Rel. 16 eType II codebook). In one example, W_{f,d} is a joint FD-DD/TD basis. The quantities a_{f,d,-m+1} . . . , a_{f,d,-1}, a_{f,d,0}, a_{f,d,1}, . . . , a_{f,d,m-1} in (47-fd) can be configured to be determined by training an AI/ML model architecture. In another example, the quantities a_{f,d,-m+1} . . . , a_{f,d,-1}, a_{f,d,0}, a_{f,d,1}, . . . , a_{f,d,m-1} in (47-fd) can be configured from a candidate set of quantities. In another example, the quantities a_{f,d,-m+1} . . . , a_{f,d,-1}, a_{f,d,0}, a_{f,d,1} . . . , a_{f,d,m-1} in (47-fd) can be specified.

Likewise, for rank >1, for each layer k, in one embodiment, the precoding matrix based on this disclosure has the following structure:

$${P}^{k} = \frac{1}{{γ}_{k}} {W}_{1}^{( k )} {{W}_{2}^{( k )} ( {W}_{f}^{( k )} ⊗ {W}_{d}^{( k )} )}^{H} = \frac{1}{{γ}_{k}} {W}_{1}^{( k )} {{C}^{( k )} ( {A}_{f}^{( k )} ⊗ {A}_{d}^{( k )} )}^{H} = \qquad ( 48 )$$

$$\frac{1}{{γ}_{k}} {W}_{1}^{( k )} * [ \begin{matrix}{c}_{k , 0 , 0} & {c}_{k , 0 , 1} & & {c}_{k , 0 , mp - 1} \\ ⋮ & ⋮ & … & ⋮ \\ {c}_{k , n - 1 , 0} & {c}_{k , no - 1 , 1} & & {c}_{k , n - 1 , mp - 1}\end{matrix} ] *$$

$${[ \begin{matrix}{a}_{f , k , 0} & {a}_{f , k , - 1} & {a}_{f , k , - 2} & … & {a}_{f , k , - m + 1} \\ {a}_{f , k , 1} & {a}_{f , k , 0} & {a}_{f , k , - 1} & ⋱ & ⋮ \\ {a}_{f , k , 2} & {a}_{f , k , 1} & {a}_{f , k , 0} & ⋱ & {a}_{f , k , - 2} \\ ⋮ & ⋱ & ⋱ & ⋱ & {a}_{f , k , - 1} \\ {a}_{f , k , m - 1} & … & {a}_{f , k , 2} & {a}_{f , k , 1} & {a}_{f , k , 0}\end{matrix} ]}^{H} ⊗$$

$${[ \begin{matrix}{a}_{d , k , 0} & {a}_{d , k , - 1} & {a}_{d , k , - 2} & … & {a}_{d , k , - p + 1} \\ {a}_{d , k , 1} & {a}_{d , k , 0} & {a}_{d , k , - 1} & ⋱ & ⋮ \\ {a}_{d , k , 2} & {a}_{d , k , 1} & {a}_{d , k , 0} & ⋱ & {a}_{d , k , - 2} \\ ⋮ & ⋱ & ⋱ & ⋱ & {a}_{d , k , - 1} \\ {a}_{d , k , p - 1} & … & {a}_{d , k , 2} & {a}_{d , k , 1} & {a}_{d , k , 0}\end{matrix} ]}^{H}$$

where γₖ is a normalization factor and W₁^{(k)} corresponds to a different basis from W_{f}^{(k)} and W_{d}^{(k)} (e.g. the DFT basis that is used to perform SD compression in the Rel. 16 eType II codebook). In one example, W_{f}^{(k)} is an FD basis and W_{d}^{(k)} is a DD/TD basis. The quantities a_{f,k,-m+1} . . . , a_{f,k,-1}, a_{f,k,0}, a_{f,k,1}, . . . , a_{f,k,m-1} and/or a_{d,k,p+1} . . . , a_{d,k,-1}, a_{d,k,0}, a_{d,k,1}, . . . a_{d,k,p-1} in (48) can be configured to be determined by training an AI/ML model architecture. In another example, the quantities a_{f,k,-m+1} . . . , a_{f,k,-1}, a_{f,k,0}, a_{f,k,1}, . . . , a_{f,k,m-1} and/or a_{d,k,-p+1} . . . , a_{d,k,-1}, a_{d,k,0}, a_{d,k,1}, . . . , a_{d,k,p-1} in (48) can be configured from a candidate set of quantities. In another example, the quantities a_{f,k,-m+1} . . . , a_{f,k,-1}, a_{f,k,0}, a_{f,k,1}, . . . , a_{f,k,m-1} and/or a_{d,k,-p+1} . . . , a_{d,k,-1}, a_{d,k,0}, a_{d,k,1}, . . . , a_{d,k,p-1} in (48) can be specified.

In one example, W₁^{(k)} can be the same for each layer k. In another example, W₁^{(k)} can be determined on a per-layer basis. In one example, W₂^{(k)} can be the same for each layer k. In another example, W₂^{(k)} can be determined on a per-layer basis. In one example, W_{f}^{(k)} can be the same for each layer k. In another example, W_{f}^{(k)} can be determined on a per-layer basis. In one example, W_{d}^{(k)} can be the same for each layer k. In another example, W_{d}^{(k)} can be determined on a per-layer basis. Each combination of these examples can also be supported.

In a variation, for rank >1, for each layer k, in one embodiment, the precoding matrix based on this disclosure has the following structure:

$${P}^{k} = \frac{1}{{γ}_{k}} {W}_{1}^{( k )} {W}_{2}^{( k )} {W}_{f , d}^{( k ) H} = \frac{1}{{γ}_{k}} {W}_{1}^{( k )} {C}^{( k )} {A}_{f , d}^{( k ) H} = \frac{1}{{γ}_{k}} {W}_{1}^{( k )} * \qquad ( 48 - fd )$$

$$[ \begin{matrix}{c}_{k , 0 , 0} & {c}_{k , 0 , 1} & & {c}_{k , 0 , m - 1} \\ ⋮ & ⋮ & … & ⋮ \\ {c}_{k , n - 1 , 0} & {c}_{k , n - 1 , 1} & & {c}_{k , n - 1 , m - 1}\end{matrix} ] *$$

$$[ \begin{matrix}{a}_{f , d , k , 0} & {a}_{f , d , k , - 1} & {a}_{f , d , k , - 2} & … & {a}_{f , d , k , - m + 1} \\ {a}_{f , d , k , 1} & {a}_{f , d , k , 0} & {a}_{f , d , k , 0} & ⋱ & ⋮ \\ {a}_{f , d , k , 2} & {a}_{f , d , k , 1} & {a}_{f , d , k , 0} & ⋱ & {a}_{f , d , k , - 1} \\ ⋮ & ⋱ & ⋱ & ⋱ & {a}_{f , d , k , - 1} \\ {a}_{f , d , k , m - 1} & … & {a}_{f , d , k , 2} & {a}_{f , d , k , 1} & {a}_{f , d , k , 0}\end{matrix} ]$$

where γₖ is a normalization factor and W₁^{(k)} corresponds to a different basis from W_{f,d}^{(k)} (e.g., the DFT basis that is used to perform SD compression in the Rel. 16 eType II codebook). In one example, W_{f,d}^{(k)} is a joint FD-DD/TD basis. The quantities a_{f,d,k,-m+1} . . . , a_{f,d,k,-1}, a_{f,d,k,0}, a_{f,d,k,1}, . . . , a_{f,d,k,m-1} in (48-fd) can be configured to be determined by training an AI/ML model architecture. In another example, the quantities a_{f,d,k,-m+1} . . . , a_{f,d,k,-1}, a_{f,d,k,0}, a_{f,d,k,1}, . . . , a_{f,d,k,m-1} in (48-fd) can be configured from a candidate set of quantities. In another example, the quantities a_{f,d,k,-m+1} . . . , a_{f,d,k,-1}, a_{f,d,k,0}, a_{f,d,k,1}, a_{f,d,k,m-1} in (48-fd) can be specified.

In one embodiment, for the space, frequency, and temporal domains, the precoding matrix based on this disclosure has the following structure:

$$P = \frac{1}{γ} {W}_{1} {{W}_{2} ( {W}_{f} ⊗ {W}_{d} )}^{H} = \frac{1}{γ} {ACW}_{f}^{H} ⊗ {A}_{d}^{H} = \qquad ( 49 )$$

$$\frac{1}{γ} [ \begin{matrix}{a}_{0} & {a}_{- 1} & {a}_{- 2} & … & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & … & {a}_{2} & {a}_{1} & {a}_{0}\end{matrix} ] * [ \begin{matrix}{c}_{0 , 0} & {c}_{0 , 1} & & {c}_{0 , mp - 1} \\ ⋮ & ⋮ & … & ⋮ \\ {c}_{n - 1 , 0} & {c}_{n - 1 , 1} & & {c}_{n - 1 , mp - 1}\end{matrix} ] *$$

$${W}_{f}^{H} ⊗ {[ \begin{matrix}{a}_{d , 0} & {a}_{d , - 1} & {a}_{d , - 2} & … & {a}_{d , - p + 1} \\ {a}_{d , 1} & {a}_{d , 0} & {a}_{d , - 1} & ⋱ & ⋮ \\ {a}_{d , 2} & {a}_{d , 1} & {a}_{d , 0} & ⋱ & {a}_{d , - 2} \\ ⋮ & ⋱ & ⋱ & ⋱ & {a}_{d , - 1} \\ {a}_{d , p - 1} & … & {a}_{d , 2} & {a}_{f , 1} & {a}_{d , 0}\end{matrix} ]}^{H}$$

where γ is a normalization factor and W_{f} corresponds to a different basis from W₁ and W_{d} (e.g., the DFT basis that is used to perform FD compression in the Rel. 16 eType II codebook). In one example, W₁ is an SD basis (e.g., across P_{CSIRS} CSI-RS antenna ports) and W_{d} is a DD/TD basis. The quantities a₋ₙ₊₁ . . . , a₋₁, a₀, a₁, . . . , aₙ₋₁ and/or a_{d,-+1} . . . , a_{d,-1}, a_{d,0}, a_{d,1}, . . . , a_{d,p-1} in (49) can be configured to be determined by training an AI/ML model architecture. In another example, the quantities a₋ₙ₊₁ . . . , a₋₁, a₀, a₁, . . . , aₙ₋₁ and/or a_{d,-p+1} . . . , a_{d,-1}, a_{d,0}, a_{d,1}, . . . , a_{d,p-1} in (49) can be configured from a candidate set of quantities. In another example, the quantities a₋ₙ₊₁ . . . , a₋₁, a₀, a₁, . . . , aₙ₋₁ and/or a_{d,-p+1} . . . , a_{d,-1}, a_{d,0}, a_{d,1}, . . . , a_{d,p-1} in (49) can be specified.

In a variation, the precoding matrix based on this disclosure has the following structure:

$$P = \frac{1}{γ} {W}_{1} {{W}_{2} ( {W}_{f} ⊗ {W}_{d} )}^{H} = \frac{1}{γ} [ \begin{matrix}{A}_{1} & 0 \\ 0 & {A}_{2}\end{matrix} ] {CW}_{f}^{H} ⊗ {A}_{d}^{H} \qquad ( 50 )$$

where γ is a normalization factor. In one example, W₁ is an SD basis for two antenna groups (e.g., two antenna polarizations of the P_{CSIRS} CSI-RS antenna ports). Here, A₁ and A₂ are associated with the two groups. In one example, A₁=A₂=A. In one example, A₁ can be different from A₂.

In one embodiment, for the space, frequency, and temporal domains, the precoding matrix based on this disclosure has the following structure:

$$P = \frac{1}{γ} {W}_{1} {W}_{2} {W}_{f}^{H} = \frac{1}{γ} {A}_{s , d} {CW}_{f}^{H} = \qquad ( 49 - sd )$$

$$\frac{1}{γ} [ \begin{matrix}{a}_{s , d , 0} & {a}_{s , d , - 1} & {a}_{s , d , - 2} & … & {a}_{s , d , - n + 1} \\ {a}_{s , d , 1} & {a}_{s , d , 0} & {a}_{s , d , - 1} & ⋱ & ⋮ \\ {a}_{s , d , 2} & {a}_{s , d , 1} & {a}_{s , d , 0} & ⋱ & {a}_{s , d , - 2} \\ ⋮ & ⋱ & ⋱ & ⋱ & {a}_{s , d , - 1} \\ {a}_{s , d , n - 1} & … & {a}_{s , d , 2} & {a}_{s , d , 1} & {a}_{s , d , 0}\end{matrix} ] *$$

$$[ \begin{matrix}{c}_{0 , 0} & {c}_{0 , 1} & & {c}_{0 , m - 1} \\ ⋮ & ⋮ & … & ⋮ \\ {c}_{n - 1 , 0} & {c}_{n - 1 , 1} & & {c}_{n - 1 , m - 1}\end{matrix} ] * {W}_{f}^{H}$$

where γ is a normalization factor and W_{f} corresponds to a different basis from W₁ (e.g., the DFT basis that is used to perform FD compression in the Rel. 16 eType II codebook). In one example, W₁ is a joint SD-DD/TD basis. The quantities a_{s,d,-n+1} . . . , a_{s,d-1}, a_{s,d,0}, a_{s,d,1}, . . . , a_{s,d,n-1} in (49-sd) can be configured to be determined by training an AI/ML model architecture. In another example, the quantities a_{s,d,-n+1} . . . , a_{s,d-1}, a_{s,d,0}, a_{s,d,1}, . . . , a_{s,d,n-1} in (49-sd) can be configured from a candidate set of quantities. In another example, the quantities a_{s,d,-n+1} . . . , a_{s,d-1}, a_{s,d,0}, a_{s,d,1}, . . . , a_{s,d,n-1} in (49-sd) can be specified.

Likewise, for rank >1, for each layer k, in one embodiment, the precoding matrix based on this disclosure has the following structure:

$${P}^{k} = \frac{1}{{γ}_{k}} {W}_{1}^{( k )} {{W}_{2}^{( k )} ( {W}_{f}^{( k )} ⊗ {W}_{d}^{( k )} )}^{H} = \frac{1}{{γ}_{k}} {A}^{( k )} {C}^{( k )} {W}_{f}^{( k ) H} ⊗ {A}_{d}^{( k ) H} = \frac{1}{{γ}_{k}} [ \begin{matrix}{a}_{k , 0} & {a}_{k , - 1} & {a}_{k , - 2} & ⋯ & {a}_{k , - n + 1} \\ {a}_{k , 1} & {a}_{k , 0} & {a}_{k , - 1} & ⋱ & ⋮ \\ {a}_{k , 2} & {a}_{k , 1} & {a}_{k , 0} & ⋱ & {a}_{k , - 2} \\ ⋮ & ⋱ & ⋱ & ⋱ & {a}_{k , - 1} \\ {a}_{k , n - 1} & ⋯ & {a}_{k , 2} & {a}_{k , 1} & {a}_{k , 0}\end{matrix} ] * [ \begin{matrix}{c}_{k , 0 , 0} & {c}_{k , 0 , 1} & & {c}_{k , 0 , m p - 1} \\ ⋮ & ⋮ & ⋯ & ⋮ \\ {c}_{k , n - 1 , 0} & {c}_{k , n - 1 , 1} & & {c}_{k , n - 1 , m p - 1}\end{matrix} ] * {W}_{f}^{( k ) H} ⊗ {[ \begin{matrix}{a}_{d , k , 0} & {a}_{d , k , - 1} & {a}_{d , k , - 2} & ⋯ & {a}_{d , k , - p + 1} \\ {a}_{d , k , 1} & {a}_{d , k , 0} & {a}_{d , k , - 1} & ⋱ & ⋮ \\ {a}_{d , k , 2} & {a}_{d , k , 1} & {a}_{d , k , 0} & ⋱ & {a}_{d , k , - 2} \\ ⋮ & ⋱ & ⋱ & ⋱ & {a}_{d , k , - 1} \\ {a}_{d , k , p - 1} & ⋯ & {a}_{d , k , 2} & {a}_{d , k , 1} & {a}_{d , k , 0}\end{matrix} ]}^{H} \qquad ( 51 )$$

where γₖ is a normalization factor and W_{f}^{(k)} corresponds to a different basis from W₁^{(k)} and W_{d}^{(k)} (e.g. the DFT basis that is used to perform FD compression in the Rel. 16 eType II codebook). In one example, W₁^{(k)} is an SD basis (e.g., across P_{CSIRS} CSI-RS antenna ports) and W_{d}^{(k)} is a DD/TD basis. The quantities a_{k,-n+1} . . . , a_{k,-1}, a_{k,0}, a_{k,1}, . . . , a_{k,n-1} and/or a_{d,k,-p+1} . . . , a_{d,k,-1}, a_{d,k,0}, a_{d,k,1}, . . . , a_{d,k,p-1} in (51) can be configured to be determined by training an AI/ML model architecture. In another example, the quantities a_{k,-n+1} . . . , a_{k,-1}, a_{k,0}, a_{k,1}, . . . , a_{k,n-1} and/or a_{d,k,-p+1} . . . , a_{d,k,-1}, a_{d,k,0}, a_{d,k,1}, . . . , a_{d,k,p-1} in (51) can be configured from a candidate set of quantities. In another example, the quantities a_{k,-n+1} . . . , a_{k,-1}, a_{k,0}, a_{k,1}, . . . , a_{k,n-1} and/or a_{d,k,-p+1} . . . , a_{d,k,-1}, a_{d,k,0}, a_{d,k,1}, . . . , a_{d,k,p-1} in (51) can be specified.

In one example, W₁^{(k)} can be the same for each layer k. In another example, W₁^{(k)} can be determined on a per-layer basis. In one example, W₂^{(k)} can be the same for each layer k. In another example, W₂^{(k)} can be determined on a per-layer basis. In one example, W_{f}^{(k)} can be the same for each layer k. In another example, W_{f}^{(k)} can be determined on a per-layer basis. In one example, W_{d}^{(k)} can be the same for each layer k. In another example, W_{d}^{(k)} can be determined on a per-layer basis. Each combination of these examples can also be supported.

In a variation, for rank >1, for each layer k, the precoding matrix based on this disclosure has the following structure:

$${P}^{k} = \frac{1}{{γ}_{l 𝔠}} {W}_{1}^{( k )} {{W}_{2}^{( k )} ( {W}_{f}^{( k )} ⊗ {W}_{d}^{( k )} )}^{H} = \frac{1}{{γ}_{k}} [ \begin{matrix}{A}_{k , 1} & 0 \\ 0 & {A}_{k , 2}\end{matrix} ] {C}^{( k )} {W}_{f}^{( k ) H} ⊗ {A}_{d}^{( k ) H} \qquad ( 52 )$$

where γₖ is a normalization factor. In one example, W₁^{(k)} is an SD basis for two antenna groups (e.g., two antenna polarizations of the P_{CSIRS} CSI-RS antenna ports) and W_{d}^{(k)} is a DD/TD basis. Here, A_{k,1} and A_{k,2} are associated with the two groups. In one example, A_{k,1}=A_{k,2}=Aₖ. In one example, A_{k,1} can be different from A_{k,2}.

In a variation, for rank >1, for each layer k, in one embodiment, the precoding matrix based on this disclosure has the following structure:

$${P}^{k} = \frac{1}{{γ}_{k}} {W}_{1}^{( k )} {W}_{2}^{( k )} {W}_{f}^{( k ) H} = \frac{1}{{γ}_{k}} {A}_{s , d}^{( k )} {C}^{( k )} {W}_{f}^{( k ) H} = \frac{1}{{γ}_{k}} [ \begin{matrix}{a}_{s , d , k , 0} & {a}_{s , d , k , - 1} & {a}_{s , d , k , - 2} & ⋯ & {a}_{s , d , k , - n + 1} \\ {a}_{s , d , k , 1} & {a}_{s , d , k , 0} & {a}_{s , d , k , - 1} & ⋱ & ⋮ \\ {a}_{s , d , k , 2} & {a}_{s , d , k , 1} & {a}_{s , d , k , 0} & ⋱ & {a}_{s , d , k , - 2} \\ ⋮ & ⋱ & ⋱ & ⋱ & {a}_{s , d , k , - 1} \\ {a}_{s , d , k , n - 1} & ⋯ & {a}_{s , d , k , 2} & {a}_{s , d , k , 1} & {a}_{s , d , k , 0}\end{matrix} ] * [ \begin{matrix}{c}_{k , 0 , 0} & {c}_{k , 0 , 1} & & {c}_{k , 0 , m - 1} \\ ⋮ & ⋮ & ⋯ & ⋮ \\ {c}_{k , n - 1 , 0} & {c}_{k , n - 1 , 1} & & {c}_{k , n - 1 , m - 1}\end{matrix} ] * {W}_{f}^{( k ) H} \qquad ( 51 ‐ sd )$$

where γₖ is a normalization factor and W_{f}^{(k)} corresponds to a different basis from W₁^{(k)} (e.g., the DFT basis that is used to perform FD compression in the Rel. 16 eType II codebook). In one example, W₁^{(k)} is a joint SD-DD/TD basis. The quantities a_{s,d,k,-n+1} . . . , a_{s,d,k,-1}, a_{s,d,k,0}, a_{s,d,k,1}, . . . , a_{s,d,k,n-1} in (51-sd) can be configured to be determined by training an AI/ML model architecture. In another example, the quantities a_{s,d,k,-n+1} . . . , a_{s,d,k,-1}, a_{s,d,k,0}, a_{s,d,k,1}, . . . a_{s,d,k,n-1} in (51-sd) can be configured from a candidate set of quantities. In another example, the quantities a_{s,d,k,-n+1} . . . , a_{s,d,k,-1}, a_{s,d,k,0}, a_{s,d,k,1}, . . . , a_{s,d,k,n-1} in (51-sd) can be specified.

In one embodiment, for the space, frequency, and temporal domains, the precoding matrix based on this disclosure has the following structure:

$$P = \frac{1}{γ} {W}_{1} {{W}_{2} ( {W}_{f} ⊗ {W}_{d} )}^{H} = \frac{1}{γ} {ACA}_{f}^{H} ⊗ {W}_{d}^{H} = \frac{1}{γ} [ \begin{matrix}{a}_{0} & {a}_{- 1} & {a}_{- 2} & ⋯ & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & ⋯ & {a}_{2} & {a}_{1} & {a}_{0}\end{matrix} ] * [ \begin{matrix}{c}_{0 , 0} & {c}_{0 , 1} & & {c}_{0 , m p - 1} \\ ⋮ & ⋮ & ⋯ & ⋮ \\ {c}_{n - 1 , 0} & {c}_{n - 1 , 1} & & {c}_{n - 1 , m p - 1}\end{matrix} ] * {[ \begin{matrix}{a}_{f , 0} & {a}_{f , - 1} & {a}_{f , - 2} & ⋯ & {a}_{f , - m + 1} \\ {a}_{f , 1} & {a}_{f , 0} & {a}_{f , - 1} & ⋱ & ⋮ \\ {a}_{f , 2} & {a}_{f , 1} & {a}_{f , 0} & ⋱ & {a}_{f , - 2} \\ ⋮ & ⋱ & ⋱ & ⋱ & {a}_{f , - 1} \\ {a}_{f , m - 1} & ⋯ & {a}_{f , 2} & {a}_{f , 1} & {a}_{f , 0}\end{matrix} ]}^{H} ⊗ {W}_{d}^{H} \qquad ( 53 )$$

where γ is a normalization factor and W_{d} corresponds to a different basis from W₁ and W_{f} (e.g., the DFT basis that is used to perform DD compression in the Rel. 18 Type II codebook refinement for high/medium velocities). In one example, W₁ is an SD basis (e.g., across P_{CSIRS} CSI-RS antenna ports) and W_{f} is an FD basis. The quantities a₋ₙ₊₁ . . . , a₁, a₀, a₁, . . . , aₙ₋₁ and/or a_{f,-m+1} . . . , a_{f,-1}, a_{f,0}, a_{f,1}, . . . , a_{f,m-1} in (53) can be configured to be determined by training an AI/ML model architecture. In another example, the quantities a₋ₙ₊₁ . . . , a₋₁, a₀, a₁, aₙ₋₁ and/or a_{f,-m+1} . . . , a_{f,-1}, a_{f,0}, a_{f,1}, . . . , a_{f,m-1} in (53) can be configured from a candidate set of quantities. In another example, the quantities a₋ₙ₊₁ . . . , a₋₁, a₀, a₁, . . . , aₙ₋₁ and/or a_{f,-m+1} . . . , a_{f,-1}, a_{f,0}, a_{f,1}, . . . , a_{f,m-1} in (53) can be specified.

In a variation, the precoding matrix based on this disclosure has the following structure:

$$P = \frac{1}{γ} {W}_{1} {{W}_{2} ( {W}_{f} ⊗ {W}_{d} )}^{H} = \frac{1}{γ} [ \begin{matrix}{A}_{1} & 0 \\ 0 & {A}_{2}\end{matrix} ] C {A}_{f}^{H} ⊗ {W}_{d}^{H} \qquad ( 54 )$$

where γ is a normalization factor. In one example, W₁ is an SD basis for two antenna groups (e.g., two antenna polarizations of the P_{CSIRS} CSI-RS antenna ports). Here, A₁ and A₂ are associated with the two groups. In one example, A₁=A₂=A. In one example, A₁ can be different from A₂.

Likewise, for rank >1, for each layer k, in one embodiment, the precoding matrix based on this disclosure has the following structure:

$${P}^{k} = \frac{1}{{γ}_{k}} {W}_{1}^{( k )} {{W}_{2}^{( k )} ( {W}_{f}^{( k )} ⊗ {W}_{d}^{( k )} )}^{H} = \frac{1}{{γ}_{k}} {A}^{( k )} {C}^{( k )} {A}_{f}^{( k ) H} ⊗ {W}_{d}^{( k ) H} = \frac{1}{{γ}_{k}} [ \begin{matrix}{a}_{k , 0} & {a}_{k , - 1} & {a}_{k , - 2} & ⋯ & {a}_{k , - n + 1} \\ {a}_{k , 1} & {a}_{k , 0} & {a}_{k , - 1} & ⋱ & ⋮ \\ {a}_{k , 2} & {a}_{k , 1} & {a}_{k , 0} & ⋱ & {a}_{k , - 2} \\ ⋮ & ⋱ & ⋱ & ⋱ & {a}_{k , - 1} \\ {a}_{k , n - 1} & ⋯ & {a}_{k , 2} & {a}_{k , 1} & {a}_{k , 0}\end{matrix} ] * [ \begin{matrix}{c}_{k , 0 , 0} & {c}_{k , 0 , 1} & & {c}_{k , 0 , m p - 1} \\ ⋮ & ⋮ & ⋯ & ⋮ \\ {c}_{k , n - 1 , 0} & {c}_{k , n - 1 , 1} & & {c}_{k , n - 1 , m p - 1}\end{matrix} ] * {[ \begin{matrix}{a}_{f , k , 0} & {a}_{f , k , - 1} & {a}_{f , k , - 2} & ⋯ & {a}_{f , k , - m + 1} \\ {a}_{f , k , 1} & {a}_{f , k , 0} & {a}_{f , k , - 1} & ⋱ & ⋮ \\ {a}_{f , k , 2} & {a}_{f , k , 1} & {a}_{f , k , 0} & ⋱ & {a}_{f , k , - 2} \\ ⋮ & ⋱ & ⋱ & ⋱ & {a}_{f , k , - 1} \\ {a}_{f , k , m - 1} & ⋯ & {a}_{f , k , 2} & {a}_{f , k , 1} & {a}_{f , k , 0}\end{matrix} ]}^{H} ⊗ {W}_{d}^{( k ) H} \qquad ( 55 )$$

where γₖ is a normalization factor and W₄^{(k)} corresponds to a different basis from W₁^{(k)} and W_{f}^{(k)} (e.g. the DFT basis that is used to perform DD compression in the Rel. 18 Type II codebook refinement for high/medium velocities). In one example, W₁^{(k)} is an SD basis (e.g., across P_{CSIRS} CSI-RS antenna ports) and W_{f}^{(k)} is an FD basis. The quantities a_{k,-n+1} . . . , a_{k,-1}, a_{k,0}, a_{k,1}, . . . , a_{k,n-1} and/or a_{f,k,-n+1} . . . , a_{f,k,-1}, a_{f,k,0}, a_{f,k,1}, . . . , a_{f,k,m-1} in (55) can be configured to be determined by training an AI/ML model architecture. In another example, the quantities a_{k,-n+1} . . . a_{k,-1}, a_{k,0}, a_{k,1}, . . . , a_{k,n-1} and/or a_{f,k,-m+1} . . . , a_{f,k,-1}, a_{f,k,0}, a_{f,k,1}, . . . , a_{f,k,m-1} in (55) can be configured from a candidate set of quantities. In another example, the quantities a_{k,-n+1} . . . , a_{k,-1}, a_{k,0}, a_{k,1}, . . . , a_{k,n-1} and/or a_{f,k,-m+1} . . . , a_{f,k,-1}, a_{f,k,0}, a_{f,k,1}, . . . , a_{f,k,m-1} in (55) can be specified.

In one example, W₁^{(k)} can be the same for each layer k. In another example, W₁^{(k)} can be determined on a per-layer basis. In one example, W₂^{(k)} can be the same for each layer k. In another example, W₂^{(k)} can be determined on a per-layer basis. In one example, W_{f}^{(k)} can be the same for each layer k. In another example, W_{f}^{(k)} can be determined on a per-layer basis. In one example, W_{d}^{(k)} can be the same for each layer k. In another example, W_{f}^{(k)} can be determined on a per-layer basis. Each combination of these examples can also be supported.

In a variation, for rank >1, for each layer k, the precoding matrix based on this disclosure has the following structure:

$${P}^{k} = \frac{1}{{γ}_{k}} {W}_{1}^{( k )} {{W}_{2}^{( k )} ( {W}_{f}^{( k )} ⊗ {W}_{d}^{( k )} )}^{H} = \frac{1}{{γ}_{k}} [ \begin{matrix}{A}_{k , 1} & 0 \\ 0 & {A}_{k , 2}\end{matrix} ] {C}^{( k )} {A}_{f}^{( k ) H} ⊗ {W}_{d}^{( k ) H} \qquad ( 56 )$$

where γₖ is a normalization factor. In one example, W₁^{(k)} is an SD basis for two antenna groups (e.g. two antenna polarizations of the P_{CSIRS} CSI-RS antenna ports), W_{f}^{(k)} is an FD basis, and W_{d}^{(k)} is a DD/TD basis. Here, A_{k,1} and A_{k,2} are associated with the two groups. In one example, A_{k,1}=A_{k,2}=Aₖ. In one example, A_{k,1} can be different from A_{k,2}.

In one embodiment, for the space, frequency, and temporal domains, the precoding matrix based on this disclosure has the following structure:

$$P = \frac{1}{γ} {W}_{1} {{W}_{2} ( {W}_{f} ⊗ {W}_{d} )}^{H} = \frac{1}{γ} {W}_{1} {CW}_{f}^{H} ⊗ {A}_{d}^{H} = \frac{1}{γ} {W}_{1} * [ \begin{matrix}{c}_{0 , 0} & {c}_{0 , 1} & & {c}_{0 , m p - 1} \\ ⋮ & ⋮ & ⋯ & ⋮ \\ {c}_{n - 1 , 0} & {c}_{n - 1 , 1} & & {c}_{n - 1 , m p - 1}\end{matrix} ] * {W}_{f}^{H} ⊗ {[ \begin{matrix}{a}_{d , 0} & {a}_{d , - 1} & {a}_{d , - 2} & ⋯ & {a}_{d , - p + 1} \\ {a}_{d , 1} & {a}_{d , 0} & {a}_{d , - 1} & ⋱ & ⋮ \\ {a}_{d , 2} & {a}_{d , 1} & {a}_{d , 0} & ⋱ & {a}_{d , - 2} \\ ⋮ & ⋱ & ⋱ & ⋱ & {a}_{d , - 1} \\ {a}_{d , p - 1} & ⋯ & {a}_{d , 2} & {a}_{f , 1} & {a}_{d , 0}\end{matrix} ]}^{H} \qquad ( 57 )$$

where γ is a normalization factor and W₁ and W_{f} correspond to different bases from W_{d} (e.g., the DFT basis that is used to perform SD and FD compression in the Rel. 16 eType II codebook). In one example, W_{d} is a DD/TD basis. The quantities a_{d,-p+1} . . . , a_{d,-1}, a_{d,0}, a_{d,1}, . . . , a_{d,p-1} in (57) can be configured to be determined by training an AI/ML model architecture. In another example, the quantities a_{d,-p+1} . . . , a_{d,-1}, a_{d,0}, a_{d,1}, . . . , a_{d,p-1} in (57) can be configured from a candidate set of quantities. In another example, the quantities a_{d,-p+1} . . . , a_{d,-1}, a_{d,0}, a_{d,1}, . . . , a_{d,p-1} in (57) can be specified.

Likewise, for rank >1, for each layer k, in one embodiment, the precoding matrix based on this disclosure has the following structure:

$${P}^{k} = \frac{1}{{γ}_{k}} {W}_{1}^{( k )} {{W}_{2}^{( k )} ( {W}_{f}^{( k )} ⊗ {W}_{d}^{( k )} )}^{H} = \frac{1}{{γ}_{k}} {W}_{1}^{( k )} {C}^{( k )} {W}_{f}^{( k ) H} ⊗ {A}_{d}^{( k ) H} = \frac{1}{{γ}_{k}} {W}_{1}^{( k )} * [ \begin{matrix}{c}_{k , 0 , 0} & {c}_{k , 0 , 1} & & {c}_{k , 0 , m p - 1} \\ ⋮ & ⋮ & ⋯ & ⋮ \\ {c}_{k , n - 1 , 0} & {c}_{k , n - 1 , 1} & & {c}_{k , n - 1 , m p - 1}\end{matrix} ] * {W}_{f}^{( k ) H} ⊗ {[ \begin{matrix}{a}_{d , k , 0} & {a}_{d , k , - 1} & {a}_{d , k , - 2} & ⋯ & {a}_{d , k , - p + 1} \\ {a}_{d , k , 1} & {a}_{d , k , 0} & {a}_{d , k , - 1} & ⋱ & ⋮ \\ {a}_{d , k , 2} & {a}_{d , k , 1} & {a}_{d , k , 0} & ⋱ & {a}_{d , k , - 2} \\ ⋮ & ⋱ & ⋱ & ⋱ & {a}_{d , k , - 1} \\ {a}_{d , k , p - 1} & ⋯ & {a}_{d , k , 2} & {a}_{d , k , 1} & {a}_{d , k , 0}\end{matrix} ]}^{H} \qquad ( 58 )$$

where γₖ is a normalization factor and W₁^{(k)} and W_{f}^{(k)} correspond to different bases from W_{d}^{(k)} (e.g. the DFT basis that is used to perform SD and FD compression in the Rel. 16 eType II codebook). In one example, W_{d}^{(k)} is a DD/TD basis. The quantities a_{d,k,-p+1} . . . , a_{d,k,-1}, a_{d,k,0}, a_{d,k,1}, . . . , a_{d,k,p-1} in (58) can be configured to be determined by training an AI/ML model architecture. In another example, the quantities a_{d,k,-p+1} . . . , a_{d,k,-1}, a_{d,k,0}, a_{d,k,1}, . . . , a_{d,k,p-1} in (58) can be configured from a candidate set of quantities. In another example, the quantities a_{d,k,-p+1} . . . , a_{d,k,-1}, a_{d,k,0}, a_{d,k,1}, . . . , a_{d,k,p-1} in (58) can be specified.

In one example, W₁^{(k)} can be the same for each layer k. In another example, W₁^{(k)} can be determined on a per-layer basis. In one example, W₂^{(k)} can be the same for each layer k. In another example, W₂^{(k)} can be determined on a per-layer basis. In one example, W_{f}^{(k)} can be the same for each layer k. In another example, W_{f}^{(k)} can be determined on a per-layer basis. In one example, W_{d}^{(k)} can be the same for each layer k. In another example, W_{d}^{(k)} can be determined on a per-layer basis. Each combination of these examples can also be supported.

In one embodiment, for the space, frequency, and temporal domains, the precoding matrix based on this disclosure has the following structure:

$$P = \frac{1}{γ} {W}_{1} {{W}_{2} ( {W}_{f} ⊗ {W}_{d} )}^{H} = \frac{1}{γ} {W}_{1} {CA}_{f}^{H} ⊗ {W}_{d}^{H} = \frac{1}{γ} {W}_{1} * [ \begin{matrix}{c}_{0 , 0} & {c}_{0 , 1} & & {c}_{0 , m p - 1} \\ ⋮ & ⋮ & ⋯ & ⋮ \\ {c}_{n - 1 , 0} & {c}_{n - 1 , 1} & & {c}_{n - 1 , m p - 1}\end{matrix} ] * {[ \begin{matrix}{a}_{f , 0} & {a}_{f , - 1} & {a}_{f , - 2} & ⋯ & {a}_{f , - m + 1} \\ {a}_{f , 1} & {a}_{f , 0} & {a}_{f , - 1} & ⋱ & ⋮ \\ {a}_{f , 2} & {a}_{f , 1} & {a}_{f , 0} & ⋱ & {a}_{f , - 2} \\ ⋮ & ⋱ & ⋱ & ⋱ & {a}_{f , - 1} \\ {a}_{f , m - 1} & ⋯ & {a}_{f , 2} & {a}_{f , 1} & {a}_{f , 0}\end{matrix} ]}^{H} ⊗ {W}_{d}^{H} \qquad ( 59 )$$

where γ is a normalization factor and W₁ and W_{d} correspond to different bases from W_{f} (e.g. the DFT basis that is used to perform SD compression in the Rel. 16 eType II codebook and DD compression in the Rel. 18 Type II codebook refinement for high/medium velocities, respectively). In one example, W_{f} is an FD basis. The quantities a_{f,-m+1} . . . , a_{f,-1}, a_{f,0}, a_{f,1}, . . . , a_{f,m-1} in (59) can be configured to be determined by training an AI/ML model architecture. In another example, the quantities a_{f,-m+1} . . . , a_{f,-1}, a_{f,0}, a_{f,1}, . . . , a_{f,m-1} in (59) can be configured from a candidate set of quantities. In another example, the quantities a_{f,-m+1} . . . , a_{f,-1}, a_{f,0}, a_{f,1}, . . . , a_{f,m-1} in (59) can be specified.

In a variation, the two matrices W₁ and W_{d} in (59) can be replaced by one matrix W_{s,d}, which can correspond to a basis for joint SD-DD/TD compression; this basis can differ from W_{f}.

Likewise, for rank >1, for each layer k, in one embodiment, the precoding matrix based on this disclosure has the following structure:

$${P}^{k} = \frac{1}{{γ}_{k}} {W}_{1}^{( k )} {{W}_{2}^{( k )} ( {W}_{f}^{( k )} ⊗ {W}_{d}^{( k )} )}^{H} = \frac{1}{{γ}_{k}} {W}_{1}^{( k )} {C}^{( k )} {A}_{f}^{( k ) H} ⊗ {W}_{d}^{( k ) H} = \frac{1}{{γ}_{k}} {W}_{1}^{( k )} * [ \begin{matrix}{c}_{k , 0 , 0} & {c}_{k , 0 , 1} & & {c}_{k , 0 , m p - 1} \\ ⋮ & ⋮ & ⋯ & ⋮ \\ {c}_{k , n - 1 , 0} & {c}_{k , n - 1 , 1} & & {c}_{k , n - 1 , m p - 1}\end{matrix} ] * {[ \begin{matrix}{a}_{f , k , 0} & {a}_{f , k , - 1} & {a}_{f , k , - 2} & ⋯ & {a}_{f , k , - m + 1} \\ {a}_{f , k , 1} & {a}_{f , k , 0} & {a}_{f , k , - 1} & ⋱ & ⋮ \\ {a}_{f , k , 2} & {a}_{f , k , 1} & {a}_{f , k , 0} & ⋱ & {a}_{f , k , - 2} \\ ⋮ & ⋱ & ⋱ & ⋱ & {a}_{f , k , - 1} \\ {a}_{f , k , m - 1} & ⋯ & {a}_{f , k , 2} & {a}_{f , k , 1} & {a}_{f , k , 0}\end{matrix} ]}^{H} ⊗ {W}_{d}^{( k ) H} \qquad ( 60 )$$

where γₖ is a normalization factor and W₁^{(k)} and W_{d}^{(k)} correspond to different bases from W_{f}^{(k)} (e.g. the DFT basis that is used to perform SD compression in the Rel. 16 eType II codebook and DD compression in the Rel. 18 Type II codebook refinement for high/medium velocities, respectively). In one example, W_{f}^{(k)} is an FD basis. The quantities a_{f,k,-m+1} . . . , a_{f,k,-1}, a_{f,k,0}, a_{f,k,1}, . . . , a_{f,k,m-1} in (60) can be configured to be determined by training an AI/ML model architecture. In another example, the quantities a_{f,k,-m+1} . . . , a_{f,k,-1}, a_{f,k,0}, a_{f,k,1}, . . . , a_{f,k,m-1} in (60) can be configured from a candidate set of quantities. In another example, the quantities a_{f,k,-m+1} . . . , a_{f,k,-1}, a_{f,k,0}, a_{f,k,1}, . . . , a_{f,k,m-1} in (60) can be specified.

In one example, W₁^{(k)} can be the same for each layer k. In another example, W_{f}^{(k)} can be determined on a per-layer basis. In one example, W₂^{(k)} can be the same for each layer k. In another example, W₂^{(k)} can be determined on a per-layer basis. In one example, W₁^{(k)} can be the same for each layer k. In another example, W_{f}^{(k)} can be determined on a per-layer basis. In one example, W_{d}^{(k)} can be the same for each layer k. In another example, W_{d}^{(k)} can be determined on a per-layer basis. Each combination of these examples can also be supported.

In a variation, the two matrices W₁^{(k)} and W_{d}^{(k)} in (60) can be replaced by one matrix W_{s,d}^{(k)}, which can correspond to a basis for joint SD-DD/TD compression; this basis can differ from W_{f}^{(k)}.

In one embodiment, for the space, frequency, and temporal domains, the precoding matrix based on this disclosure has the following structure:

$$P = \frac{1}{γ} {W}_{1} {{W}_{2} ( {W}_{f} ⊗ {W}_{d} )}^{H} = \frac{1}{γ} {ACW}_{f}^{H} ⊗ {W}_{d}^{H} = \frac{1}{γ} [ \begin{matrix}{a}_{0} & {a}_{- 1} & {a}_{- 2} & ⋯ & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & ⋯ & {a}_{2} & {a}_{1} & {a}_{0}\end{matrix} ] * [ \begin{matrix}{c}_{0 , 0} & {c}_{0 , 1} & & {c}_{0 , m p - 1} \\ ⋮ & ⋮ & ⋯ & ⋮ \\ {c}_{n - 1 , 0} & {c}_{n - 1 , 1} & & {c}_{n - 1 , m p - 1}\end{matrix} ] * {W}_{f}^{H} ⊗ {W}_{d}^{H} \qquad ( 61 )$$

where γ is a normalization factor and W_{f} and W_{d} correspond to different bases from W₁ (e.g. the DFT basis that is used to perform FD compression in the Rel. 16 eType II codebook and DD compression in the Rel. 18 Type II codebook refinement for high/medium velocities, respectively). In one example, W₁ is an SD basis (e.g., across P_{CSIRS} CSI-RS antenna ports). The quantities a₋ₙ₊₁ . . . , a₋₁, a₀, a₁, . . . , aₙ₋₁ in (61) can be configured to be determined by training an AI/ML model architecture. In another example, the quantities a₋ₙ₊₁ . . . , a₋₁, a₀, a₁, . . . , aₙ₋₁ in (61) can be configured from a candidate set of quantities. In another example, the quantities a₋ₙ₊₁ . . . , a₋₁, a₀, a₁, . . . , aₙ₋₁ in (61) can be specified.

In a variation, the precoding matrix based on this disclosure has the following structure:

$$P = \frac{1}{γ} {W}_{1} {{W}_{2} ( {W}_{f} ⊗ {W}_{d} )}^{H} = \frac{1}{γ} [ \begin{matrix}{A}_{1} & 0 \\ 0 & {A}_{2}\end{matrix} ] C {W}_{f}^{H} ⊗ {W}_{d}^{H} \qquad ( 62 )$$

where γ is a normalization factor. In one example, W₁ is an SD basis for two antenna groups (e.g., two antenna polarizations of the P_{CSIRS} CSI-RS antenna ports). Here, A₁ and A₂ are associated with the two groups. In one example, A₁=A₂=A. In one example, A₁ can be different from A₂.

In a variation, the two matrices W_{f} and W_{d} in (61) can be replaced by one matrix W_{f,d}, which can correspond to a basis for joint FD-DD/TD compression; this basis can differ from W₁.

Likewise, for rank >1, for each layer k, in one embodiment, the precoding matrix based on this disclosure has the following structure:

$${P}^{k} = \frac{1}{{γ}_{k}} {W}_{1}^{( k )} {{W}_{2}^{( k )} ( {W}_{f}^{( k )} ⊗ {W}_{d}^{( k )} )}^{H} = \frac{1}{{γ}_{k}} {A}^{( k )} {C}^{( k )} {W}_{f}^{( k ) H} ⊗ {W}_{d}^{( k ) H} = \frac{1}{{γ}_{k}} [ \begin{matrix}{a}_{k , 0} & {a}_{k , - 1} & {a}_{k , - 2} & ⋯ & {a}_{k , - n + 1} \\ {a}_{k , 1} & {a}_{k , 0} & {a}_{k , - 1} & ⋱ & ⋮ \\ {a}_{k , 2} & {a}_{k , 1} & {a}_{k , 0} & ⋱ & {a}_{k , - 2} \\ ⋮ & ⋱ & ⋱ & ⋱ & {a}_{k , - 1} \\ {a}_{k , n - 1} & ⋯ & {a}_{k , 2} & {a}_{k , 1} & {a}_{k , 0}\end{matrix} ] * [ \begin{matrix}{c}_{k , 0 , 0} & {c}_{k , 0 , 1} & & {c}_{k , 0 , m p - 1} \\ ⋮ & ⋮ & ⋯ & ⋮ \\ {c}_{k , n - 1 , 0} & {c}_{k , n - 1 , 1} & & {c}_{k , n - 1 , m p - 1}\end{matrix} ] * {W}_{f}^{( k ) H} ⊗ {W}_{d}^{( k ) H} \qquad ( 63 )$$

where γₖ is a normalization factor and W_{f}^{(k)} and W_{d}^{(k)} correspond to different bases from W₁^{(k)} (e.g. the DFT basis that is used to perform FD compression in the Rel. 16 eType II codebook and DD compression in the Rel. 18 Type II codebook refinement for high/medium velocities, respectively). In one example, W₁^{(k)} is an SD basis (e.g., across P_{CSIRS} CSI-RS antenna ports). The quantities a_{k,-n+1} . . . , a_{k,-1}, a_{k,0}, a_{k,1}, . . . , a_{k,n-1} in (63) can be configured to be determined by training an AI/ML model architecture. In another example, the quantities a_{k,-n+1} . . . , a_{k,-1}, a_{k,0}, a_{k,1}, . . . , a_{k,n-1} in (63) can be configured from a candidate set of quantities. In another example, the quantities a_{k,-n+1} . . . , a_{k,-1}, a_{k,0}, a_{k,1}, . . . , a_{k,n-1} in (63) can be specified.

In one example, W₁^{(k)} can be the same for each layer k. In another example, W₁^{(k)} can be determined on a per-layer basis. In one example, W₂^{(k)} can be the same for each layer k. In another example, W₂^{(k)} can be determined on a per-layer basis. In one example, W₁^{(k)} can be the same for each layer k. In another example, W₂^{(k)} can be determined on a per-layer basis. In one example, W₂^{(k)} can be the same for each layer k. In another example, W_{f}^{(k)} can be determined on a per-layer basis. Each combination of these examples can also be supported.

In a variation, for rank >1, for each layer k, the precoding matrix based on this disclosure has the following structure:

$${P}^{k} = \frac{1}{{γ}_{k}} {W}_{1}^{( k )} {{W}_{2}^{( k )} ( {W}_{f}^{( k )} ⊗ {W}_{d}^{( k )} )}^{H} = \frac{1}{{γ}_{k}} [ \begin{matrix}{A}_{k , 1} & 0 \\ 0 & {A}_{k , 2}\end{matrix} ] {C}^{( k )} {W}_{f}^{( k ) H} ⊗ {W}_{d}^{( k ) H} \qquad ( 64 )$$

where γₖ is a normalization factor. In one example, W₁^{(k)} is an SD basis for two antenna groups (e.g., two antenna polarizations of the P_{CSIRS} CSI-RS antenna ports). Here, A_{k,1} and A_{k,2} are associated with the two groups. In one example, A_{k,1}=A_{k,2}=Aₖ. In one example, A_{k,1} can be different from A_{k,2}.

In a variation, the two matrices W_{f}^{(k)} and W_{d}^{(k)} in (43) can be replaced by one matrix W_{f,d}^{(k)} which can correspond to a basis for joint FD-DD/TD compression; this basis can differ from W₁^{(k)}.

In a variation, the quantities a₋ₙ₊₁ . . . , a₋₁, a₀, a₁, . . . , aₙ₋₁ in (27), (33), (37), (49), (53), and/or (61) can be selected from a DFT basis, i.e. each of these elements can have the form e^{j2πr/s}. In another variation, the quantities a_{f,-m+1} . . . , a_{f,-1}, a_{f,0}, a_{f,1}, . . . , a_{f,m-1} in (31), (33), (43), (47), (53), and/or (59) can be selected from a DFT basis, i.e. each of these elements can have the form e^{j2πr/s}. In another variation, the quantities a_{d,-n+1} . . . , a_{d,-1}, a_{d,0}, a_{d,1}, . . . , a_{d,n-1} in (25) and/or a_{d,-m+1} . . . , a_{d,-1}, a_{d,0}, a_{d,1}, . . . , a_{d,m-1} in (27) and (41) and/or a_{d,-p+1} . . . , a_{d,-1}, a_{d,0}, a_{d,1}, . . . , a_{d,p-1} in (31), (33), (45), (47), (49), and/or (57) can be selected from a DFT basis, i.e. each of these elements can have the form e^{j2πr/s}.

Likewise, for rank >1, for each layer k, the quantities a_{k,-n+1} . . . , a_{k,-1}, a_{k,0}, a_{k,1}, a_{k,n-1} in (29), (35), (39), (51), (55), and/or (63) can be selected from a DFT basis, i.e. each of these elements can have the form e^{j2πr/s}. In another variation, the quantities a_{f,k,-m+1} . . . , a_{f,k,-1}, a_{f,k,0}, a_{f,k,1}, . . . , a_{f,k,m-1} in (32), (35), (44), (48), (55), and/or (60) can be selected from a DFT basis, i.e. each of these elements can have the form e^{j2πr/s}. In another variation, the quantities a_{d,k,-n+1} . . . , a_{d,k,-1}, a_{d,k,0}, a_{d,k,1}, . . . , a_{d,k,n-1} in (26) and/or a_{d,k,-m+1} . . . , a_{d,k,-1}, a_{d,k,0}, a_{d,k,1}, . . . , a_{d,k,m-1} in (29) and (42) and/or a_{d,k,-p+1} . . . , a_{d,k,-1}, a_{d,k,0}, a_{d,k,1}, . . . , a_{d,k,p-1} in (32), (35), (46), (48), (51), and/or (58) can be selected from a DFT basis, i.e. each of these elements can have the form e^{j2πr/s}.

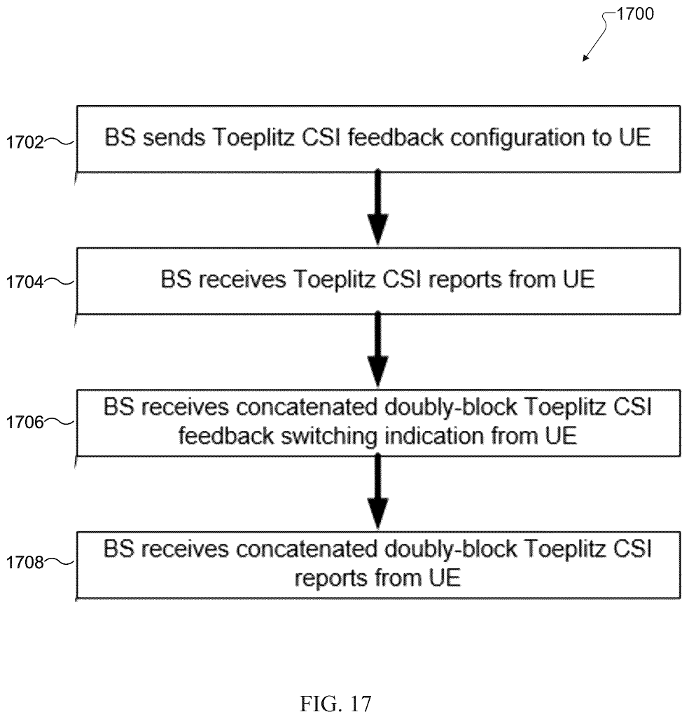

FIG. 17 illustrates a flowchart of an example BS procedure 1700 to support UE-initiated switch to concatenated doubly-block Toeplitz CSI feedback/report method according to embodiments of the present disclosure. For example, procedure 1700 to support UE-initiated switch to concatenated doubly-block Toeplitz CSI feedback/report method can be performed by the BS 102 of FIG. 1 and a corresponding procedure may be performed by any of the UEs 111-116 of FIG. 1. This example is for illustration only and other embodiments can be used without departing from the scope of the present disclosure.

The procedure begins in 1702, a BS sends a feedback configuration message for a CSI feedback/report method that utilizes a Toeplitz matrix to a UE. In 1704, a BS receives a CSI report from a UE that has been generated based on a feedback/report method that utilizes a Toeplitz matrix. In 1706, a BS receives a message from a UE that indicates a switch to a CSI feedback/report method that utilizes a concatenation of doubly-block Toeplitz matrices. In one example, a dedicated/new MAC CE can be used for this message, or an existing MAC CE can be used for this message. In another example, this message can be sent on the PUCCH or the PUSCH, where a new UCI format can be defined for this message, or an existing UCI format can be used for this message. If an existing UCI format is used for this message, this indication can be included as a part of UCI and therefore reported together with CSI feedback as, e.g., a 1-bit indication in a CSI report. In 1708, a BS receives a CSI report from a UE that has been generated based on a feedback/report method that utilizes a concatenation of doubly-block Toeplitz matrices.

In another example, a BS can pre-determine/configure information about the switching time to a CSI feedback/report method that utilizes a concatenation of doubly-block Toeplitz matrices. In this case, 1708 does not need to be performed; a BS can receive CSI reports from a UE that have been generated based on a feedback/report method that utilizes a concatenation of doubly-block Toeplitz matrices at a pre-determined/configured time in 1708.

In another example, between 1706 and 1708, a BS can perform 1707. In 1707, a BS can send an ACK/NACK to a UE in response to a received message from a UE that indicates a switch to a CSI feedback/report method that utilizes a concatenation of doubly-block Toeplitz matrices. If a BS sends an ACK, then a UE switches to a CSI feedback/report method that utilizes a concatenation of doubly-block Toeplitz matrices; a BS receives CSI reports from a UE that have been generated based on a feedback/report method that utilizes a concatenation of doubly-block Toeplitz matrices in 1708. If a BS sends a NACK, then a BS receives CSI reports from a UE that have been generated based on a feedback/report method that utilizes a Toeplitz matrix in 1708. In 1707, in another example, a BS can send a configuration message for a CSI feedback/report method that utilizes a concatenation of doubly-block Toeplitz matrices to a UE.

In another example, a BS can enable/disable 1706, 1707, and 1708, e.g., via RRC configuration. If these are disabled, then a BS continues receiving CSI reports from a UE that have been generated based on a feedback/report method that utilizes a Toeplitz matrix in 1704.

In another example, a CSI feedback/report method that utilizes a Toeplitz matrix can be replaced by a traditional CSI feedback/report method in the preceding examples. In one example, this traditional CSI feedback/report method can correspond to the CSI feedback based on the Type I codebook or the Type II codebook.

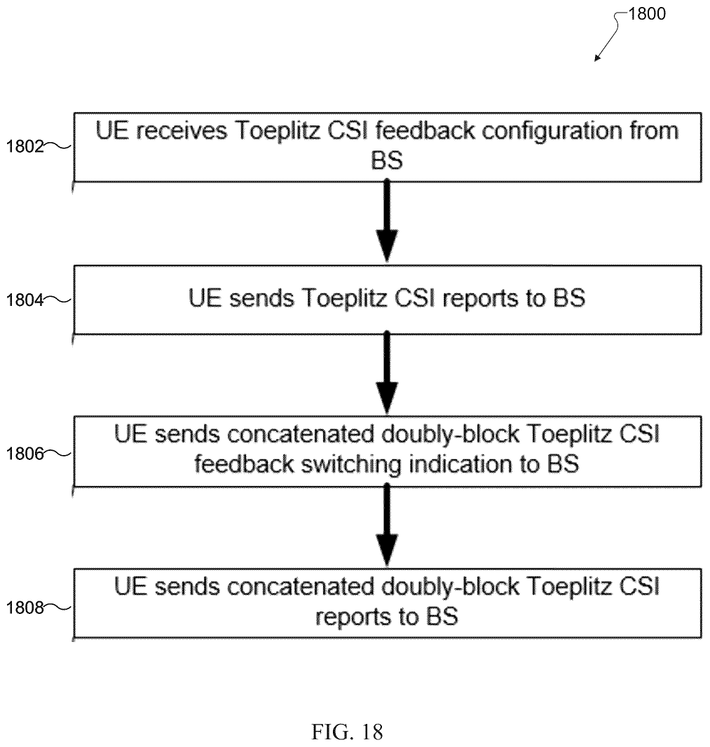

FIG. 18 illustrates a flowchart of an example UE procedure 1800 to support UE-initiated switch to concatenated doubly-block CSI feedback/report method according to embodiments of the present disclosure. For example, procedure 1800 to support UE-initiated switch to concatenated doubly-block CSI feedback/report method can be performed by the UE 116 of FIG. 3. This example is for illustration only and other embodiments can be used without departing from the scope of the present disclosure.

The procedure begins in 1802, a UE receives a feedback configuration message for a CSI feedback/report method that utilizes a Toeplitz matrix from a BS. In 1804, a UE sends CSI reports to a BS that have been generated based on a feedback/report method that utilizes a Toeplitz matrix. In 1806, a UE sends a message to a BS that indicates a switch to a CSI feedback/report method that utilizes a concatenation of doubly-block Toeplitz matrices. In one example, a dedicated/new MAC CE can be used for this message, or an existing MAC CE can be used for this message. In another example, this message can be sent on the PUCCH or the PUSCH, where a new UCI format can be defined for this message, or an existing UCI format can be used for this message. If an existing UCI format is used for this message, this indication can be included as a part of UCI and therefore reported together with CSI feedback, e.g., a 1-bit indication in a CSI report. In 1808, a UE sends CSI reports to a BS that have been generated based on a feedback/report method that utilizes a concatenation of doubly-block Toeplitz matrices.

In another example, a BS can pre-determine/configure information about the switching time to a CSI feedback/report method that utilizes a concatenation of doubly-block Toeplitz matrices. In this case, 1808 does not need to be performed; a UE can send CSI reports to a BS that have been generated based on a feedback/report method that utilizes a concatenation of doubly-block Toeplitz matrices at a pre-determined/configured time in 1808.

In another example, between 1806 and 1808, a UE can perform 1807. In 1807, a UE can receive an ACK/NACK from a BS in response to a received message from a UE that indicates a switch to a CSI feedback/report method that utilizes a concatenation of doubly-block Toeplitz matrices. If a UE receives an ACK, then a UE switches to a CSI feedback/report method that utilizes a concatenation of doubly-block Toeplitz matrices; a UE sends CSI reports to a BS that have been generated based on a feedback/report method that utilizes a concatenation of doubly-block Toeplitz matrices in 1808. If a UE receives a NACK, then a UE sends CSI reports to a BS that have been generated based on a feedback/report method that utilizes a Toeplitz matrix in 1808. In 1807, in another example, a UE can receive a configuration message for a CSI feedback/report method that utilizes a concatenation of doubly-block Toeplitz matrices from a BS.

In another example, a BS can enable/disable 1806, 1807, and 1808, e.g., via RRC configuration. If these are disabled, then a UE continues sending CSI reports to a BS that have been generated based on a feedback/report method that utilizes a Toeplitz matrix in 1804.

In another example, a CSI feedback/report method that utilizes a Toeplitz matrix can be replaced by a traditional CSI feedback/report method in the preceding examples. In one example, this traditional CSI feedback/report method can correspond to the CSI feedback based on the Type I codebook or the Type II codebook.

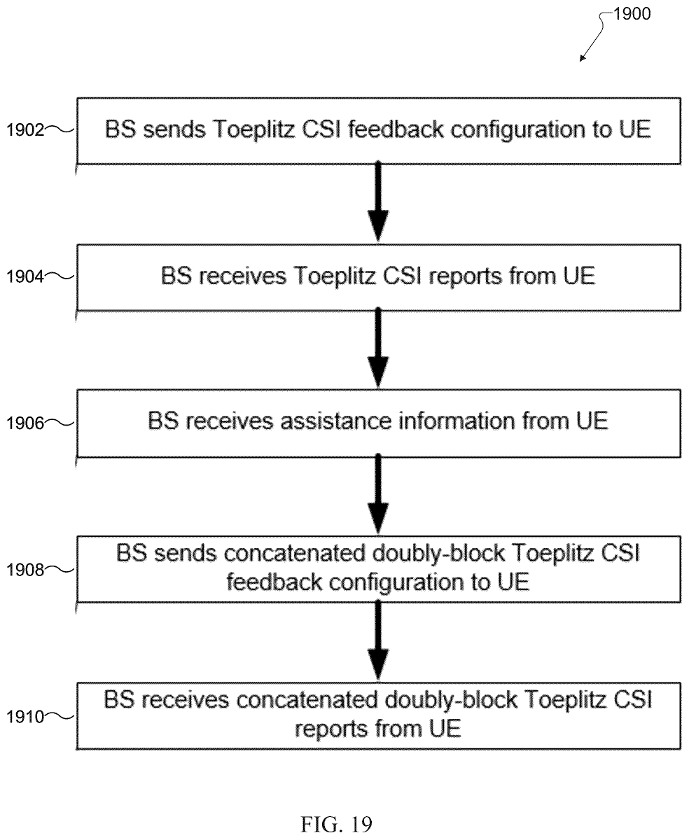

FIG. 19 illustrates a flowchart of an example BS procedure 1900 to support BS-initiated switch to concatenated doubly-block Toeplitz CSI feedback/report method according to embodiments of the present disclosure. For example, procedure 1900 to support BS-initiated switch to concatenated doubly-block Toeplitz CSI feedback/report method can be performed by the BS 102 of FIG. 1. This example is for illustration only and other embodiments can be used without departing from the scope of the present disclosure.

The procedure begins in 1902, a BS sends a feedback configuration message for a CSI feedback/report method that utilizes a Toeplitz matrix to a UE. In 1904, a BS receives a CSI report from a UE that has been generated based on a feedback/report method that utilizes a Toeplitz matrix. In 1906, a BS receives assistance information from a UE; the assistance information can include a recommendation for switching to a CSI feedback/report method that utilizes a concatenation of doubly-block Toeplitz matrices. In 1908, a BS sends a feedback configuration message for a CSI feedback/report method that utilizes a concatenation of doubly-block Toeplitz matrices to a UE. In 1910, a BS receives a CSI report from a UE that has been generated based on a feedback/report method that utilizes a concatenation of doubly-block Toeplitz matrices.

In another example, a CSI feedback/report method that utilizes a Toeplitz matrix can be replaced by a traditional CSI feedback/report method in the preceding examples. In one example, this traditional CSI feedback/report method can correspond to the CSI feedback based on the Type I codebook or the Type II codebook.

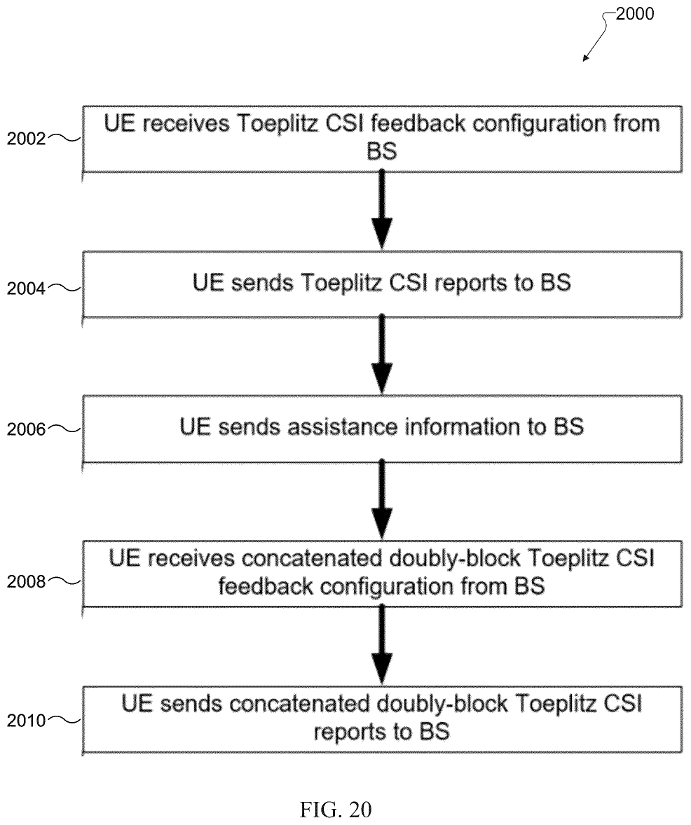

FIG. 20 illustrates a flowchart of an example UE procedure 2000 to support BS-initiated switch to concatenated doubly-block Toeplitz CSI feedback/report method according to embodiments of the present disclosure. For example, procedure 2000 to support BS-initiated switch to concatenated doubly-block Toeplitz CSI feedback/report method can be performed by the UE 116 of FIG. 3 and a corresponding procedure can be performed by the BS 102 of FIG. 1. This example is for illustration only and other embodiments can be used without departing from the scope of the present disclosure.

The procedure begins in 2002, a UE receives a feedback configuration message for a CSI feedback/report method that utilizes a Toeplitz matrix from a BS. In 2004, a UE sends a CSI report to a BS that has been generated based on a feedback/report method that utilizes a Toeplitz matrix. In 2006, a UE sends assistance information to a BS; the assistance information can include a recommendation for switching to a CSI feedback/report method that utilizes a concatenation of doubly-block Toeplitz matrices. In 2008, a UE receives a feedback configuration message for a CSI feedback/report method that utilizes a concatenation of doubly-block Toeplitz matrices from a BS. In 2010, a UE sends a CSI report to a BS that has been generated based on a feedback/report method that utilizes a concatenation of doubly-block Toeplitz matrices.

In another example, a CSI feedback/report method that utilizes a Toeplitz matrix can be replaced by a traditional CSI feedback/report method in the preceding examples. In one example, this traditional CSI feedback/report method can correspond to the CSI feedback based on the Type I codebook or the Type II codebook.

In one embodiment, a BS can configure a UE to send an indication of switching to a CSI feedback/report method that utilizes a concatenation of doubly-block Toeplitz matrices via RRC configuration. Table 6 is an example of modifying an IE PUSCH-Config to configure a UE to send this switching indication. In this example, concatDoublyBlockToeplitzCBSwitch, if present, corresponds to this switching indication. In another example, an IE PUCCH-Config can be modified to configure a UE to send this switching indication.

TABLE 6
PUSCH-Config ::= SEQUENCE {
...
concatDoublyBlockToeplitzCBSwitch BOOLEAN OPTIONAL, -- Need
M
...
}

In one embodiment, a BS can configure a UE to send an indication of switching to a CSI feedback/report method that utilizes a concatenation of doubly-block Toeplitz matrices via MAC CE activation command.

In one embodiment, a BS can configure a UE to send an indication of switching to a CSI feedback/report method that utilizes a concatenation of doubly-block Toeplitz matrices via DCI.

In another embodiment, a BS can configure a UE to send an indication of switching to a CSI feedback/report method that utilizes a concatenation of doubly-block circulant matrices.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
transmit capability information indicating a capability of the UE to support a Toeplitz-based method of determining channel state information (CSI) reports,
receive configuration information that indicates parameters for the Toeplitz-based method of determining the CSI reports, and
receive CSI reference signals (RSs); and
a processor operably coupled to the transceiver, the processor configured to:
measure the CSI-RSs, and
determine, based on the configuration information and the measured CSI-RSs, a CSI report,
wherein the transceiver is configured to transmit the CSI report.

2. The UE of claim 1, wherein:
the configuration information includes one or more domains for determining the CSI report,
the one or more domains include spatial, frequency, or time domains,
the configuration information includes an indication of the one or more domains to be used to determine the CSI report, and
the processor is further configured to determine the CSI report based on the Toeplitz-based method for the one or more indicated domains.

3. The UE of claim 2, wherein:
the configuration information includes an indication of a joint basis for the Toeplitz-based method of determining the CSI report,
the joint basis for the Toeplitz-based method corresponds to the one or more indicated domains, and
the processor is further configured to determine the CSI report based on the joint basis for the Toeplitz-based method corresponding to the one or more indicated domains.

4. The UE of claim 1, wherein:
the parameters include at least one of (i) batch normalization coefficients and (ii) parameters for nonlinear operations;
when the parameters include the batch normalization coefficients, the processor is further configured to:
apply the Toeplitz-based method to basis vectors, and
apply the batch normalization coefficients to an output of the Toeplitz-based method to determine the CSI report; and
when the parameters include the parameters for nonlinear operations, the processor is further configured to:
apply the Toeplitz-based method to the basis vectors, and
apply the parameters for nonlinear operations to an output of the Toeplitz-based method to determine the CSI report.

5. The UE of claim 1, wherein:
the processor is further configured to identify assistance information;
the transceiver is further configured to transmit, based on the assistance information, a request to use the Toeplitz-based method for determining the CSI report; and
the assistance information comprises at least one of a block error rate, a throughput, an estimated coherence time, and an estimated coherence bandwidth.

6. The UE of claim 1, wherein:
the configuration information includes an indication to use the Toeplitz-based method for one or more layers for multi-rank transmission; and
the processor is further configured to:
determine the Toeplitz-based method for each of the one or more layers, and
determine, based on the Toeplitz-based method for each of the one or more layers, the CSI report.

7. The UE of claim 1, wherein:
the parameters include (i) an instruction to apply a machine learning (ML) based method for determining the Toeplitz-based method for determining the CSI report and (ii) assistance information for application of the ML based method, and
the processor is further configured to:
determine, based on the assistance information, the ML based method, and
determine, based on the ML based method, the Toeplitz-based method for determining the CSI report.

8. A base station (BS), comprising:
a processor; and
a transceiver operably coupled to the processor, the transceiver configured to:
receive capability information indicating a capability of a user equipment (UE) to support a Toeplitz-based method of determining channel state information (CSI) reports,
transmit configuration information that indicates parameters for the Toeplitz-based method of determining the CSI reports,
transmit CSI reference signals (RSs), and
receive the CSI report that is based on the configuration information and the CSI-RSs.

9. The BS of claim 8, wherein:
the configuration information includes one or more domains for determining the CSI report,
the one or more domains include spatial, frequency, or time domains,
the configuration information includes an indication of the one or more domains to be used to determine the CSI report, and
the CSI report is further based on the Toeplitz-based method for the one or more indicated domains.

10. The BS of claim 9, wherein:
the configuration information includes an indication of a joint basis for the Toeplitz-based method of determining the CSI report,
the joint basis for the Toeplitz-based method corresponds to the one or more indicated domains, and
the CSI report is further based on the joint basis for the Toeplitz-based method corresponding to the one or more indicated domains.

11. The BS of claim 8, wherein:
the parameters include at least one of (i) batch normalization coefficients and (ii) parameters for nonlinear operations;
when the parameters include the batch normalization coefficients:
the Toeplitz-based method is applied to basis vectors, and
the batch normalization coefficients are applied to an output of the Toeplitz-based method to determine the CSI report; and
when the parameters include the parameters for nonlinear operations:
the Toeplitz-based method is applied to the basis vectors, and
the parameters for nonlinear operations are applied to an output of the Toeplitz-based method to determine the CSI report.

12. The BS of claim 8, wherein:
the transceiver is further configured to receive a request to use the Toeplitz-based method for determining the CSI report;
the request is based on assistance information; and
the assistance information comprises at least one of a block error rate, a throughput, an estimated coherence time, and an estimated coherence bandwidth.

13. The BS of claim 8, wherein:
the configuration information includes an indication to use the Toeplitz-based method for one or more layers for multi-rank transmission; and
the CSI report is further based on the Toeplitz-based method for each of the one or more layers.

14. The BS of claim 8, wherein:
the parameters include (i) an instruction to apply a machine learning (ML) based method for determining the Toeplitz-based method for determining the CSI report and (ii) assistance information for application of the ML based method, and
the CSI report is further based on the Toeplitz-based method for determining the CSI report, which is based on the ML based method for determining the Toeplitz-based method for determining the CSI report and the assistance information for application of the ML based method.

15. A method performed by a user equipment (UE), the method comprising:
transmitting capability information indicating a capability of the UE to support a Toeplitz-based method of determining channel state information (CSI) reports;
receiving configuration information that indicates parameters for the Toeplitz-based method of determining the CSI reports;
receiving CSI reference signals (RSs);
measuring the CSI-RSs;
determining, based on the configuration information and the measured CSI-RSs, a CSI report; and
transmitting the CSI report.

16. The method of claim 15, wherein:
the configuration information includes one or more domains for determining the CSI report,
the one or more domains include spatial, frequency, or time domains,
the configuration information includes an indication of the one or more domains to be used to determine the CSI report, and
determining the CSI report further comprises determining the CSI report based on the Toeplitz-based method for the one or more indicated domains.

17. The method of claim 9, wherein:
the configuration information includes an indication of a joint basis for the Toeplitz-based method of determining the CSI report,
the joint basis for the Toeplitz-based method corresponds to the one or more indicated domains, and
determining the CSI report further comprises determining the CSI report based on the joint basis for the Toeplitz-based method corresponding to the one or more indicated domains.

18. The method of claim 15, wherein:
the parameters include at least one of (i) batch normalization coefficients and (ii) parameters for nonlinear operations;
when the parameters include the batch normalization coefficients, the method further comprises:
applying the Toeplitz-based method to basis vectors, and
applying the batch normalization coefficients to an output of the Toeplitz-based method to determine the CSI report; and
when the parameters include the parameters for nonlinear operations, the method further comprises:
applying the Toeplitz-based method to the basis vectors, and
applying the parameters for nonlinear operations to an output of the Toeplitz-based method to determine the CSI report.

19. The method of claim 15, further comprising:
identifying assistance information; and
transmitting, based on the assistance information, a request to use the Toeplitz-based method for determining the CSI report,
wherein the assistance information comprises at least one of a block error rate, a throughput, an estimated coherence time, and an estimated coherence bandwidth.

20. The method of claim 15, wherein:
the configuration information includes an indication to use the Toeplitz-based method for one or more layers for multi-rank transmission;
the method further comprises determining the Toeplitz-based method for each of the one or more layers; and
determining the CSI report further comprises determining, based on the Toeplitz-based method for each of the one or more layers, the CSI report.
